(19) United States
(12) Patent Application Publication
(10) Pub. No.: US 2012/0242646 A1
(43) Pub. Date: Sep. 27, 2012

(54) DISPLAY PANEL, LIQUID CRYSTAL DISPLAY, AND DRIVING METHOD

(75) Inventor: Asahi Yamato, Osaka-shi (JP)

(73) Assignee: SHARP KABUSHIKI KAISHA, Osaka-shi, Osaka (JP)

(21) Appl. No.: 13/514,082

(22) PCT Filed: Sep. 22, 2010
(86) PCT No.: PCT/JP2010/066453

§ 371 Date: Jun. 6, 2012

(30) Foreign Application Priority Data
Dec. 11, 2009 (JP) 2009-282187

(51) Int. Cl. G09G 3/36; G06F 3/038

(52) U.S. Cl. 345/212; 345/87

(57) ABSTRACT

A display panel includes: a gate driver (13), which supplies gate signals to a plurality of gate bus lines (GL₁ to GL_{N}); a source driver (12), which supplies source signals to a plurality of source bus lines (SL₁ to SL_{M}); a plurality of auxiliary capacitor bus lines (CSL₁ to CSL_{N}); and an auxiliary capacitor driver (14) which, in a single scanning period (T_{V}) from a point in time where the gate driver (13) supplies a gate bus line (GLₙ) with a conducting signal to a point in time where the gate driver (13) supplies the conducting signal next, supplies an auxiliary capacitor bus line (CSLₙ) with a rectangular voltage signal (#CSLₙ) in synchronization with the conducting signal, the rectangular voltage signal (#CSLₙ) being composed of at least a first voltage level (V_{CS1}) and a second voltage level (V_{CS2}) that is different from the first voltage level. This allows the display panel to suppress the phenomenon of blurring of moving images while suppressing increase in manufacturing cost and in power consumption.

### TECHNICAL FIELD

The present invention relates to a display panel that displays an image by using liquid crystals, and also relates to a liquid crystal display device including such a display panel.

### BACKGROUND ART

Conventionally, image display devices for displaying images have been classified broadly into impulse-type image display devices such as CRT (cathode-ray tubes) and hold-type image display devices such as liquid crystal display devices.

In an impulse-type image display device, a lighting period during which an image is displayed and an extinction period during which no image is displayed are alternately repeated. In a typical hold-type image display device, on the other hand, no extinction period is provided.

Therefore, the hold-type image display devices are more likely to suffer from blurring of moving images than the impulse-type image display devices.

A reason for this is for example as follows: Although, in changing from displaying one frame to displaying the next frame, a hold-type image display device displays an moving object as if the moving object were staying in one position, the observer transfers his/her gaze on the screen in chase of the moving object even in a period of time during which the moving object is being displayed as if it were staying in one position; therefore, the contours of the moving object appear to be blurred.

Patent Literature 1 discloses an image display device which divides one frame period into two subframes, namely a first-half subframe and a second-half subframe, and which supplies the two subframes with image signals having different gray-scale levels. According to the technology described in Patent Literature 1, such the phenomenon of blurring of moving images can be suppressed by making the brightness of an image in the first-half subframe and the brightness of an image in the second-half subframe different.

### CITATION LIST

### Patent Literature 1

Japanese Patent Application Publication, Tokukai, No. 2005-173573 (Jun. 30, 2005)

### SUMMARY OF INVENTION

### Technical Problem

However, the technology described in Patent Literature 1 requires a frame memory in which to temporarily store the input image signals, thus undesirably bringing about increase in manufacturing cost. Moreover, the technology described in Patent Literature 1 requires access to the frame memory every time a frame is displayed, thus undesirably bringing about increase in power consumption.

The present invention has been made in view of the foregoing problems, and it is an object of the present invention to realize a display panel capable of suppressing the phenomenon of blurring of moving images while suppressing increase in manufacturing cost and in power consumption.

### Solution to Problem

In order to solve the foregoing problems, a display panel according to the present invention is a display panel including: a plurality of gate bus lines; a plurality of source bus lines; a plurality of auxiliary capacitor bus lines; a transistor including a gate connected to a given gate bus line of the plurality of gate bus lines and a source connected to a given source bus line of the plurality of source bus lines; a pixel electrode connected to a drain of the transistor; a capacitor, one end of which is connected to the drain of the transistor in parallel with the pixel electrode, and the other end of which is connected to a given auxiliary capacitor bus line of the plurality of auxiliary capacitor bus lines; a source driver, connected to one end of each of the plurality of source bus lines, which supplies the given source bus line with a source signal; a gate driver, connected to one end of each of the plurality of gate bus lines, which sequentially supplies the given gate bus line with a conducting signal that renders the transistor conducting; a counter electrode opposed to the pixel electrode via a liquid crystal; a counter electrode wire connected to the counter electrode; and a counter electrode driver, which supplies the counter electrode wire with a common potential, the display panel including an auxiliary capacitor driver which, in a single scanning period from a point in time where the gate driver supplies the given gate bus line with the conducting signal to a point in time where the gate driver supplies the conducting signal next, supplies the given auxiliary capacitor bus line with a rectangular voltage signal in synchronization with the conducting signal, the rectangular voltage signal being composed of at least a first voltage level and a second voltage level that is different from the first voltage level, in the single scanning period, a period of time during which the rectangular voltage signal is at the first voltage level and a period of time during which the rectangular voltage signal is at the second voltage level being each longer than a response time of the liquid crystal.

Although, in changing from displaying one frame to displaying the next frame, a hold-type image display device such as a liquid crystal display device displays an moving object as if the moving object were staying in one position, the observer transfers his/her gaze on the screen in chase of the moving object even in a period of time during which the moving object is being displayed as if it were staying in one position; therefore, there occurs a phenomenon of blurring of moving images where the contours of the moving object appear to be blurred.

As described above, a display panel according to the present invention is a display panel including: a plurality of gate bus lines; a plurality of source bus lines; a plurality of auxiliary capacitor bus lines; a transistor including a gate connected to a given gate bus line of the plurality of gate bus lines and a source connected to a given source bus line of the plurality of source bus lines; a pixel electrode connected to a drain of the transistor; a capacitor, one end of which is connected to the drain of the transistor in parallel with the pixel electrode, and the other end of which is connected to a given auxiliary capacitor bus line of the plurality of auxiliary capacitor bus lines; a source driver, connected to one end of each of the plurality of source bus lines, which supplies the given source bus line with a source signal; a gate driver, connected to one end of each of the plurality of gate bus lines, which sequentially supplies the given gate bus line with a conducting signal that renders the transistor conducting; a counter electrode opposed to the pixel electrode via a liquid crystal layer; a counter electrode wire connected to the counter electrode; and a counter electrode driver, which supplies the counter electrode wire with a common potential, the display panel including an auxiliary capacitor driver which, in a single scanning period from a point in time where the gate driver supplies the given gate bus line with the conducting signal to a point in time where the gate driver supplies the conducting signal next, supplies the given auxiliary capacitor bus line with a rectangular voltage signal in synchronization with the conducting signal, the rectangular voltage signal being composed of at least a first voltage level and a second voltage level that is different from the first voltage level. Therefore, in a single scanning period from a point in time where the gate driver supplies the given gate bus line with the conducting signal to a point in time where the gate driver supplies the conducting signal next, a first voltage level and a second voltage level that is different from the first voltage level can be applied to the pixel electrode connected via the transistor to the given gate bus line.

Further, in the display panel according to the present invention, in the single scanning period, a period of time during which the rectangular voltage signal is at the first voltage level and a period of time during which the rectangular voltage signal is at the second voltage level are each longer than a response time of the liquid crystal. The response time of the liquid crystal here means the amount of time required for the orientation of the liquid crystal to start to change after application of an electric field to the liquid crystal. Generally, the amount of time required is 1 ms or more.

Therefore, the foregoing configuration can cause the brightness of an image in the pixel region in which the pixel electrode has been formed to switch between two values in the single scanning period.

This brings about an effect of making it possible to suppress the phenomenon of blurring of moving images.

Further, the auxiliary capacitor driver of the display panel according to the present invention can supply, in synchronization with the conducting signal, the rectangular voltage signal composed of the first voltage level and the second voltage level. Therefore, the voltage level of the rectangular voltage signal changes after a certain period of time has elapsed since the conducting signal was supplied.

Therefore, unlike in a case where a voltage signal is supplied out of synchronization with the conducting signal, the switching between bright and dark can be carried out in every pixel region on the screen after a certain period of time has elapsed since an update of image data.

Further, in the display panel according to the present invention, the blurring of moving images can be suppressed without using a frame memory in which to temporarily store image signals. Therefore, as compared with a conventional configuration that uses a frame memory in which to temporarily store image signals, the display panel according to the present invention brings about an effect of making it possible to reduce manufacturing cost. Further, as compared with a conventional configuration that uses a frame memory in which to temporarily store image signals, the display panel according to the present invention brings about an effect of making it possible to reduce power consumption.

Further, a driving method according to the present invention is a method for driving a display panel including: a plurality of gate bus lines; a plurality of source bus lines; a plurality of auxiliary capacitor bus lines; a transistor including a gate connected to a given gate bus line of the plurality of gate bus lines and a source connected to a given source bus line of the plurality of source bus lines; a pixel electrode connected to a drain of the transistor; a capacitor, one end of which is connected to the drain of the transistor in parallel with the pixel electrode, and the other end of which is connected to a given auxiliary capacitor bus line of the plurality of auxiliary capacitor bus lines; a source driver, connected to one end of each of the plurality of source bus lines, which supplies the given source bus line with a source signal; a gate driver, connected to one end of each of the plurality of gate bus lines, which sequentially supplies the given gate bus line with a conducting signal that renders the transistor conducting; a counter electrode opposed to the pixel electrode via a liquid crystal; a counter electrode wire connected to the counter electrode; and a counter electrode driver, which supplies the counter electrode wire with a common potential, the method including a voltage signal supplying step of, in a single scanning period from a point in time where the gate driver supplies the given gate bus line with the conducting signal to a point in time where the gate driver supplies the conducting signal next, supplying the given auxiliary capacitor bus line with a rectangular voltage signal in synchronization with the conducting signal, the rectangular voltage signal being composed of at least a first voltage level and a second voltage level that is different from the first voltage level, in the single scanning period, a period of time during which the rectangular voltage signal is at the first voltage level and a period of time during which the rectangular voltage signal is at the second voltage level being each longer than a response time of the liquid crystal.

The foregoing method brings about the same effects as the foregoing display panel according to the present invention.

### Advantageous Effects of Invention

As described above, a display panel according to the present invention is a display panel including: a plurality of gate bus lines; a plurality of source bus lines; a plurality of auxiliary capacitor bus lines; a transistor including a gate connected to a given gate bus line of the plurality of gate bus lines and a source connected to a given source bus line of the plurality of source bus lines; a pixel electrode connected to a drain of the transistor; a capacitor, one end of which is connected to the drain of the transistor in parallel with the pixel electrode, and the other end of which is connected to a given auxiliary capacitor bus line of the plurality of auxiliary capacitor bus lines; a source driver, connected to one end of each of the plurality of source bus lines, which supplies the given source bus line with a source signal; a gate driver, connected to one end of each of the plurality of gate bus lines, which sequentially supplies the given gate bus line with a conducting signal that renders the transistor conducting; a counter electrode opposed to the pixel electrode via a liquid crystal; a counter electrode wire connected to the counter electrode; and a counter electrode driver, which supplies the counter electrode wire with a common potential, the display panel including an auxiliary capacitor driver which, in a single scanning period from a point in time where the gate driver supplies the given gate bus line with the conducting signal to a point in time where the gate driver supplies the conducting signal next, supplies the given auxiliary capacitor bus line with a rectangular voltage signal in synchronization with the conducting signal, the rectangular voltage signal being composed of at least a first voltage level and a second voltage level that is different from the first voltage level, in the single scanning period, a period of time during which the rectangular voltage signal is at the first voltage level and a period of time during which the rectangular voltage signal is at the second voltage level being each longer than a response time of the liquid crystal.

Therefore, in the display panel according to the present invention, the blurring of moving images can be suppressed without using a frame memory in which to temporarily store image signals. Therefore, as compared with a conventional configuration that uses a frame memory in which to temporarily store image signals, manufacturing cost can be reduced. Further, as compared with a conventional configuration that uses a frame memory in which to temporarily store image signals, power consumption can be reduced.

### BRIEF DESCRIPTION OF DRAWINGS

FIG. 1 is a block diagram showing a configuration of a display panel according to a first embodiment of the present invention.

FIG. 2 is a circuit diagram showing a configuration of a pixel region of the display panel according to the first embodiment of the present invention.

FIG. 3 serves to explain a first example of operation of the display panel according to the first embodiment of the present invention, (a) being a timing chart showing a waveform of a source signal corresponding to a high tone, (b) being a timing chart showing a waveform of a gate signal, (c) being a timing chart showing a common potential and a potential of a pixel electrode, (d) being a timing chart showing a waveform of an auxiliary capacitor signal.

FIG. 4 serves to explain the first example of operation of the display panel according to the first embodiment of the present invention, (a) being a timing chart showing a waveform of a source signal corresponding to a low tone, (b) being a timing chart showing a waveform of a gate signal, (c) being a timing chart showing a common potential and a potential of a pixel electrode, (d) being a timing chart showing a waveform of an auxiliary capacitor signal.

FIG. 5 serves to explain a second example of operation of the display panel according to the first embodiment of the present invention, (a) being a timing chart showing a waveform of a source signal corresponding to a high tone, (b) being a timing chart showing a waveform of a gate signal, (c) being a timing chart showing a common potential and a potential of a pixel electrode, (d) being a timing chart showing a waveform of an auxiliary capacitor signal.

FIG. 6 serves to explain the second example of operation of the display panel according to the first embodiment of the present invention, (a) being a timing chart showing a waveform of a source signal corresponding to a low tone, (b) being a timing chart showing a waveform of a gate signal, (c) being a timing chart showing a common potential and a potential of a pixel electrode, (d) being a timing chart showing a waveform of an auxiliary capacitor signal.

FIG. 7 serves to explain a third example of operation of the display panel according to the first embodiment of the present invention, (a) being a timing chart showing a waveform of a source signal corresponding to a high tone, (b) being a timing chart showing a waveform of a gate signal, (c) being a timing chart showing a common potential and a potential of a pixel electrode, (d) being a timing chart showing a waveform of an auxiliary capacitor signal.

FIG. 8 serves to explain the third example of operation of the display panel according to the first embodiment of the present invention, (a) being a timing chart showing a waveform of a source signal corresponding to a low tone, (b) being a timing chart showing a waveform of a gate signal, (c) being a timing chart showing a common potential and a potential of a pixel electrode, (d) being a timing chart showing a waveform of an auxiliary capacitor signal.

FIG. 9 serves to explain a fourth example of operation of the display panel according to the first embodiment of the present invention, (a) being a timing chart showing a waveform of a source signal, (b) being a timing chart showing a waveform of a gate signal, (c) being a timing chart showing a common potential and a potential of a pixel electrode, (d) being a timing chart showing a waveform of an auxiliary capacitor signal.

FIG. 10 serves to explain a fifth example of operation of the display panel according to the first embodiment of the present invention, (a) being a timing chart showing a waveform of a source signal, (b) being a timing chart showing a waveform of a gate signal, (c) being a timing chart showing a common potential and a potential of a pixel electrode, (d) being a timing chart showing a waveform of an auxiliary capacitor signal.

FIG. 11 serves to explain a sixth example of operation of the display panel according to the first embodiment of the present invention, (a) being a timing chart showing a waveform of a source signal, (b) being a timing chart showing a waveform of a gate signal, (c) being a timing chart showing a common potential and a potential of a pixel electrode, (d) being a timing chart showing a waveform of an auxiliary capacitor signal.

FIG. 12 serves to explain an example of operation of the display panel according to the first embodiment of the present invention, (a) being a timing chart showing waveforms of gate signals, (b) being a timing chart showing examples of waveforms of auxiliary capacitor signals, (c) being a timing chart showing other examples of waveforms of auxiliary capacitor signals.

FIG. 13 serves to explain a seventh example of operation of the display panel according to the first embodiment of the present invention, (a) being a timing chart showing waveforms of gate signals, (b) being a timing chart showing waveforms of auxiliary capacitor signals.

FIG. 14 serves to explain an example of operation of the display panel according to the first embodiment of the present invention, (a) being a timing chart showing a waveform of a gate signal, (b) being a timing chart showing a common potential and a potential of a pixel electrode, (c) being a timing chart showing a waveform of an auxiliary capacitor signal having a duty ratio.

FIG. 15 serves to explain an example of operation of the display panel according to the first embodiment of the present invention, (a) being a timing chart showing a waveform of a gate signal, (b) being a timing chart showing a common potential and a potential of a pixel electrode, (c) being a timing chart showing a waveform of an auxiliary capacitor signal having another duty ratio.

FIG. 16, which serves to explain an effect of the display panel according to the first embodiment of the present invention, is a graph representing a relationship between duty ratio and brightness.

FIG. 17, which serves to explain an effect of the display panel according to the first embodiment of the present invention, is a graph representing a relationship between duty ratio and visibility.

FIG. 18 serves to explain an example of operation of the display panel according to the first embodiment of the present invention, (a) being a timing chart showing a waveform of a gate signal, (b) being a timing chart showing a common potential and an example of a potential of a pixel electrode, (c) being a timing chart showing an example of a waveform of an auxiliary capacitor signal, (d) being a timing chart showing a common potential and another example of a potential of a pixel electrode, (e) being a timing chart showing another example of a waveform of an auxiliary capacitor signal.

FIG. 19 is a block diagram showing a configuration of an auxiliary capacitor driver in the display panel according to the first embodiment of the present invention.

FIG. 20 is a block diagram showing a configuration of a display panel according to a second embodiment of the present invention.

FIG. 21 serves to explain an example of operation of the display panel according to the second embodiment of the present invention, (a) being a timing chart showing waveforms of gate signals, (b) being a timing chart showing waveforms of auxiliary capacitor signals.

FIG. 22 is a block diagram showing a configuration of a display panel according to a third embodiment of the present invention.

FIG. 23 is a circuit diagram showing a configuration of a display section in the display panel according to the third embodiment.

FIG. 24 is a circuit diagram showing a configuration of a display section in a display panel according to a fourth embodiment of the present invention.

FIG. 25, which is a diagram showing an example of operation of the display panel according to the fourth embodiment of the present invention, is a diagram showing the polarities of potentials that are applied to the display section of the display panel.

### DESCRIPTION OF EMBODIMENTS

### Embodiment 1

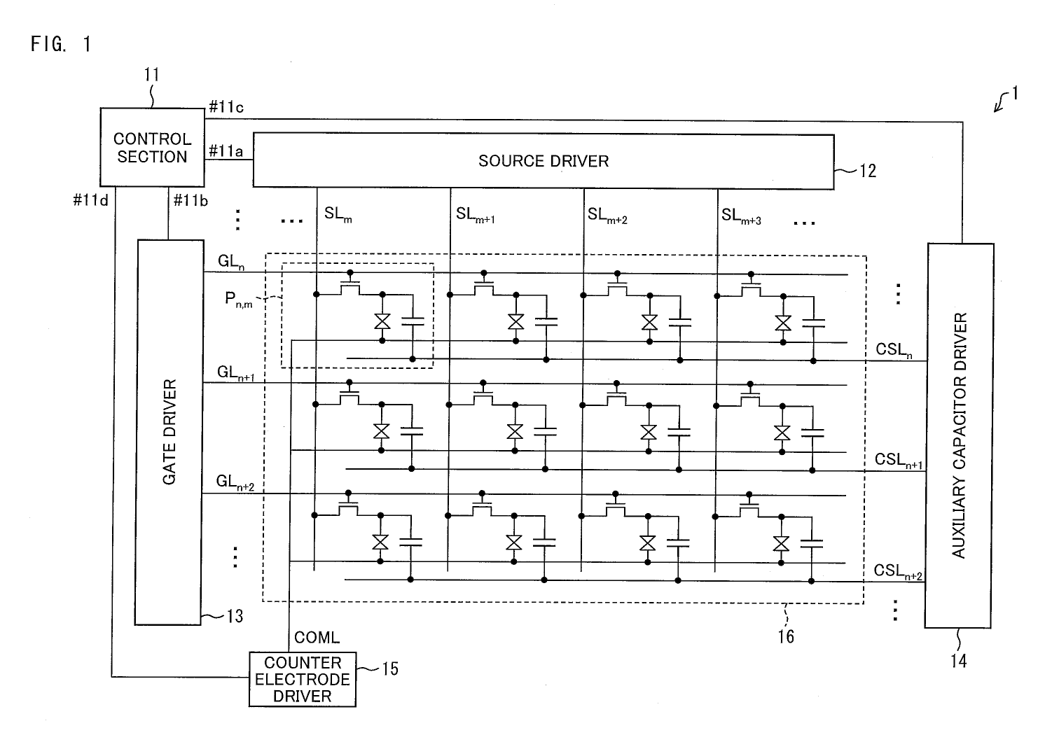

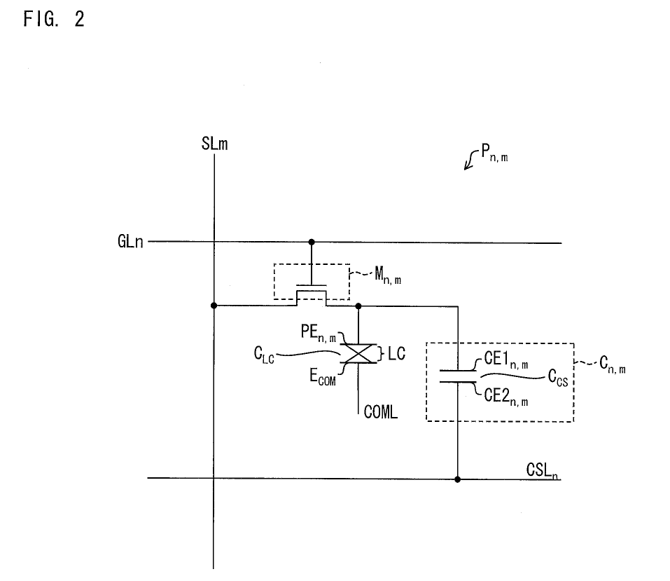

A configuration of a display panel according to a first embodiment of the present invention is described with reference to FIGS. 1 and 2. FIG. 1 is a block diagram showing a configuration of a display panel 1 according to the present embodiment. The display panel 1 is an active-matrix liquid crystal display panel.

As shown in FIG. 1, the display panel 1 includes a control section 11, a source driver 12, a gate driver 13, an auxiliary capacitor driver 14, a counter electrode driver 15, and a display section 16.

The control section 11 outputs a control signal #11a to control the source driver 12, a control signal #11b to control the gate driver 13, a control signal #11c to control the auxiliary capacitor driver 14, and a control signal #11d to control the counter electrode driver 15.

In the display section 16, N gate bus lines GL₁ to GL_{N} and M source bus lines SL₁ to SL_{M} are formed in such a reticular pattern as to intersect one another. Further, in the display section 16, N auxiliary capacitor bus lines CSL₁ to CSL_{N} are formed substantially in parallel with the N gate bus lines GL₁ to GL_{N}. Further, in the display section 16, a counter electrode wire COML is formed. In the following, as shown in FIG. 1, the nth gate bus line, the mth source bus line, and the nth auxiliary capacitor bus line are represented as “gate bus line GLₙ”, “source bus line SLₘ”, and “auxiliary capacitor bus line CSLₙ”, respectively.

Further, as shown in FIG. 1, the display section 16 includes a pixel region P_{n,m} defined by the gate bus line GLₙ (1≦n≦N) and the source bus line SLₘ (1≦m≦M).

As shown in FIG. 1, the M source bus lines SL₁ to SL_{M} have their terminals connected to the source driver 12. The source driver 12 supplies the M source bus lines SL₁ to SL_{M} with source signals #SL₁ to #SL_{M}, respectively.

Further, the N gate bus lines GL₁ to GL_{N} have their terminals connected to the gate driver 13. The gate driver 13 supplies the N gate bus lines GL₁ to GL_{N} with gate signals #GL₁ to #GL_{N}, respectively.

Further, the N auxiliary capacitor bus lines CSL₁ to CSL_{N} have their terminals connected to the auxiliary capacitor driver 14. The auxiliary capacitor driver 14 supplies the N auxiliary capacitor bus lines CSL₁ to CSL_{N} with auxiliary capacitor signals #CSL₁ to #CSL_{N}, respectively.

Further, the counter electrode wire COML has its terminal connected to the counter electrode driver 15. The counter electrode driver 15 supplies the counter electrode wire COML with a common potential V_{COM}.

FIG. 2 is a circuit diagram showing a configuration of the display panel 1 in the pixel region P_{n,m}. As shown in FIG. 2, the display panel 1 includes, in the pixel region P_{n,m}, a transistor M_{n,m} having its gate connected to the gate bus line GLₙ and its source connected to the source bus line SLₘ. The transistor M_{n,m} is, for example, a thin-film transistor (TFT), but, in the present invention, is not to be limited to a specific type of transistor. Further, in the present embodiment, the transistor M_{n,m} is described by taking, as an example, a transistor that switches into a conducting state when a high-level potential is applied to the gate and switches into a cutoff state when a low-level potential is applied to the gate. However, the present invention is not to be limited to such an example. Even a transistor that switches into a conducting state when a low-level potential is applied to the gate and switches into a cutoff state when a high-level potential is applied to the gate can be applied to the present invention.

Further, as shown in FIG. 2, the transistor M_{n,m} has its drain connected to a pixel electrode PE_{n,m}. Further, the display panel 1 includes, in the pixel region P_{n,m}, a counter electrode E_{COM} opposed to the pixel electrode PE_{n,m}, and the counter electrode E_{COM} is connected to the counter electrode wire COML. Further, the display panel 1 includes a liquid crystal LC between the pixel electrode PE_{n,m} and the counter electrode E_{COM}, with a pixel capacitor C_{LC} formed between the pixel electrode PE_{n,m} and the counter electrode E_{COM}.

An electric field corresponding to charge stored in the pixel electrode PE_{n,m} is induced between the pixel electrode PE_{n,m} and the counter electrode E_{COM}, and the orientation of the liquid crystal LC is determined according to the magnitude of the electric field. In other words, the orientation of the liquid crystal LC is determined according to the absolute value of a potential difference between the pixel electrode PE_{n,m} and the counter electrode E_{COM}. Further, the transmittance of the liquid crystal LC is determined according to the orientation. The present embodiment is described by taking, as an example, a case of normally black in which as the absolute value of the potential difference becomes larger, the transmittance of the liquid crystal LC becomes higher. However, the present invention is not to be limited to such an example. The present invention can be applied even in a case of normally white in which as the absolute value of the potential difference becomes larger, the transmittance of the liquid crystal LC becomes lower. Further, the higher the transmittance of the liquid crystal LC becomes, the higher the brightness of the pixel region P_{n,m}, which includes the liquid crystal LC, becomes.

Further, the transistor M_{n,m} has its drain connected to a first auxiliary capacitor electrode CE1_{n,m} parallel to the pixel electrode PE_{n,m}. Further, the pixel region P_{n,m} includes a second auxiliary capacitor electrode CE2_{n,m} opposed to the first auxiliary capacitor electrode CE1_{n,m} and connected to the auxiliary capacitor bus line CSLₙ, with an auxiliary capacitor C_{CS} formed between the first auxiliary capacitor electrode CE1_{n,m} and the second auxiliary capacitor electrode CE2_{n,m} in parallel with the pixel capacitor C_{LC}. In other words, the first auxiliary capacitor electrode CE1_{n,m} and the second auxiliary capacitor electrode CE2_{n,m} constitute a capacitor C_{n,m} having the auxiliary capacitor C_{CS}.

(Example 1 of Operation of the Display Panel 1)

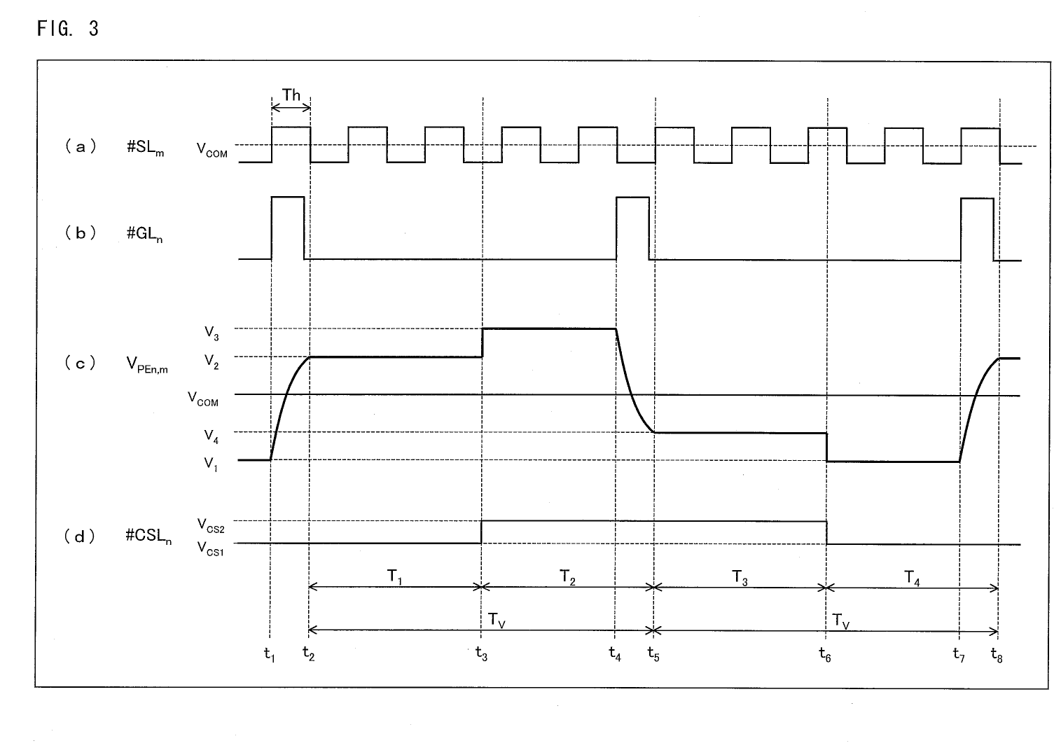

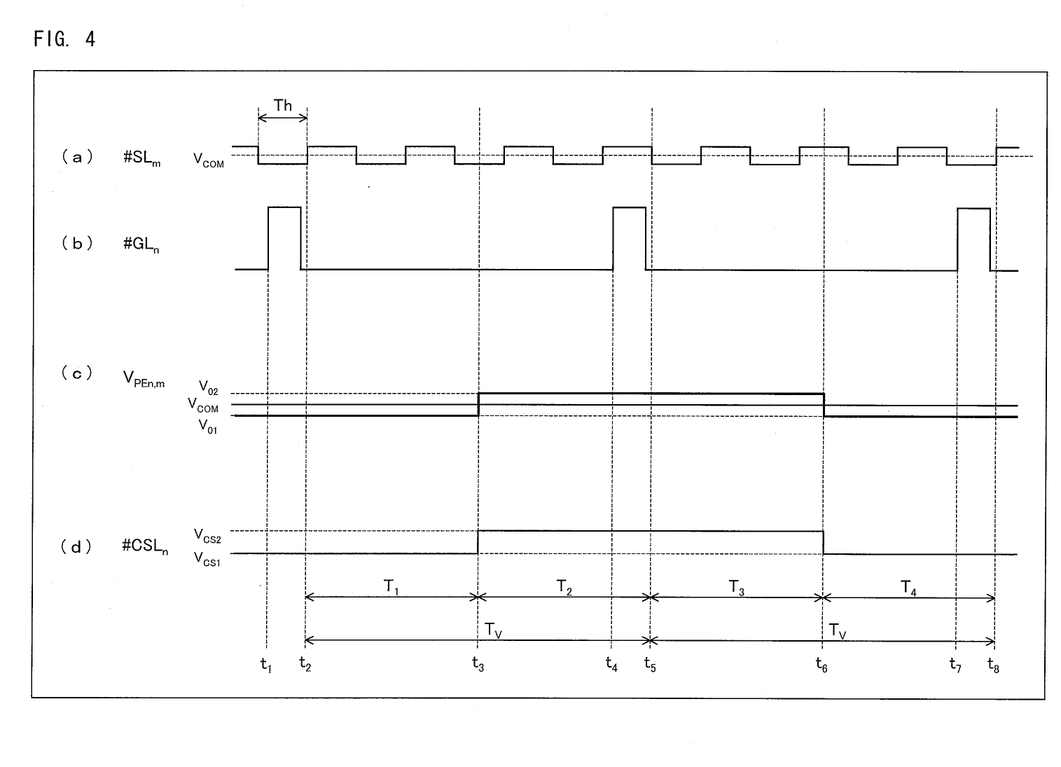

A first example of operation of the display panel 1 according to the present embodiment is described below with reference to (a) through (d) of FIG. 3 and (a) through (d) of FIG. 4.

First, a case where the source driver 12 supplies the source bus line SLₘ with a source signal #SLₘ corresponding to a high tone is described with reference to (a) through (d) of FIG. 3.

(a) of FIG. 3 is a timing chart showing an example of a waveform of the source signal #SLₘ, which is supplied to the source bus line SLₘ.

(b) of FIG. 3 is a timing chart showing an example of a waveform of the gate signal #GLₙ, which is supplied to the gate bus line GLₙ.

(c) of FIG. 3 is a timing chart showing the common potential V_{COM}, which is supplied to the counter electrode wire COML, and a potential V_{PEn,m} that is applied to the pixel electrode PE_{n,m}.

(d) of FIG. 3 is a timing chart showing a waveform of the auxiliary capacitor signal #CSLₙ, which is supplied to the auxiliary capacitor bus line CSLₙ. As shown in (d) of FIG. 3, the auxiliary capacitor signal #CSLₙ is a signal that alternately takes on a potential V_{CS1} and a potential V_{CS2} in a single cycle composed of two consecutive vertical scanning periods T_{V}. More specifically, as shown in (d) of FIG. 3, the auxiliary capacitor signal #CSLₙ takes on the potential V_{CS1} during a period T₁ in a single vertical scanning period T_{V}, and takes on the potential V_{CS2} during a period T₂. Further, the auxiliary capacitor signal #CSLₙ takes on the potential V_{CS2} during a period T₃ in the ensuing vertical scanning period T_{V}, and takes on the potential V_{CS1} during a period T₄. It is assumed that as shown in (d) of FIG. 3, specific values of the potentials V_{CS1} and V_{CS2} satisfy V_{CS1}<V_{CS2}.

As shown in (c) and (d) of FIG. 3, when the auxiliary capacitor signal #CSLₙ is at the lowest potential (potential V_{CS1}) and the gate signal #GLₙ is at a high level, the voltage that is applied to the liquid crystal LC changes into a positive polarity; and when the auxiliary capacitor signal #CSLₙ is at the highest potential (potential V_{CS2}) and the gate signal #GLₙ is at a high level, the voltage that is applied to the liquid crystal LC changes into a negative polarity.

The “voltage that is applied to the liquid crystal LC” here means a potential difference between the potential V_{PEn,m}, which is applied to the pixel electrode PE_{n,m}, and the potential V_{COM}, which is applied to the counter electrode E_{COM} (same applies below).

Further, in the present embodiment, a case is described where the potential V_{PEn,m}, which is applied to the pixel electrode PE_{n,m}, has the same polarity as a potential V_{PEn,t} (t≠m, 1≦t≦M) that is applied to a pixel electrode PE_{n,t}.

It should be noted that each single vertical scanning period T_{V} is defined as including a boundary time at a point in time where the period starts, but not including a boundary time at a point in time where the period ends. That is, in (d) of FIG. 3, each single vertical period T_{V} is defined as a set of times t that satisfy t₂≦t<t₅ or as a set of times t that satisfy t₅≦t<t₈ (same applies below).

The following describes the operation of each of the components in the pixel region P_{n,m} of the display panel 1.

First, as shown in (b) of FIG. 3, the gate signal #GLₙ rises from a low level to a high level at the time t₁ and, after a certain period of time has elapsed, falls to a low level. In a period of time during which the gate signal #GLₙ is at a high level, the transistor M_{n,m} is in a conducting state. When the transistor M_{n,m} is in a conducting state, the source signal #SLₘ is supplied to the pixel electrode PE_{n,m} and the first auxiliary capacitor electrode CE1_{n,m}. As shown in (c) of FIG. 3, in a period from the time t₁ to the time t₂, the potential V_{PEn,m}, which is applied to the pixel electrode PE_{n,m}, rises from a potential V₁ to a potential V₂ (which is positive).

Then, the auxiliary capacitor signal #CSLₙ rises from the potential V_{CS1} to the potential V_{CS2} at the time t₃. Since the gate signal #GLₙ is at a low level at this point in time, the transistor M_{n,m} is in a cutoff state. Therefore, a sum of the charge stored in the pixel electrode PE_{n,m} and the charge stored in the first auxiliary capacitor electrode CE1_{n,m} is invariable. Meanwhile, when the value of the auxiliary capacitor signal #CSLₙ changes, the charge stored in the pixel electrode PE_{n,m} and the charge stored in the first auxiliary capacitor electrode CE1_{n,m} change. Accordingly, the potential V_{PEn,m} of the pixel electrode PE_{n,m} changes from the potential V₂ to a potential V₃. It should be noted here that a specific value of the potential V₃ is defined as:

V₃=(V_{CS2}−V_{CS1})×C_{CS}/Σ_{C}+V₂.

Further, Σ_{C} is the sum of the capacitors connected to the drain of the transistor M_{n,m} in parallel with each other and, in the present embodiment, specifically, Σ_{C}=C_{LC}+C_{CS}. Since V_{CS1}<V_{CS2} as mentioned above, the potential V₃ is greater than the potential V₂.

Further, as shown in (c) of FIG. 3, the potential difference between the potential V₃ and the common potential V_{COM} is greater than the potential difference between the potential V₂ and the common potential V_{COM}. That is, the transmittance of the liquid crystal LC in a period from the time t₃ to the time t₄ is greater than the transmittance of the liquid crystal LC in a period from the time t₂ to the time t₃. That is, the brightness of the pixel region P_{n,m} in the period from the time t₃ to the time t₄ is greater than the brightness of the pixel region P_{n,m} in the period from the time t₂ to the time t₃.

Then, the gate signal #GLₙ rises from a low level to a high level at the time t₄ and, after a certain period of time has elapsed, falls to a low level. In a period of time during which the gate signal #GLₙ is at a high level, the transistor M_{n,m} is in a conducting state, so that the source signal #SLₘ is supplied to the pixel electrode PE_{n,m} and the first auxiliary capacitor electrode CE1_{n,m}.

As shown in (c) of FIG. 3, in a period from the time t₄ to the time t₅, the potential V_{PEn,m}, which is applied to the pixel electrode PE_{n,m}, falls from the potential V₃ to a potential V₄ (which is negative).

Then, the auxiliary capacitor signal #CSLₙ falls from the potential V_{CS2} to the potential V_{CS1} at the time t₆. Since the gate signal #GLₙ is at a low level at this point in time, the transistor M_{n,m} is in a cutoff state. Therefore, a sum of the charge stored in the pixel electrode PE_{n,m} and the charge stored in the first auxiliary capacitor electrode CE1_{n,m} is invariable. Meanwhile, when the value of the auxiliary capacitor signal #CSLₙ changes, the charge stored in the pixel electrode PE_{n,m} and the charge stored in the first auxiliary capacitor electrode CE1_{n,m} change. Accordingly, the potential V_{PEn,m} of the pixel electrode PE_{n,m} changes from the potential V₄ to the potential V₁. It should be noted here that a specific value of the potential V₁ is defined as:

V₁=(V_{CS1}−V_{CS2})×C_{CS}/Σ_{C}+V₄.

Further, since V_{CS1}<V_{CS2} as mentioned above, the potential V₁ is smaller than the potential V₄.

Further, as shown in (c) of FIG. 3, the potential difference between the potential V₁ and the common potential V_{COM} is greater than the potential difference between the potential V₄ and the common potential V_{COM}. That is, the transmittance of the liquid crystal LC in a period from the time t₆ to the time t₇ is greater than the transmittance of the liquid crystal LC in a period from the time t₅ to the time t₆. That is, the brightness of the pixel region P_{n,m} in the period from the time t₆ to the time t₇ is greater than the brightness of the pixel region P_{n,m} in the period from the time t₅ to the time t₆.

The operation at the time t₇ and later is the same as the operation at the time t₁ and later.

Although the foregoing description has assumed that Σ_{C}=C_{LC}+C_{CS}, the present invention is not to be limited thereby. For example, in such a case where a capacitor (parasitic capacitor) Cgd exists between the drain of the transistor M_{n,m} and the gate bus line GLₙ and a capacitor (parasitic capacitor) Csd exists between the drain of the transistor M_{n,m} and the source bus line SLₘ, Σ_{C}=C_{LC}+C_{CS}+Cgd+Csd. Alternatively, in such a case where in addition to these capacitors, a further capacitor Cext exists in parallel with the liquid crystal capacitor C_{LC}, Σ_{C}=C_{LC}+C_{CS}+Cgd+Csd+Cext. As for the definition of Σ_{C}, the same applies to the following description.

Further, in actuality, a period of time during which the gate signal #GLn shown in (b) of FIG. 3 is at a high level is sufficiently shorter than a single vertical scanning period T_{V}.

As described above, the display panel 1 according to the present embodiment is a display panel including: a plurality of gate bus lines GL₁ to GL_{N}; a plurality of source bus lines SL₁ to SL_{M}; a plurality of auxiliary capacitor bus lines CSL₁ to CSL_{N}; a transistor M_{n,m} including a gate connected to a given gate bus line GLₙ of the plurality of gate bus lines and a source connected to a given source bus line SLₘ of the plurality of source bus lines; a pixel electrode PE_{n,m} connected to a drain of the transistor; a capacitor C_{n,m}, one end (first auxiliary capacitor electrode CE1_{n,m}) of which is connected to the drain of the transistor in parallel with the pixel electrode, and the other end (second auxiliary capacitor electrode CE2_{n,m}) of which is connected to a given auxiliary capacitor bus line CSLₙ of the plurality of auxiliary capacitor bus lines; a source driver 12, connected to one end of each of the plurality of source bus lines, which supplies the given source bus line with a source signal; a gate driver 13, connected to one end of each of the plurality of gate bus lines, which sequentially supplies the given gate bus line with a conducting signal that renders the transistor conducting; a counter electrode E_{COM} opposed to the pixel electrode via a liquid crystal layer (liquid crystal LC); a counter electrode wire COML connected to the counter electrode; and a counter electrode driver 15, which supplies the counter electrode wire with a common potential V_{COM}, the display panel 1 including an auxiliary capacitor driver which, in a single scanning period (single vertical scanning period T_{V}) from a point in time where the gate driver supplies the given gate bus line with the conducting signal (high-level interval of a gate signal #GLₙ) to a point in time where the gate driver supplies the conducting signal next, supplies the given auxiliary capacitor bus line CSLₙ with a rectangular voltage signal (auxiliary capacitor signal #CSLₙ) in synchronization with the conducting signal, the rectangular voltage signal being composed of at least a first voltage level and a second voltage level that is different from the first voltage level (i.e., at least a potential V_{CS1} and a potential V_{CS2}). Further, in the single scanning period, a period of time during which the rectangular voltage signal is at the first voltage level and a period of time during which the rectangular voltage signal is at the second voltage level, i.e., a time T₁ and a time T₂, are each longer than a response time of the liquid crystal.

Therefore, in the single scanning period, the display panel 1 can apply a two-valued voltage level to the pixel electrode connected via the transistor to the given gate bus line. That is, the display panel 1 can cause the brightness of an image in the pixel region P_{n,m}, in which the pixel electrode PE_{n,m} has been formed, to switch between two values in the single scanning period.

This makes it possible to suppress the aforementioned phenomenon of blurring of moving images.

The auxiliary capacitor driver 14 of the display panel 1 according to the present invention can supply the rectangular voltage signal (auxiliary capacitor signal #CSLₙ) in synchronization with the conducting signal. Therefore, unlike in a case where a voltage signal is supplied out of synchronization with the conducting signal, a proportion between a period of display at a high brightness and a period of display at a low brightness can be made substantially equal in any place on the screen, so that blurring of moving images can be effectively suppressed.

Further, in the display panel 1 according to the present invention, the blurring of moving images can be suppressed without using a frame memory in which to temporarily store image signals. Therefore, as compared with a conventional configuration that uses a frame memory in which to temporarily store image signals, manufacturing cost can be reduced. Further, as compared with a conventional configuration that uses a frame memory in which to temporarily store image signals, power consumption can be reduced.

Further, according to this example of operation, the rectangular voltage signal (auxiliary capacitor signal #CSLₙ) takes on either one of the first and second voltage levels (i.e., either one of the potentials V_{CS1} and V_{CS2}) in an at least 10% continuous period of time of the single scanning period.

Therefore, the phenomenon of blurring of moving images can be effectively suppressed.

Further, according to this example of operation, the rectangular voltage signal (auxiliary capacitor signal #CSLₙ) takes on either one (potential V_{CS1}) of the first and second voltage levels in a period of time from a point in time at which the single scanning period (single vertical scanning period T_{V}) starts to a point in time where substantially 10% of the single scanning period elapses, and takes on the other one (potential V_{CS2}) of the first and second voltage levels in a period of time from a point in time where substantially 90% of the single scanning period elapses to a point in time at which the single scanning period ends.

Generally, in the case of switching between a display at a high brightness and a display at a low brightness, no improvement in blurring of moving images is felt when the percentage of the display at the high brightness is 90% or higher, more improvement in blurring of moving images is felt at a lower percentage between 90% to 10%, and satisfactory improvement in blurring of moving images is felt at a percentage of approximately 10%.

Therefore, according to the foregoing configuration, the phenomenon of blurring of moving images can be effectively suppressed.

Next, a case where the source driver 12 supplies the source bus line SLₘ with a source signal #SLₘ corresponding to a low tone is described with reference to (a) through (d) of FIG. 4. It should be noted that overlaps with the foregoing description are not described below.

(a) of FIG. 4 is a timing chart showing an example of a waveform of the source signal #SLₘ which is supplied to the source bus line SLₘ. In the following, as shown in (a) of FIG. 4, a case where the potential of the source signal #SLₘ when the conducting signal #GLₙ is at a high level and the auxiliary capacitor bus line #CSLₙ is at a low level is lower than the potential of the waveform shown in (a) of FIG. 3 under the same conditions or a case where the potential of the source signal #SLₘ when the conducting signal #GLₙ is at a high level and the auxiliary capacitor bus line #CSLₙ is at a high level is higher than the potential of the waveform shown in (a) of FIG. 3 under the same conditions is described.

(b) of FIG. 4 is a timing chart showing an example of a waveform of the gate signal #GLₙ, which is supplied to the gate bus line GLₙ. The waveform shown in (b) of FIG. 4 is the same as that shown in (b) of FIG. 3.

(c) of FIG. 4 is a timing chart showing the common potential V_{COM}, which is supplied to the counter electrode wire COML, and a potential V_{PEn,m} that is applied to the pixel electrode PE_{n,m}.

(d) of FIG. 4 is a timing chart showing a waveform of the auxiliary capacitor signal #CSLₙ, which is supplied to the auxiliary capacitor bus line CSLₙ. The waveform shown in (d) of FIG. 4 is the same as that shown in (d) of FIG. 3.

First, as shown in (b) of FIG. 4, the gate signal #GLₙ rises from a low level to a high level at the time t₁ and, after a certain period of time has elapsed, falls to a low level. In a case where, as shown in (a) of FIG. 4, the potential of the source signal #SLₘ relative to the common potential V_{COM} is substantially equal to the potential of the pixel electrode PE_{n,m} during a period from the time t₁ to the time t₂, the potential V_{PEn,m} of the pixel electrode PE_{n,m} stays substantially constant at a potential V₀₁.

Then, the auxiliary capacitor signal #CSLₙ rises from the potential V_{CS1} to the potential V_{CS2} at the time t₃. Accordingly, the potential V_{PEn,m} of the pixel electrode PE_{n,m} changes from the potential V₀₁ to a potential V₀₂. It should be noted here that a specific value of the potential V₀₂ is defined as:

V₀₂=(V_{CS2}−V_{CS1})×C_{CS}/Σ_{C}+V₀₁.

Since V_{CS1}<V_{CS2} as mentioned above, the potential V₀₂ is greater than the potential V₀₁.

Then, the gate signal #GLₙ rises from a low level to a high level at the time t₄ and, after a certain period of time has elapsed, falls to a low level. In a case where, as shown in (a) of FIG. 4, the potential of the source signal #SLₘ relative to the common potential V_{COM} is substantially equal to the potential V_{PEn,m} of the pixel electrode PE_{n,m} during a period from the time t₄ to the time t₅, the potential V_{PEn,m} of the pixel electrode PE_{n,m} stays substantially constant at the potential V₀₂.

Then, the auxiliary capacitor signal #CSLₙ falls from the potential V_{CS2} to the potential V_{CS1} at the time t₆. Accordingly, the potential V_{PEn,m} of the pixel electrode PE_{n,m} changes for example from the potential V₀₂ to the potential V₀₁.

The operation at the time t₇ and later is the same as the operation at the time t₁ and later.

As shown in (c) of FIG. 4, the absolute value of the potential difference between the potential V_{PEn,m} of the pixel electrode PE_{n,m} and the common potential V_{COM} is always kept substantially constant throughout all the periods. That is, in a case where the source signal #SLₘ corresponding to a low tone is supplied, the transmittance of the liquid crystal LC of the pixel region P_{n,m} can be kept substantially constant even in a case where the value of the auxiliary capacitor signal #CSLₙ is changed as shown in (d) of FIG. 4.

According to this example of operation, as described above, in the single scanning period (single vertical scanning period T_{V}), the polarity of a voltage that is applied to the liquid crystal when the rectangular voltage signal (auxiliary capacitor signal #CSLₙ) is at the first voltage level and the polarity of a voltage that is applied to the liquid crystal when the rectangular voltage signal is at the second voltage level are polarities that are different from each other. That is, a voltage that is applied to the liquid crystal as represented by a difference between the potential V₀₁ of the pixel electrode PE_{n,m} and the potential V_{COM} of the counter electrode when the auxiliary capacitor signal #CSLₙ is at the potential V_{CS1} and a voltage that is applied to the liquid crystal as represented by a difference between the potential V₀₂ of the pixel electrode PE_{n,m} and the potential V_{COM} of the counter electrode when the auxiliary capacitor signal #CSLₙ is at the potential V_{CS2} are opposite in polarity to each other.

According to the foregoing configuration, regardless of whether the rectangular voltage signal is at the first or second voltage level, the absolute value of the voltage that is applied to the liquid crystal can be made sufficiently small.

Therefore, according to the foregoing configuration, in a normally black type in which the brightness is lower in a case where the absolute value of a voltage that is applied to the liquid crystal is smaller, a black display can be carried out at a sufficiently low brightness, regardless of whether the rectangular voltage signal is at the first or second voltage level.

Further, according to this example of operation, it is preferable that the absolute value of the potential difference between the first voltage level and the second voltage level be twice or less as great as the threshold voltage of the liquid crystal. That is, it is preferable that the absolute value of the potential difference between the potential V_{CS1} and the potential V_{CS2} be twice or less as great as the threshold voltage of the liquid crystal.

Generally, the orientation of a liquid crystal is not affected even when a voltage that is equal to or lower than the threshold voltage is applied to the liquid crystal. In other words, the threshold voltage means a voltage at which the orientation of a liquid crystal starts to be affected (same applies below). The threshold voltage can be defined, for example, as a voltage 1/100 times as great as a saturation voltage at which the transmittance of the liquid crystal gets saturated.

Assuming that the voltage difference between the voltage that is applied to the liquid crystal as represented by the difference between the potential of the pixel electrode PE_{n,m} and the potential V_{COM} of the counter electrode in a case where the auxiliary capacitor signal #CSLₙ is at the potential V_{CS1} and the voltage that is applied to the liquid crystal as represented by the difference between the potential of the pixel electrode PE_{n,m} and the potential V_{COM} of the counter electrode in a case where the auxiliary capacitor signal #CSLₙ is at the potential V_{CS2} is represented as ΔV_{LC}, ΔV_{LC} satisfies:

ΔV_{LC}=(V_{CS2}−V_{CS1})×C_{CS}/Σ_{C}.

It should be noted here that since C_{CS}/Σ_{C}<1, ΔV_{LC}<(V_{CS2}−V_{CS1}) is derived.

Further, assuming that the voltage that is applied to the liquid crystal as represented by the difference between the potential of the pixel electrode PE_{n,m} and the potential V_{COM} of the counter electrode is expressed as V_{LC}, it is desirable that in a case where the potential of the auxiliary capacitor signal #CSLₙ is the potential V_{CS1}, V_{LC} be set as V_{LC}=−ΔV_{LC}/2, and that in a case where the potential of the auxiliary capacitor signal #CSLₙ is the potential V_{CS2}, V_{LC} be set as V_{LC}=ΔV_{LC}/2. It should be noted here that as long as ΔV_{LC}/2 is equal to or less than the threshold voltage V_{LCth}, i.e., ΔV_{LC}/2≦V_{LCth}, a black display can be carried out regardless of whether the potential of the auxiliary capacitor signal #CSLₙ is the potential V_{CS1} or the potential V_{CS2}. Therefore, as long as V_{CS2}−V_{CS1}≦2×V_{LCth}, a black display can be carried out regardless of whether the potential of the auxiliary capacitor signal #CSLₙ is the potential V_{CS1} or the potential V_{CS2}.

According to the foregoing configuration, as described above, in a normally black type in which the brightness is lower in a case where the absolute value of a voltage that is applied to the liquid crystal is smaller, a black display can be carried out regardless of whether the voltage level of the rectangular voltage signal is the first or second voltage level.

It should be noted that the above method of derivation can be applied in substantially the same manner to the examples of operation to be described later.

(Example 2 of Operation of the Display Panel 1)

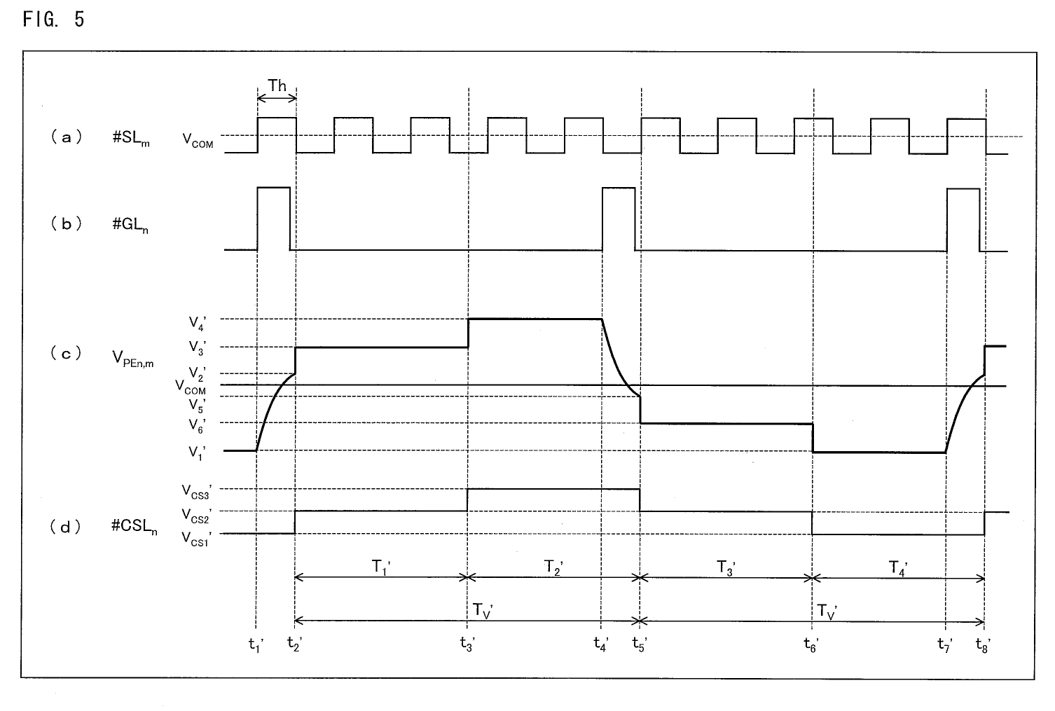

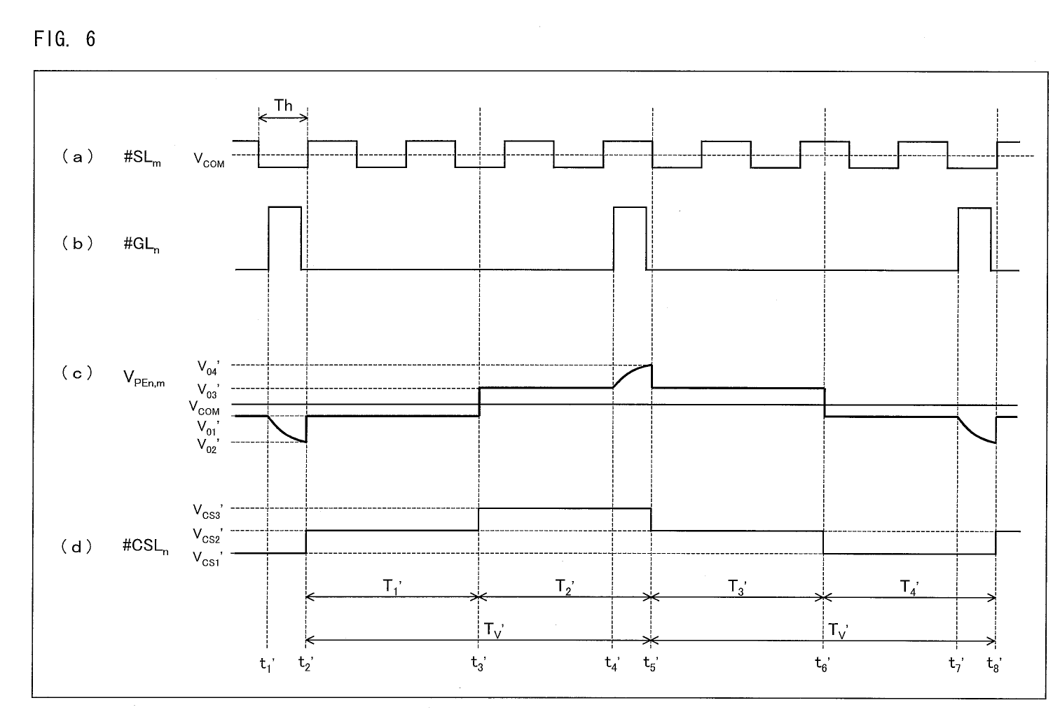

A second example of operation of the display panel 1 according to the present embodiment is described below with reference to (a) through (d) of FIG. 5 and (a) through (d) of FIG. 6.

First, a case where the source driver 12 supplies the source bus line SLₘ with a source signal #SLₘ corresponding to a high tone is described with reference to (a) through (d) of FIG. 5.

(a) of FIG. 5 is a timing chart showing an example of a waveform of the source signal #SLₘ, which is supplied to the source bus line SLₘ. This waveform is the same as the waveform of the source signal #SLₘ shown in (a) of FIG. 3.

(b) of FIG. 5 is a timing chart showing a waveform of the gate signal #GLₙ, which is supplied to the gate bus line GLₙ. As shown in (b) of FIG. 5, the waveform of the gate signal #GLₙ in this example of operation is described as being the same as the waveform of the gate signal #GLₙ shown in (b) of FIG. 3.

(c) of FIG. 5 is a timing chart showing the common potential V_{COM}, which is supplied to the counter electrode wire COML, and a potential V_{PEn,m} that is applied to the pixel electrode PE_{n,m}.

(d) of FIG. 5 is a timing chart showing a waveform of the auxiliary capacitor signal #CSLₙ, which is supplied to the auxiliary capacitor bus line CSLₙ. As shown in (d) of FIG. 5, the auxiliary capacitor signal #CSLₙ in this example of operation is a signal that takes on a potential V_{CS1}′, a potential V_{CS2}′, and a potential V_{CS3}′ in a single cycle composed of two consecutive vertical scanning periods T_{V}′. More specifically, as shown in (d) of FIG. 5, the auxiliary capacitor signal #CSLₙ takes on the potential V_{CS2}′ during a period T₁′ in a single vertical scanning period T_{V}′, and takes on the potential V_{CS3}′ during a period T₂′. Further, the auxiliary capacitor signal #CSLₙ takes on the potential V_{CS2}′ during a period T₃′ in the ensuing vertical scanning period T_{V}′, and takes on the potential V_{CS1}′ during a period T₄′. It is assumed that as shown in (d) of FIG. 5, specific values of the potentials V_{CS1}′, V_{CS2}′, and V_{CS2}′ satisfy V_{CS1}′<V_{CS2}′<V_{CS3}′.

As shown in (c) and (d) of FIG. 5, when the auxiliary capacitor signal #CSLₙ is at the lowest potential (potential V_{CS1}′) and the gate signal #GLₙ is at a high level, the voltage that is applied to the liquid crystal LC changes into a positive polarity; and when the auxiliary capacitor signal #CSLₙ is at the highest potential (potential V_{CS3}′) and the gate signal #GLₙ is at a high level, the voltage that is applied to the liquid crystal LC changes into a negative polarity.

The following describes the operation of each of the components in the pixel region P_{n,m} of the display panel 1 in this example of operation.

First, as shown in (b) of FIG. 5, the gate signal #GLₙ rises from a low level to a high level at the time t₁′ and, after a certain period of time has elapsed, falls to a low level. In a period of time during which the gate signal #GLₙ is at a high level, the transistor M_{n,m} is in a conducting state. When the transistor M_{n,m} is in a conducting state, the source signal #SLₘ is supplied to the pixel electrode PE_{n,m} and the first auxiliary capacitor electrode CE1_{n,m}. As shown in (c) of FIG. 5, in a period from the time t₁′ to the time t₂′, the potential V_{PEn,m}, which is applied to the pixel electrode PE_{n,m}, rises from a potential V₁′ to a potential V₂′ (which is positive).

Further, the auxiliary capacitor signal #CSLₙ rises from the potential V_{CS1}′ to the potential V_{CS2}′ at the time t₂′. Since the gate signal #GLₙ is at a low level at this point in time, the transistor M_{n,m} is in a cutoff state. Therefore, a sum of the charge stored in the pixel electrode PE_{n,m} and the charge stored in the first auxiliary capacitor electrode CE1_{n,m} is invariable. Meanwhile, when the value of the auxiliary capacitor signal #CSLₙ changes, the charge stored in the pixel electrode PE_{n,m} and the charge stored in the first auxiliary capacitor electrode CE1_{n,m} change. Accordingly, the potential V_{PEn,m} of the pixel electrode PE_{n,m} changes from the potential V₂′ to a potential V₃′. It should be noted here that a specific value of the potential V₃′ is defined as:

V₃′=(V_{CS2}′−V_{CS1}′)×C_{CS}/Σ_{C}+V₂′.

Since V_{CS1}′<V_{CS2}′ as mentioned above, the potential V₃′ is greater than the potential V₂′.

Then, the auxiliary capacitor signal #CSLₙ rises from the potential V_{CS2}′ to the potential V_{CS3}′ at the time t₃′. Accordingly, the potential V_{PEn,m} of the pixel electrode PE_{n,m} changes from the potential V₃′ to a potential V₄′. It should be noted here that a specific value of the potential V₄′ is defined as:

V₄′=(V_{CS3}′−V_{CS2}′)×C_{CS}/Σ_{C}+V₃′.

Since V_{CS2}′<V_{CS3}′ as mentioned above, the potential V₄′ is greater than the potential V₃′.

Further, as shown in (c) of FIG. 5, the potential difference between the potential V₄′ and the common potential V_{COM} is greater than the potential difference between the potential V₃′ and the common potential V_{COM}. That is, the transmittance of the liquid crystal LC in a period from the time t₃′ to the time t₄′ is greater than the transmittance of the liquid crystal LC in a period from the time t₂′ to the time t₃′. That is, the brightness of the pixel region P_{n,m} in the period from the time t₃′ to the time t₄′ is greater than the brightness of the pixel region P_{n,m} in the period from the time t₂′ to the time t₃′.

Then, the gate signal #GLₙ rises from a low level to a high level at the time t₄′ and, after a certain period of time has elapsed, falls to a low level. In a period of time during which the gate signal #GLₙ is at a high level, the transistor M_{n,m} is in a conducting state, so that the source signal #SLₘ is supplied to the pixel electrode PE_{n,m} and the first auxiliary capacitor electrode CE1_{n,m}.

As shown in (c) of FIG. 5, in a period from the time t₄′ to the time t₅′, the potential V_{PEn,m}, which is applied to the pixel electrode PE_{n,m}, falls from the potential V₄′ to a potential V₅′ (which is negative).

Further, the auxiliary capacitor signal #CSLₙ falls from the potential V_{CS3}′ to the potential V_{CS2}′ at the time t₅′. Accordingly, the potential V_{PEn,m} of the pixel electrode PE_{n,m} changes from the potential V₅′ to a potential V₆′. It should be noted here that a specific value of the potential V₆′ is defined as:

V₆′=(V_{CS2}′−V_{CS3}′)×C_{CS}/Σ_{C}+V₅′.

Since V_{CS2}′<V_{CS3}′ as mentioned above, the potential V₆′ is smaller than the potential V₅′.

Then, the auxiliary capacitor signal #CSLₙ falls from the potential V_{CS2}′ to the potential V_{CS1}′ at the time t₆′. Accordingly, the potential V_{PEn,m} of the pixel electrode PE_{n,m} changes from the potential V₆′ to the potential V₁′. It should be noted here that a specific value of the potential V₁′ is defined as:

V₁′=(V_{CS1}′−V_{CS2}′)×C_{CS}/Σ_{C}+V₆′.

Since V_{CS1}′<V_{CS2}′ as mentioned above, the potential V₁′ is smaller than the potential V₆′.

Further, as shown in (c) of FIG. 5, the potential difference between the potential V₁′ and the common potential V_{COM} is greater than the potential difference between the potential V₆′ and the common potential V_{COM}. That is, the transmittance of the liquid crystal LC in a period from the time t₆′ to the time t₇′ is greater than the transmittance of the liquid crystal LC in a period from the time t₅′ to the time t₆′. That is, the brightness of the pixel region P_{n,m} in the period from the time t₆′ to the time t₇′ is greater than the brightness of the pixel region P_{n,m} in the period from the time t₅′ to the time t₆′.

The operation at the time t₇′ and later is the same as the operation at the time t₁′ and later.

The above example of operation has described a case where the auxiliary capacitor signal #CSLₙ rises from the potential V_{CS1}′ to the potential V_{CS2}′ at the time t₂′ and the auxiliary capacitor signal #CSLₙ falls from the potential V_{CS3}′ to the potential V_{CS2}′ at the time t₅′. However, more generally, the auxiliary capacitor signal #CSLₙ rises from the potential V_{CS1}′ to the potential V_{CS2}′ before several horizontal periods (period multiple times as long as a horizontal period Th) have elapsed since the time t₂′ and the auxiliary capacitor signal #CSLₙ falls from the potential V_{CS3}′ to the potential V_{CS2}′ before several horizontal periods (period multiple times as long as a horizontal period Th) have elapsed since the time t₅′.

Further, according to this example of operation, in the single scanning period (single vertical scanning period T_{V}′), the auxiliary capacitor driver 14 supplies the given auxiliary capacitor bus line with a rectangular voltage signal (auxiliary capacitor signal #CSLₙ) in synchronization with the conducting signal, the rectangular voltage signal being composed of the first voltage level, the second voltage level, and a third voltage level that is different from the first and second voltage levels.

That is, according to this example of operation, in the single scanning period (single vertical scanning period T_{V}′), the auxiliary capacitor driver 14 supplies a rectangular voltage signal (auxiliary capacitor signal #CSLₙ) composed of the potential V_{CS1}′, the potential V_{CS2}′, and the potential V_{CS3}′.

Therefore, according to this example of operation, in the single scanning period, the level of voltage that is applied to the given auxiliary capacitor bus line switches among three values. In other words, in the single scanning period, the level of voltage that is applied to the auxiliary capacitor bus line makes two transitions. The first transition between the voltage levels in the single scanning period causes a voltage that is applied to the liquid crystal after the first transitions between the voltage levels to be suitable for a display after the first transition between the voltage levels, and the second transition between the voltage levels allows switching between a high brightness and a low brightness.

That is, this example of operation makes a display at a higher brightness possible while effectively suppressing the phenomenon of blurring of moving images.

Further, according to this example of operation, in a case where when the gate driver 13 supplies the given gate bus line GLₙ with the conducting signal (high-level interval of the gate signal #GLₙ), the given auxiliary capacitor bus line CSLₙ is supplied with the lowest voltage level among the voltage levels, the auxiliary capacitor driver 14 supplies the given auxiliary capacitor bus line CSLₙ with the rectangular voltage signal #CSLₙ in the single scanning period (single vertical scanning period T_{V}′), the rectangular voltage signal #CSLₙ having its voltage levels arranged in an ascending order.

That is, as mentioned above, in a case where in the period from the time t₁′ to the time t₂′, the auxiliary capacitor bus line CSLₙ is supplied with the lowest voltage level V_{CS1}′ among the voltage levels V_{CS1}′, V_{CS2}′, and V_{CS3}′, the auxiliary capacitor driver 14 supplies the auxiliary capacitor bus line CSLₙ with an auxiliary capacitor signal #CSLₙ in a single scanning period from the time t₂′ to the time t₅′ (single vertical scanning period T_{V}′), the auxiliary capacitor signal #CSLₙ taking on the voltage level V_{CS2}′ in a period T₁′ from the time t₂′ to the time t₃′ and taking on the voltage level V_{CS3}′ (V_{CS2}′<V_{CS3}′) in a period T₂′ from the time t₃′ to the time t₅′.

Generally, in a normally black type in which a black display is carried out in a case where no voltage is applied to the pixel electrode, a phenomenon of insufficient rising from a low brightness to a high brightness occurs due to finite lengths of time of response of the liquid crystal. In other words, there is such a characteristic that the amount of time required to change from a low brightness to a high brightness is larger than the amount of time required to change from a high brightness to a low brightness. In a case where a signal that is applied to the pixel electrode has a positive polarity, such a phenomenon can occur at a timing when the potential of the pixel electrode changes to a high voltage.

According to the foregoing configuration, in a case where when the gate driver supplies the given gate bus line with the conducting signal, the given auxiliary capacitor bus line is supplied with the lowest voltage level among the voltage levels, the pixel electrode can be supplied with a voltage signal at a lower voltage and then with a voltage signal at a higher voltage level in the single scanning period.

This allows the potential that is applied to the pixel electrode to gradually change to a high voltage. This makes it possible to suppress the phenomenon of insufficient rising from a low brightness to a high brightness that can occur in a normally black type.

Further, according to this example of operation, in a case where when the gate driver 13 supplies the given gate bus line GLₙ with the conducting signal (high-level interval of the gate signal #GLₙ), the given auxiliary capacitor bus line CSLₙ is supplied with the highest voltage level among the voltage levels, the auxiliary capacitor driver 14 supplies the given auxiliary capacitor bus line CSLₙ with the rectangular voltage signal in the single scanning period, the rectangular voltage signal having its voltage levels arranged in a descending order.

That is, as mentioned above, in a case where in the period from the time t₄′ to the time t₅′, the auxiliary capacitor bus line CSLₙ is supplied with the highest voltage level V_{CS3}′ among the voltage levels V_{CS1}′, V_{CS2}′, and V_{CS3}′, the auxiliary capacitor driver 14 supplies the auxiliary capacitor bus line CSLₙ with a rectangular voltage signal #CSLₙ in a single scanning period (single vertical scanning period T_{V}′) from the time t₅′ to the time t₈′, the rectangular voltage signal #CSLₙ taking on the voltage level V_{CS2}′ in a period T₃′ from the time t₅′ to the time t₆′ and taking on the voltage level V_{CS1}′ (V_{CS1}′<V_{CS2}′) in a period T₄′ from the time t₆′ to the time t₈′.

Generally, in a normally black type in which a black display is carried out in a case where no voltage is applied to the pixel electrode, a phenomenon of insufficient rising from a low brightness to a high brightness occurs due to finite lengths of time of response of the liquid crystal. In other words, there is such a characteristic that the amount of time required to change from a low brightness to a high brightness is larger than the amount of time required to change from a high brightness to a low brightness. In a case where a signal that is applied to the pixel electrode has a negative polarity, such a phenomenon can occur at a timing when the potential of the pixel electrode changes to a low voltage.

According to the foregoing configuration, in a case where when the gate driver supplies the given gate bus line with the conducting signal, the given auxiliary capacitor bus line is supplied with the highest voltage level among the voltage levels, the pixel electrode can be supplied with a voltage signal at a higher voltage and then with a voltage signal at a lower voltage level in the single scanning period.

This allows the potential that is applied to the pixel electrode to gradually change to a low voltage. This makes it possible to suppress the phenomenon of insufficient rising from a low brightness to a high brightness that can occur in a normally black type.

Next, a case where the source driver 12 supplies the source bus line SLₘ with a source signal #SLₘ corresponding to a low tone is described with reference to (a) through (d) of FIG. 6. It should be noted that overlaps with the foregoing description are not described below.

(a) of FIG. 6 is a timing chart showing an example of a waveform of the source signal #SLₘ, which is supplied to the source bus line SLₘ. In the following, as shown in (a) of FIG. 6, a case where the potential of the source signal #SLₘ when the conducting signal #GLₙ is at a high level and the auxiliary capacitor bus line #CSLₙ is at a low level is lower than the potential of the waveform shown in (a) of FIG. 3 under the same conditions or a case where the potential of the source signal #SLₘ when the conducting signal #GLₙ is at a high level and the auxiliary capacitor bus line #CSLₙ is at a high level is higher than the potential of the waveform shown in (a) of FIG. 3 under the same conditions is described.

(b) of FIG. 6 is a timing chart showing a waveform of the gate signal #GLₙ, which is supplied to the gate bus line GLₙ. The waveform shown in (b) of FIG. 6 is the same as that shown in (b) of FIG. 3.

(c) of FIG. 6 is a timing chart showing the common potential V_{COM}, which is supplied to the counter electrode wire COML, and a potential V_{PEn,m} that is applied to the pixel electrode PE_{n,m}.

(d) of FIG. 6 is a timing chart showing a waveform of the auxiliary capacitor signal #CSLₙ, which is supplied to the auxiliary capacitor bus line CSLₙ. The waveform shown in (d) of FIG. 6 is the same as that shown in (d) of FIG. 5.

First, as shown in (b) of FIG. 6, the gate signal #GLₙ rises from a low level to a high level at the time t₁′ and, after a certain period of time has elapsed, falls to a low level. As shown in (c) of FIG. 6, in the period from the time t₁′ to the time t₂′, the potential V_{PEn,m}, that is applied to the pixel electrode PE_{n,m}, falls, for example, from a potential V₀₁′ to a potential V₀₂′.

Further, the auxiliary capacitor signal #CSLₙ rises from the potential V_{CS1}′ to the potential V_{CS2}′ at the time t₂′. Accordingly, the potential V_{PEn,m} of the pixel electrode PE_{n,m} changes from the potential V₀₂′, for example, to the potential V₀₁′.

Then, the auxiliary capacitor signal #CSLₙ rises from the potential V_{CS2}′ to the potential V_{CS3}′ at the time t₃′. Accordingly, the potential V_{PEn,m} of the pixel electrode PE_{n,m} changes from the potential V₀₁′ to a potential V₀₃′. It should be noted here that a specific value of the potential V₀₃′ is defined as:

V₀₃′=(V_{CS3}′−V_{CS2}′)×C_{CS}/Σ_{C}+V₀′.

Since V_{CS2}′<V_{CS3}′ as mentioned above, the potential V₀₃′ is greater than the potential V₀₁′.

Then, the gate signal #GLₙ rises from a low level to a high level at the time t₄′ and, after a certain period of time has elapsed, falls to a low level. As shown in (c) of FIG. 6, in the period from the time t₄′ to the time t₅′, the potential V_{PEn,m}, which is applied to the pixel electrode PE_{n,m}, rises from the potential V₀₁′ to a potential V₀₄′.

Further, the auxiliary capacitor signal #CSLₙ falls from the potential V_{CS3}′ to the potential V_{CS2}′ at the time t₅′. Accordingly, the potential V_{PEn,m} of the pixel electrode PE_{n,m} changes from the potential V₀₄′, for example, to the potential V₀₃′.

Then, the auxiliary capacitor signal #CSLₙ falls from the potential V_{CS2}′ to the potential V_{CS1}′ at the time t₆′. Accordingly, the potential V_{PEn,m} of the pixel electrode PE_{n,m} changes from the potential V₀₃′ to the potential V₀₁′.

The operation at the time t₇′ and later is the same as the operation at the time t₁′ and later.

As shown in (c) of FIG. 6, the absolute value of the potential difference between the potential V_{PEn,m} of the pixel electrode PE_{n,m} and the common potential V_{COM} is always kept substantially constant throughout all the periods. That is, the transmittance of the liquid crystal LC of the pixel region P_{n,m} can be kept substantially constant even in a case where the value of the auxiliary capacitor signal #CSLₙ is changed as shown in (d) of FIG. 6.

Further, according to this example of operation, in the single scanning period (single vertical scanning period T_{V}′), a polarity of a voltage that is applied to the liquid crystal after a first transition between the voltage levels and a polarity of a voltage that is applied to the liquid crystal after a next transition between the voltage levels are polarities that are different from each other. A voltage that is applied to the liquid crystal as represented by a difference between the potential V₀₁′ of the pixel electrode PE_{n,m} and the potential V_{COM} of the counter electrode when the auxiliary capacitor signal #CSLₙ is at the potential V_{CS2}′ and a voltage that is applied to the liquid crystal as represented by a difference between the potential V₀₃′ of the pixel electrode PE_{n,m} and the potential V_{COM} of the counter electrode when the auxiliary capacitor signal #CSLₙ is at the potential V_{CS3}′ are opposite in polarity to each other.

According to the foregoing configuration, regardless of whether after the first transition between the voltage levels or after the next transition between the voltage levels in the single scanning period, the absolute value of the voltage that is applied to the liquid crystal can be made sufficiently small.

Therefore, according to the foregoing configuration, in a normally black type in which the brightness is lower in a case where the absolute value of a voltage that is applied to the liquid crystal is smaller, a black display can be carried out at a sufficiently low brightness, regardless of whether after the first transition between the voltage levels or after the next transition between the voltage levels in the single scanning period.

Further, according to this example of operation, it is preferable that an absolute value of a potential difference between the middle voltage level among the first to third voltage levels and the highest voltage level among the first to third voltage levels be twice or less as great as a threshold voltage of the liquid crystal. That is, according to this example of operation, it is preferable that the absolute value of the potential difference between the middle potential V_{CS2}′ among the potentials V_{CS1}′, V_{CS2}′, and V_{CS3}′ and the highest potential V_{CS3}′ among the potentials V_{CS1}′, V_{CS2}′, and V_{CS3}′ be twice or less as great as the threshold voltage of the liquid crystal.

According to the foregoing configuration, the absolute value of the potential difference between the middle voltage level among the first to third voltage levels and the highest voltage level among the first to third voltage levels is twice or less as great as the threshold voltage of the liquid crystal; that is, in this example, the absolute value of the potential difference between the middle potential V_{CS2}′ among the potentials V_{CS1}′, V_{CS2}′, and V_{CS3}′ and the highest potential V_{CS3}′ among the potentials V_{CS1}′, V_{CS2}′, and V_{CS3}′ is twice or less as great as the threshold voltage of the liquid crystal. This makes it possible to prevent the orientation of the liquid crystal from being affected, regardless of which of the first to third voltage levels the rectangular voltage signal takes on.

Therefore, according to the foregoing configuration, in a normally black type in which the brightness is lower in a case where the absolute value of a voltage that is applied to the liquid crystal is smaller, a black display can be carried out regardless of which of the first to third voltage levels the rectangular voltage signal takes on.

(Example 3 of Operation of the Display Panel 1)

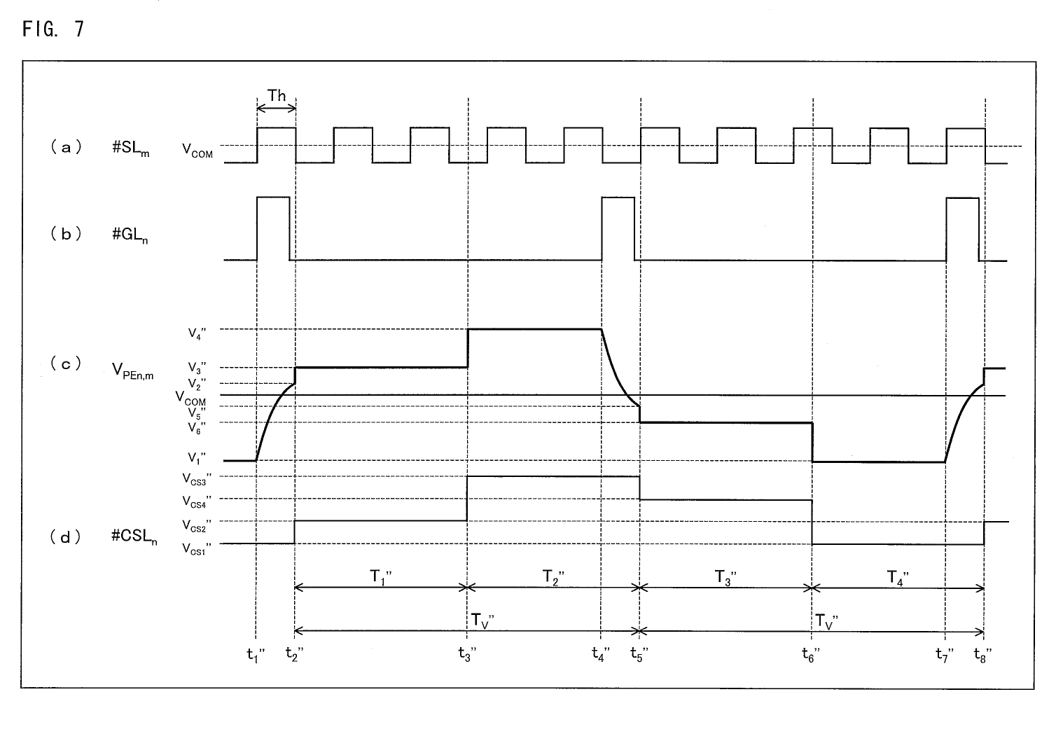

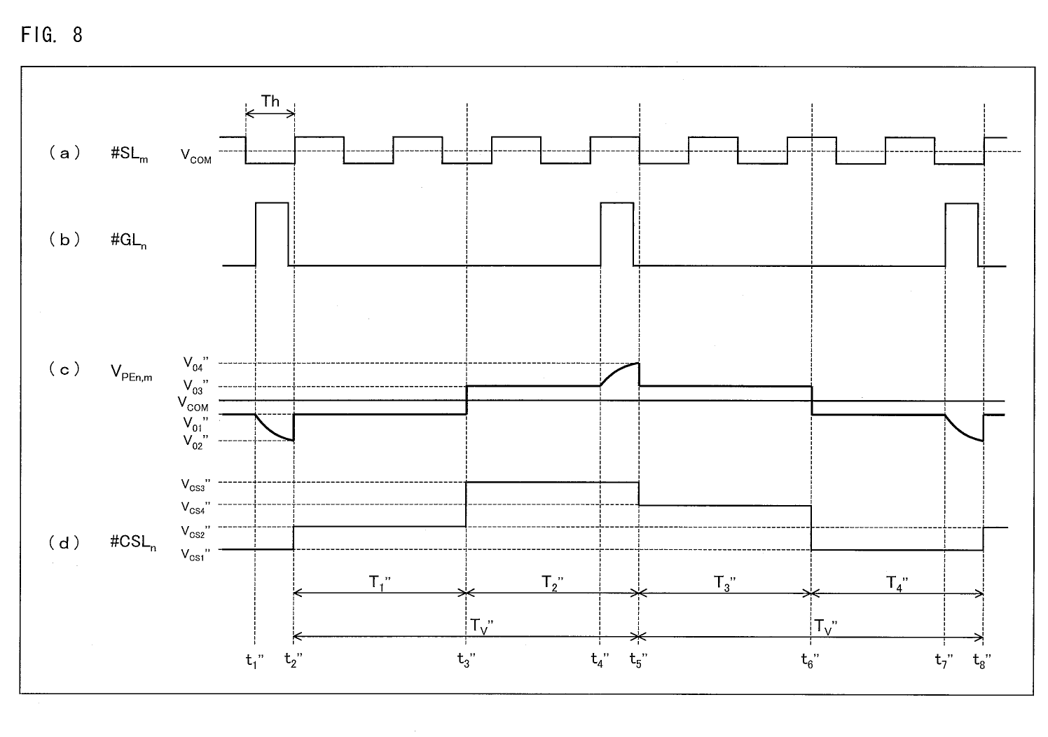

A third example of operation of the display panel 1 according to the present embodiment is described below with reference to (a) through (d) of FIG. 7 and (a) through (d) of FIG. 8.

First, a case where the source driver 12 supplies the source bus line SLₘ with a source signal #SLₘ corresponding to a high tone is described with reference to (a) through (d) of FIG. 7.

(a) of FIG. 7 is a timing chart showing an example of a waveform of the source signal #SLₘ, which is supplied to the source bus line SLₘ. As shown in (a) of FIG. 7, the waveform of the source signal #SLₘ in this example of operation is described as being the same as the waveform of the source signal #SLₘ shown in (a) of FIG. 3.

(b) of FIG. 7 is a timing chart showing a waveform of the gate signal #GLₙ, which is supplied to the gate bus line GLₙ. As shown in (b) of FIG. 7 the waveform of the gate signal #GLₙ in this example of operation is described as being the same as the waveform of the gate signal #GLₙ shown in (b) of FIG. 3.

(c) of FIG. 7 is a timing chart showing the common potential V_{COM}, which is supplied to the counter electrode wire COML, and a potential V_{PEn,m} that is applied to the pixel electrode PE_{n,m}.

(d) of FIG. 7 is a timing chart showing a waveform of the auxiliary capacitor signal #CSLₙ, which is supplied to the auxiliary capacitor bus line CSLₙ. As shown in (d) of FIG. 7, the auxiliary capacitor signal #CSLₙ in this example of operation is a signal that takes on a potential V_{CS1}″, a potential V_{CS2}″, a potential V_{CS3}″, and a potential V_{CS4}″ in a single cycle composed of two consecutive vertical scanning periods T_{V}″. More specifically, as shown in (d) of FIG. 7, the auxiliary capacitor signal #CSLₙ takes on the potential V_{CS2}″ during a period T₁″ in a single vertical scanning period T_{V}″, and takes on the potential V_{CS3}″ during a period T₂″. Further, the auxiliary capacitor signal #CSLₙ takes on the potential V_{CS4}″ during a period T₃″ in the ensuing vertical scanning period T_{V}′, and takes on the potential V_{CS1}″ during a period T₄″. It is assumed that as shown in (d) of FIG. 7, specific values of the potentials V_{CS1}″, V_{CS2}″, V_{CS3}″, and V_{CS4}″ satisfy V_{CS1}″<V_{CS2}″<V_{CS4}″<V_{CS3}″ and V_{CS2}″−V_{CS1}″<V_{CS3}″−V_{CS2}″, as well as V_{CS3}″−V_{CS4}″<V_{CS4}″−V_{CS1}″.

As shown in (c) and (d) of FIG. 7, when the auxiliary capacitor signal #CSLₙ is at the lowest potential (potential V_{CS1}″) and the gate signal #GLₙ is at a high level, the voltage that is applied to the liquid crystal LC changes into a positive polarity; and when the auxiliary capacitor signal #CSLₙ is at the highest potential (potential V_{CS3}″) and the gate signal #GLₙ is at a high level, the voltage that is applied to the liquid crystal LC changes into a negative polarity.

The following describes the operation of each of the components in the pixel region P_{n,m} of the display panel 1 in this example of operation.

First, as shown in (b) of FIG. 7, the gate signal #GLₙ rises from a low level to a high level at the time t₁″ and, after a certain period of time has elapsed, falls to a low level. In a period of time during which the gate signal #GLₙ is at a high level, the transistor M_{n,m} is in a conducting state. When the transistor M_{n,m} is in a conducting state, the source signal #SLₘ is supplied to the pixel electrode PE_{n,m} and the first auxiliary capacitor electrode CE1_{n,m}. As shown in (c) of FIG. 7, in a period from the time t₁″ to the time t₂″, the potential V_{PEn,m}, which is applied to the pixel electrode PE_{n,m}, rises from a potential V₁″ to a potential V₂″ (which is positive).

Further, the auxiliary capacitor signal #CSLₙ rises from the potential V_{CS1}″ to the potential V_{CS2}″ at the time t₂″. Accordingly, the potential V_{PEn,m} of the pixel electrode PE_{n,m} changes from the potential V₂″ to a potential V₃″. It should be noted here that a specific value of the potential V₃″ is defined as:

V₃″=(V_{CS2}″−V_{CS1}″)×C_{CS}/Σ_{C}+V₂″.

Since V_{CS1}″<V_{CS2}″ as mentioned above, the potential V₃″ is greater than the potential V₂″.

Then, the auxiliary capacitor signal #CSLₙ rises from the potential V_{CS2}″ to the potential V_{CS3}″ at the time t₃″. Accordingly, the potential V_{PEn,m} of the pixel electrode PE_{n,m} changes from the potential V₃″ to a potential V₄″. It should be noted here that a specific value of the potential V₄″ is defined as:

V₄″=(V_{CS3}″−V_{CS2}″)×C_{CS}/Σ_{C}+V₃″.

Since V_{CS2}″<V_{CS3}″ as mentioned above, the potential V₄″ is greater than the potential V₃″.

Further, as shown in (c) of FIG. 7, the potential difference between the potential V₄″ and the common potential V_{COM} is greater than the potential difference between the potential V₃″ and the common potential V_{COM}. That is, the transmittance of the liquid crystal LC in a period from the time t₃″ to the time t₄″ is greater than the transmittance of the liquid crystal LC in a period from the time t₂″ to the time t₃″. That is, the brightness of the pixel region P_{n,m} in the period from the time t₃″ to the time t₄″ is greater than the brightness of the pixel region P_{n,m} in the period from the time t₂″ to the time t₃″.

Then, the gate signal #GLₙ rises from a low level to a high level at the time t₄″ and, after a certain period of time has elapsed, falls to a low level. In a period of time during which the gate signal #GLₙ is at a high level, the transistor M_{n,m} is in a conducting state, so that the source signal #SLₘ is supplied to the pixel electrode PE_{n,m} and the first auxiliary capacitor electrode CE1_{n,m}.

As shown in (a) of FIG. 7, in a period from the time t₄″ to the time t₅″, the potential V_{PEn,m}, which is applied to the pixel electrode PE_{n,m}, falls from the potential V₄″ to a potential V₅″ (which is negative).

Further, the auxiliary capacitor signal #CSLₙ falls from the potential V_{CS3}″ to the potential V_{CS4}″ at the time t₅″. Accordingly, the potential V_{PEn,m} of the pixel electrode PE_{n,m} changes from the potential V₅″ to a potential V₆″. It should be noted here that a specific value of the potential V₆″ is defined as:

V₆″=(V_{CS4}″−V_{CS3}″)×C_{CS}/Σ_{C}+VS″.

Since V_{CS4}″<V_{CS3}″ as mentioned above, the potential V₆″ is smaller than the potential V₅″.

Then, the auxiliary capacitor signal #CSLₙ falls from the potential V_{CS4}″ to the potential V_{CS1}″ at the time t₆″. Accordingly, the potential V_{PEn,m} of the pixel electrode PE_{n,m} changes from the potential V₆″ to the potential V₁″. It should be noted here that a specific value of the potential V₁″ is defined as:

V₁″=(V_{CS1}″−V_{CS4}″)×C_{CS}/Σ_{C}+V₆″.

Since V_{CS1}″<V_{CS4}″ as mentioned above, the potential V₁″ is smaller than the potential V₆″.

Further, as shown in (c) of FIG. 7, the potential difference between the potential V₁″ and the common potential V_{COM} is greater than the potential difference between the potential V₆″ and the common potential V_{COM}. That is, the transmittance of the liquid crystal LC in a period from the time t₆″ to the time t₇″ is greater than the transmittance of the liquid crystal LC in a period from the time t₅″ to the time t₆″. That is, the brightness of the pixel region P_{n,m} in the period from the time t₆″ to the time t₇″ is greater than the brightness of the pixel region P_{n,m} in the period from the time t₅″ to the time t₆″.

The operation at the time t₇″ and later is the same as the operation at the time t₁″ and later.

The above example of operation has described a case where the auxiliary capacitor signal #CSLₙ rises from the potential V_{CS1}″ to the potential V_{CS2}″ at the time t₂″ and the auxiliary capacitor signal #CSLₙ falls from the potential V_{CS3}″ to the potential V_{CS4}″ at the time t₅″. However, more generally, the auxiliary capacitor signal #CSLₙ rises from the potential V_{CS1}″ to the potential V_{CS4}″ before several horizontal periods (period multiple times as long as a horizontal period Th) have elapsed since the time t₂″ and the auxiliary capacitor signal #CSLₙ falls from the potential V_{CS3}″ to the potential V_{CS2}″ before several horizontal periods (period multiple times as long as a horizontal period Th) have elapsed since the time t₅″.

Further, according to this example of operation, in the single scanning period (single vertical scanning period T_{V}″), the auxiliary capacitor driver 14 supplies the given auxiliary capacitor bus line CSLₙ with a rectangular voltage signal in synchronization with the conducting signal, the rectangular voltage signal being composed of the first voltage level, the second voltage level, and a third voltage level that is different from the first and second voltage levels, and in a single scanning period subsequent to the single scanning period (single vertical scanning period T_{V}″), the auxiliary capacitor driver 14 supplies the given auxiliary capacitor bus line CSLₙ with a rectangular voltage signal (auxiliary capacitor signal #CSLₙ) in synchronization with the conducting signal, the rectangular voltage signal being composed of any two of the first to third voltage levels and a fourth voltage level that is different from the first to third voltage levels.

That is, according to this example of operation, in the two consecutive vertical scanning periods, the auxiliary capacitor driver 14 supplies a rectangular voltage signal (auxiliary capacitor signal #CSLₙ) composed of the potential V_{CS1}″, the potential V_{CS2}″, the potential V_{CS3}″, and the potential V_{CS4}″.

Therefore, according to this example of operation, in the single scanning period, the auxiliary capacitor driver 14 can supply the given auxiliary capacitor bus line with a rectangular voltage signal in synchronization with the conducting signal, the rectangular voltage signal being composed of the first voltage level, the second voltage level, and a third voltage level that is different from the first and second voltage levels. Therefore, in the single scanning period, the level of voltage that is applied to the given auxiliary capacitor bus line switches among three values. In other words, in the single scanning period, the level of voltage that is applied to the auxiliary capacitor bus line makes two transitions. The first transition between the voltage levels in the single scanning period causes a voltage that is applied to the liquid crystal after the first transition between the voltage levels to be suitable for a display after the first transition between the voltage levels, and the second transition between the voltage levels allows switching between a high brightness and a low brightness.

Therefore, the foregoing configuration makes a display at a higher brightness possible while effectively suppressing the phenomenon of blurring of moving images.

Furthermore, the foregoing configuration makes it possible, in a single scanning period subsequent to the single scanning period, to supply a rectangular voltage signal composed of any two of the first to third voltage levels and a fourth voltage level that is different from the first to third voltage levels. Therefore, as compared with a case where a rectangular voltage signal composed of the first to third voltage levels is supplied in a single scanning period subsequent to the single scanning period, the adjustment of brightness levels between a high brightness and a low brightness can be more flexibly carried out.

Therefore, the foregoing configuration makes a display at a high brightness possible while further effectively suppressing the phenomenon of blurring of moving images.

Further, in the display panel according to the present invention, the absolute value |V_{CS2}″−V_{CS1}″| of the potential difference between the voltage level before a first transition between the voltage levels in the single scanning period (single vertical scanning period T_{V}″) and the voltage level after the first transition is smaller than the absolute value |V_{CS3}″−V_{CS2}″| of the potential difference between the voltage level before a next transition between the voltage levels in the single scanning period and the voltage level after the next transition. It is assumed here that the symbol |a| represents the absolute value of a.

Therefore, in this example of operation, a change in brightness of the pixel region P_{n,m} along with a transition between the voltage levels of the auxiliary capacitor signal #CSLₙ at the time t₃″ can be made larger while maintaining the effect of enhancing the brightness.

Therefore, in this example of operation, the phenomenon of blurring of moving images can be more effectively suppressed. The same applies to the single vertical scanning period T_{V}″ from the time t₅″ to the time t₈″.

Next, a case where the source driver 12 supplies the source bus line SLₘ with a source signal #SLₘ corresponding to a low tone is described with reference to (a) through (d) of FIG. 8. It should be noted that overlaps with the foregoing description are not described below.

(a) of FIG. 8 is a timing chart showing an example of a waveform of the source signal #SLₘ, which is supplied to the source bus line SLₘ. This waveform is the same as the waveform of the source signal #SLₘ shown in (a) of FIG. 6.

(b) of FIG. 8 is a timing chart showing a waveform of the gate signal #GLₙ, which is supplied to the gate bus line GLₙ. As shown in (b) of FIG. 8, the waveform of the gate signal #GLₙ in this example of operation is described as being the same as the waveform of the gate signal #GLₙ shown in (b) of FIG. 3.

(c) of FIG. 8 is a timing chart showing the common potential V_{COM}, which is supplied to the counter electrode wire COML, and a potential V_{PEn,m} that is applied to the pixel electrode PE_{n,m}.

(d) of FIG. 8 is a timing chart showing a waveform of the auxiliary capacitor signal #CSLₙ, which is supplied to the auxiliary capacitor bus line CSLₙ. The waveform shown in (d) of FIG. 8 is the same as that shown in (d) of FIG. 6.

First, as shown in (b) of FIG. 8, the gate signal #GLₙ rises from a low level to a high level at the time t₁″ and, after a certain period of time has elapsed, falls to a low level. As shown in (a) of FIG. 8, in the period from the time t₁″ to the time t₂″, the potential V_{PEn,m}, which is applied to the pixel electrode PE_{n,m}, falls from a potential V₀₁″ to a potential V₀₂″.

Further, the auxiliary capacitor signal #CSLₙ rises from the potential V_{CS1}″ to the potential V_{CS2}″ at the time t₂″. Accordingly, the potential V_{PEn,m} of the pixel electrode PE_{n,m} changes from the potential V₂″, for example, to the potential V₀₁″.

Then, the auxiliary capacitor signal #CSLₙ rises from the potential V_{CS2}″ to the potential V_{CS3}″ at the time t₃″. Accordingly, the potential V_{PEn,m} of the pixel electrode PE_{n,m} changes from the potential V₀₁″ to a potential V₀₃″. It should be noted here that a specific value of the potential V₀₃″ is defined as:

V₀₃″=(V_{CS3}″−V_{CS2}″)×C_{CS}/Σ_{C}+V₀″.

Since V_{CS2}″<V_{CS3}″ as mentioned above, the potential V₀₃″ is greater than the potential V₀₁″.

Then, the gate signal #GLₙ rises from a low level to a high level at the time t₄″ and, after a certain period of time has elapsed, falls to a low level. As shown in (c) of FIG. 8, in the period from the time t₄″ to the time t₅″, the potential V_{PEn,m}, which is applied to the pixel electrode PE_{n,m}, rises from the potential V₀₃″ to a potential V₀₄″.

Further, the auxiliary capacitor signal #CSLₙ falls from the potential V_{CS3}″ to the potential V_{CS4}″ at the time t₅″. Accordingly, the potential V_{PEn,m} of the pixel electrode PE_{n,m} changes from the potential V₀₄″, for example, to the potential V₀₃″.

Then, the auxiliary capacitor signal #CSLₙ falls from the potential V_{CS4}″ to the potential V_{CS1}″ at the time t₆″. Accordingly, the potential V_{PEn,m} of the pixel electrode PE_{n,m} changes from the potential V₀₃″, for example, to the potential V₀₁″.

The operation at the time t₇″ and later is the same as the operation at the time t₁″ and later.

As shown in (c) of FIG. 8, the absolute value of the potential difference between the potential V_{PEn,m} of the pixel electrode PE_{n,m} and the common potential V_{COM} is always kept substantially constant throughout all the periods. That is, the transmittance of the liquid crystal LC of the pixel region P_{n,m} can be kept substantially constant even in a case where the value of the auxiliary capacitor signal #CSLₙ is changed as shown in (d) of FIG. 8.

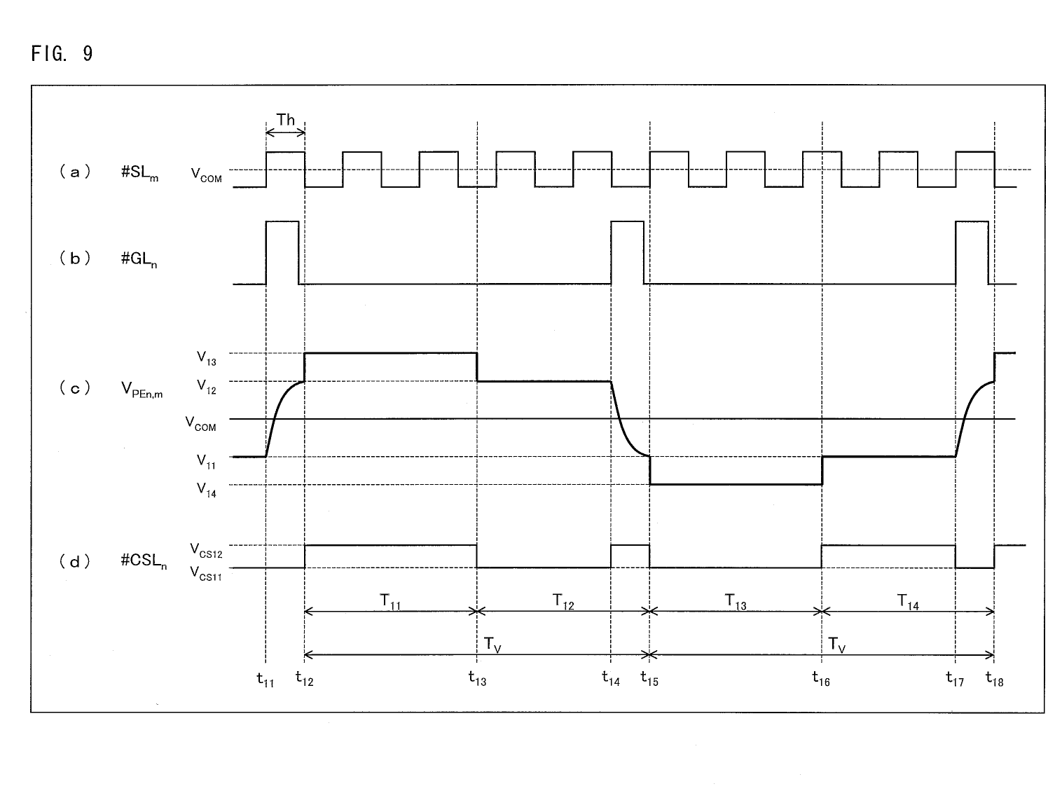

Each of the above examples 1 to 3 of operation has described a case where the brightness of the pixel region P_{n,m} in the second half of a single vertical scanning period is greater than the brightness of the pixel region P_{n,m} in the first half of the single vertical scanning period. However, the present invention is not to be limited to these examples. In the following, examples 4 to 6 of operation, where the brightness of the pixel region P_{n,m} in the second half of a single vertical scanning period is smaller than the brightness of the pixel region P_{n,m} in the first half of the single vertical scanning period, are described with reference to FIGS. 9 through 11.

According to this example of operation, in the single scanning period single vertical scanning period T_{V}″, a polarity of a voltage that is applied to the liquid crystal as represented by a difference between a potential of the pixel electrode and a potential of the counter electrode after a first transition between the voltage levels and a polarity of a voltage that is applied to the liquid crystal as represented by a difference between a potential of the pixel electrode and the potential of the counter electrode after a next transition between the voltage levels are polarities that are different from each other. That is, a voltage that is applied to the liquid crystal as represented by a difference between the potential V₀₁″ of the pixel electrode PE_{n,m} and the potential V_{COM} of the counter electrode when the auxiliary capacitor signal #CSLₙ is at the potential V_{CS2}″ and a voltage that is applied to the liquid crystal as represented by a difference between the potential V₀₃″ of the pixel electrode PE_{n,m} and the potential V_{COM} of the counter electrode when the auxiliary capacitor signal #CSLₙ is at the potential V_{CS3}″ are opposite in polarity to each other.

According to the foregoing configuration, regardless of whether after the first transition between the voltage levels or after the next transition between the voltage levels in the single scanning period, the absolute value of the voltage that is applied to the liquid crystal can be made sufficiently small.

Therefore, according to the foregoing configuration, in a normally black type in which the brightness is lower in a case where the absolute value of a voltage that is applied to the liquid crystal is smaller, a black display can be carried out at a sufficiently low brightness, regardless of whether after the first transition between the voltage levels or after the next transition between the voltage levels in the single scanning period.

Further, according to this example of operation, it is preferable that an absolute value of a potential difference between the second lowest voltage level among the first to fourth voltage levels and the highest voltage level among the first to fourth voltage levels be twice or less as great as a threshold voltage of the liquid crystal. That is, according to this example of operation, it is preferable that the absolute value of the potential difference between the second lowest potential V_{CS2}″ among the potentials V_{CS1}″, V_{CS2}″, V_{CS3}″, and V_{CS4}″ and the highest potential V_{CS3}″ among the potentials V_{CS1}″, V_{CS2}″, V_{CS3}″, and V_{CS4}″ be twice or less as great as the threshold voltage of the liquid crystal.

According to the foregoing configuration, it is preferable that the absolute value of the potential difference between the second lowest voltage level among the first to fourth voltage levels and the highest voltage level among the first to fourth voltage levels be twice or less as great as the threshold voltage of the liquid crystal. That is, according to this example of operation, the absolute value of the potential difference between the second lowest potential V_{CS2}″ among the potentials V_{CS1}″, V_{CS2}″, V_{CS3}″, and V_{CS4}″ and the highest potential V_{CS3}″ among the potentials V_{CS1}″, V_{CS2}″, V_{CS3}″, and V_{CS4}″ is twice or less as great as the threshold voltage of the liquid crystal. This makes it possible to prevent the orientation of the liquid crystal from being affected, regardless of which of the third and fourth voltage levels the rectangular voltage signal takes on.

Therefore, according to the foregoing configuration, in a normally black type in which the brightness is lower in a case where the absolute value of a voltage that is applied to the liquid crystal is smaller, a black display can be carried out regardless of which of the first to fourth voltage levels the rectangular voltage signal takes on.

(Example 4 of Operation of the Display Panel 1)

A fourth example of operation of the display panel 1 according to the present embodiment is described below with reference to (a) through (d) of FIG. 9.

(a) of FIG. 9 is a timing chart showing an example of a waveform of the source signal #SLₘ, which is supplied to the source bus line SLₘ. As shown in (a) of FIG. 9, the waveform of the source signal #SLₘ in this example of operation is described as being substantially the same as the waveform of the source signal #SLₘ shown in (a) of FIG. 3.

(b) of FIG. 9 is a timing chart showing a waveform of the gate signal #GLₙ, which is supplied to the gate bus line GLₙ. As shown in (b) of FIG. 9, the waveform of the gate signal #GLₙ in this example of operation is described as being the same as the waveform of the gate signal #GLₙ shown in (b) of FIG. 3.

(c) of FIG. 9 is a timing chart showing the common potential V_{COM}, which is supplied to the counter electrode wire COML, and a potential V_{PEn,m} that is applied to the pixel electrode PE_{n,m}.

(d) of FIG. 9 is a timing chart showing a waveform of the auxiliary capacitor signal #CSLₙ, which is supplied to the auxiliary capacitor bus line CSLₙ. As shown in (d) of FIG. 9, the auxiliary capacitor signal #CSLₙ in this example of operation is a signal that takes on a potential V_{CS11} and a potential V_{CS12} in a single cycle composed of two consecutive vertical scanning periods T_{V}. More specifically, as shown in (d) of FIG. 9, the auxiliary capacitor signal #CSLₙ takes on the potential V_{CS12} during a period T₁₁ in a single vertical scanning period T_{V}, takes on the potential V_{CS11} from a time t₁₃ to a time t₁₄ in a period T₁₂, and takes on the potential V_{CS12} from the time t₁₄ to a time t₁₅ in the period T₁₂. Further, the auxiliary capacitor signal #CSLₙ takes on the potential V_{CS11} during a period T₁₃ in the ensuing vertical scanning period T_{V}, takes on the potential V_{CS12} from a time t₁₆ to a time t₁₇ in a period T₁₄, and takes on the potential V_{CS11} from the time t₁₇ to a time t₁₈ in the period T₁₄. It is assumed that as shown in (d) of FIG. 9, specific values of the potentials V_{CS11} and V_{CS12} satisfy V_{CS11}<V_{CS12}.

The following describes the operation of each of the components in the pixel region P_{n,m} of the display panel 1 in this example of operation.

First, as shown in (b) of FIG. 9, the gate signal #GLₙ rises from a low level to a high level at the time t₁₁ and, after a certain period of time has elapsed, falls to a low level. In a period of time during which the gate signal #GLₙ is at a high level, the transistor M_{n,m} is in a conducting state. When the transistor M_{n,m} is in a conducting state, the source signal #SLₘ is supplied to the pixel electrode PE_{n,m} and the first auxiliary capacitor electrode CE1_{n,m}. As shown in (c) of FIG. 9, in a period from the time t₁₁ to the time t₁₂, the potential V_{PEn,m}, which is applied to the pixel electrode PE_{n,m}, rises from a potential V₁₁ to a potential V₁₂ (which is positive).

Further, the auxiliary capacitor signal #CSLₙ rises from the potential V_{CS11} to the potential V_{CS12} at the time t₁₂. Accordingly, the potential V_{PEn,m} of the pixel electrode PE_{n,m} changes from the potential V₁₂ to a potential V₁₃. It should be noted here that a specific value of the potential V₁₃ is defined as:

V₁₃=(V_{CS12}−V_{CS11})×C_{CS}/Σ_{C}+V₁₂.

Since V_{CS11}<V_{CS12} as mentioned above, the potential V₁₃ is greater than the potential V₁₂.

Then, the auxiliary capacitor signal #CSLₙ falls from the potential V_{CS12} to the potential V_{CS11} at the time t₁₃. Accordingly, the potential V_{PEn,m} of the pixel electrode PE_{n,m} changes from the potential V₁₃ to the potential V₁₂.

Further, as shown in (c) of FIG. 9, the potential difference between the potential V₁₃ and the common potential V_{COM} is greater than the potential difference between the potential V₁₂ and the common potential V_{COM}. That is, the transmittance of the liquid crystal LC in a period from the time t₁₂ to the time t₁₃ is greater than the transmittance of the liquid crystal LC in a period from the time t₁₃ to the time t₁₄. That is, the brightness of the pixel region P_{n,m} in the period from the time t₁₂ to the time t₁₃ is greater than the brightness of the pixel region P_{n,m} in the period from the time t₁₃ to the time t₁₄.

Then, the gate signal #GLₙ rises from a low level to a high level at the time t₁₄ and, after a certain period of time has elapsed, falls to a low level. In a period of time during which the gate signal #GLₙ is at a high level, the transistor M_{n,m} is in a conducting state, and the source signal #SLₘ is supplied to the pixel electrode PE_{n,m} and the first auxiliary capacitor electrode CE1_{n,m}. Further, the auxiliary capacitor signal #CSLₙ rises from the potential V_{CS11} to the potential V_{CS12} at the time t₁₄.

As shown in (a) of FIG. 9, in the period from the time t₁₄ to the time t₁₅, the potential V_{PEn,m}, which is applied to the pixel electrode PE_{n,m}, falls from the potential V₁₂, for example, to the potential V₁₁.

Further, the auxiliary capacitor signal #CSLₙ falls from the potential V_{CS12} to the potential V_{CS11} at the time t₁₅. Accordingly, the potential V_{PEn,m} of the pixel electrode PE_{n,m} changes from the potential V₁₁ to a potential V₁₄. It should be noted here that a specific value of the potential V₁₄ is defined as:

V₁₄=(V_{CS11}−V_{CS12})×C_{CS}/ΣC+V₁₁.

Since V_{CS11}<V_{CS12} as mentioned above, the potential V₁₄ is smaller than the potential V₁₁.

Then, the auxiliary capacitor signal #CSLₙ rises from the potential V_{CS11} to the potential V_{CS12} at the time t₁₆. Accordingly, the potential V_{PEn,m} of the pixel electrode PE_{n,m} changes from the potential V₁₄ to the potential V₁₁.

As shown in (c) of FIG. 9, the potential difference between the potential V₁₄ and the common potential V_{COM} is greater than the potential difference between the potential V₁₁ and the common potential V_{COM}. That is, the transmittance of the liquid crystal LC in a period from the time t₁₅ to the time t₁₆ is greater than the transmittance of the liquid crystal LC in a period from the time t₁₆ to the time t₁₇. That is, the brightness of the pixel region P_{n,m} in the period from the time t₁₅ to the time t₁₆ is greater than the brightness of the pixel region P_{n,m} in the period from the time t₁₆ to the time t₁₇.

Then, the gate signal #GLₙ rises from a low level to a high level at the time t₁₇ and, after a certain period of time has elapsed, falls to a low level. Further, the auxiliary capacitor signal #CSLₙ falls from the potential V_{CS12} to the potential V_{CS11}. The operation at the time t₁₇ and later is the same as the operation at the time t₁₁ and later.

The above example of operation has described a case where the auxiliary capacitor signal #CSLₙ rises from the potential V_{CS11} to the potential V_{CS12} at the time t₁₂ and the auxiliary capacitor signal #CSLₙ falls from the potential V_{CS12} to the potential V_{CS11} at the time t₁₅. However, more generally, the auxiliary capacitor signal #CSLₙ rises from the potential V_{CS11} to the potential V_{CS12} before several horizontal periods (period multiple times as long as a horizontal period Th) have elapsed since the time t₁₂ and the auxiliary capacitor signal #CSLₙ falls from the potential V_{CS12} to the potential V_{CS11} before several horizontal periods (period multiple times as long as a horizontal period Th) have elapsed since the time t₁₅.

Further, the above example of operation has described a case where the auxiliary capacitor signal #CSLₙ rises from the potential V_{CS11} to the potential V_{CS12} at the time t₁₄. However, more generally, the auxiliary capacitor signal #CSLₙ rises from the potential V_{CS11} to the potential V_{CS12} in a period from the time t₁₃ to the time t₁₅.

As in this example of operation, the display panel 1 according to the present invention can also cause a change in brightness of the pixel region P_{n,m} in a single vertical scanning period by supplying the auxiliary capacitor signal #CSLₙ in such a way that the brightness of the pixel region P_{n,m} in the second half of a single vertical scanning period is smaller than the brightness of the pixel region P_{n,m} in the first half of the single vertical scanning period.

Therefore, in this example of operation, too, the phenomenon of blurring of moving images can be suppressed.

(Example 5 of Operation of the Display Panel 1)

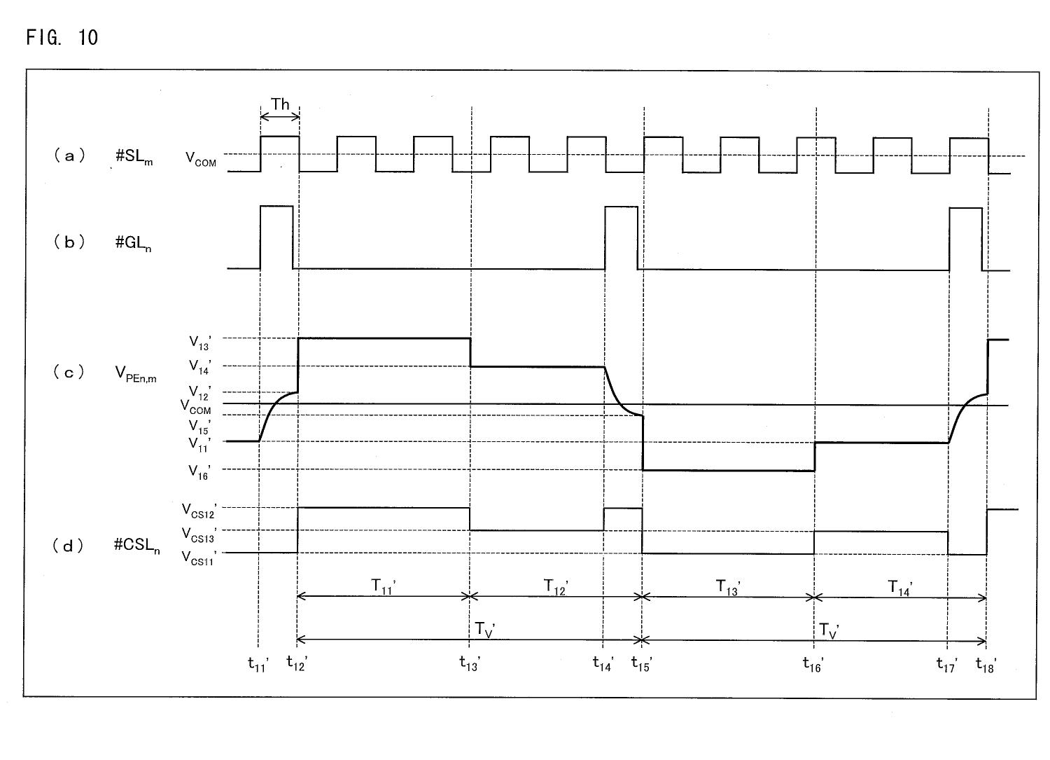

A fifth example of operation of the display panel 1 according to the present embodiment is described below with reference to (a) through (d) of FIG. 10.

(a) of FIG. 10 is a timing chart showing an example of a waveform of the source signal #SLₘ, which is supplied to the source bus line SLₘ. As shown in (a) of FIG. 10, the waveform of the source signal #SLₘ in this example of operation is described as being substantially the same as the waveform of the source signal #SLₘ shown in (a) of FIG. 3.

(b) of FIG. 10 is a timing chart showing a waveform of the gate signal #GLₙ, which is supplied to the gate bus line GLₙ. As shown in (b) of FIG. 10, the waveform of the gate signal #GLₙ in this example of operation is described as being substantially the same as the waveform of the gate signal #GLₙ shown in (b) of FIG. 3.

(c) of FIG. 10 is a timing chart showing the common potential V_{COM}, which is supplied to the counter electrode wire COML, and a potential V_{PEn,m} that is applied to the pixel electrode PE_{n,m}.

(d) of FIG. 10 is a timing chart showing a waveform of the auxiliary capacitor signal #CSLₙ, which is supplied to the auxiliary capacitor bus line CSLₙ. As shown in (d) of FIG. 10, the auxiliary capacitor signal #CSLₙ in this example of operation is a signal that takes on a potential V_{CS11}′, a potential V_{CS12}′, and a potential V_{CS13}′ in a single cycle composed of two consecutive vertical scanning periods T_{V}′. More specifically, as shown in (d) of FIG. 10, the auxiliary capacitor signal #CSLₙ takes on the potential V_{CS12}′ during a period T₁₁′ in a single vertical scanning period T_{V}′, takes on the potential V_{CS13}′ from a time t₁₃′ to a time t₁₄′ in a period T₁₂′, and takes on the potential V_{CS12}′ from the time t₁₄′ to a time t₁₅′ in the period T₁₂′. Further, the auxiliary capacitor signal #CSLₙ takes on the potential V_{CS11}′ during a period T₁₃′ in the ensuing vertical scanning period T_{V}′, takes on the potential V_{CS13}′ from a time t₁₆′ to a time t₁₇′ in a period T₁₄′, and takes on the potential V_{CS11}′ from the time t₁₇′ to a time t₁₈′ in the period T₁₄′. It is assumed that as shown in (d) of FIG. 10, specific values of the potentials V_{CS11}′, V_{CS12}′, and V_{CS13}′ satisfy V_{CS11}′<V_{CS13}′<V_{CS12}′.

The following describes the operation of each of the components in the pixel region P_{n,m} of the display panel 1 in this example of operation.

First, as shown in (b) of FIG. 10, the gate signal #GLₙ rises from a low level to a high level at the time t₁₁′ and, after a certain period of time has elapsed, falls to a low level. In a period of time during which the gate signal #GLₙ is at a high level, the transistor M_{n,m}, is in a conducting state. When the transistor M_{n,m}, is in a conducting state, the source signal #SLₘ is supplied to the pixel electrode PE_{n,m} and the first auxiliary capacitor electrode CE1_{n,m}. As shown in (a) of FIG. 10, in a period from the time t₁₁′ to the time t₁₂′, the potential V_{PEn,m}, which is applied to the pixel electrode PE_{n,m}, rises from a potential V₁₁′ to a potential V₁₂′ (which is positive).

Further, the auxiliary capacitor signal #CSLₙ rises from the potential V_{CS11}′ to the potential V_{CS12}′ at the time t₁₂′. Accordingly, the potential V_{PEn,m} of the pixel electrode PE_{n,m} changes from the potential V₁₂′ to a potential V₁₃′. It should be noted here that a specific value of the potential V₁₃′ is defined as:

V₁₃′=(V_{CS12}′−V_{CS11}′)×C_{CS}/Σ_{C}+V₁₂′.

Since V_{CS11}′<V_{CS12}′ as mentioned above, the potential V₁₃′ is greater than the potential V₁₂′.

Then, the auxiliary capacitor signal #CSLₙ falls from the potential V_{CS12}′ to the potential V_{CS13}′ at the time t₁₃′. Accordingly, the potential V_{PEn,m} of the pixel electrode PE_{n,m} changes from the potential V₁₃′ to a potential V₁₄′. It should be noted here that a specific value of the potential V₁₄′ is defined as:

V₁₄′=(V_{CS13}′−V_{CS12}′)×C_{CS}/Σ_{C}+V₁₃′.

Since V_{CS13}′<V_{CS12}′ as mentioned above, the potential V₁₄′ is smaller than the potential V₁₃′.

As shown in (c) of FIG. 10, the potential difference between the potential V₁₃′ and the common potential V_{COM} is greater than the potential difference between the potential V₁₄′ and the common potential V_{COM}. That is, the transmittance of the liquid crystal LC in a period from the time t₁₂′ to the time t₁₃′ is greater than the transmittance of the liquid crystal LC in a period from the time t₁₃′ to the time t₁₄′. That is, the brightness of the pixel region P_{n,m} in the period from the time t₁₂′ to the time t₁₃′ is greater than the brightness of the pixel region P_{n,m} in the period from the time t₁₃′ to the time t₁₄′.

Then, the gate signal #GLₙ rises from a low level to a high level at the time t₁₄′ and, after a certain period of time has elapsed, falls to a low level. In a period of time during which the gate signal #GLₙ is at a high level, the transistor M_{n,m} is in a conducting state, and the source signal #SLₘ is supplied to the pixel electrode PE_{n,m} and the first auxiliary capacitor electrode CE1_{n,m}. Further, the auxiliary capacitor signal #CSLₙ rises from the potential V_{CS13}′ to the potential V_{CS12}′ at the time t₁₄′.

As shown in (c) of FIG. 10, in the period from the time t₁₄′ to the time t₁₅′, the potential V_{PEn,m}, which is applied to the pixel electrode PE_{n,m}, falls from the potential V₁₄′ to a potential V₁₅′ (which is negative).

Further, the auxiliary capacitor signal #CSLₙ falls from the potential V_{CS12}′ to the potential V_{CS11}′ at the time t₁₅′. Accordingly, the potential V_{PEn,m} of the pixel electrode PE_{n,m} changes from the potential V₁₅′ to a potential V₁₆′. It should be noted here that a specific value of the potential V₁₆′ is defined as:

V₁₆′=(V_{CS11}′−V_{CS12}′)×C_{CS}/Σ_{C}+V₁₅′.

Since V_{CS11}′<V_{CS12}′ as mentioned above, the potential V₁₆′ is smaller than the potential V₁₅′.

Then, the auxiliary capacitor signal #CSLₙ rises from the potential V_{CS11}′ to the potential V_{CS13}′ at the time t₁₆′. Accordingly, the potential V_{PEn,m} of the pixel electrode PE_{n,m} changes from the potential V₁₆′ to the potential V₁₁′.

As shown in (c) of FIG. 10, the potential difference between the potential V₁₆′ and the common potential V_{COM} is greater than the potential difference between the potential V₁₁′ and the common potential V_{COM}. That is, the transmittance of the liquid crystal LC in a period from the time t₁₅′ to the time t₁₆′ is greater than the transmittance of the liquid crystal LC in a period from the time t₁₆′ to the time t₁₇′. That is, the brightness of the pixel region P_{n,m} in the period from the time t₁₅′ to the time t₁₆′ is greater than the brightness of the pixel region P_{n,m} in the period from the time t₁₆′ to the time t₁₇′.

Then, the gate signal #GLₙ rises from a low level to a high level at the time t₁₇′ and, after a certain period of time has elapsed, falls to a low level. Further, the auxiliary capacitor signal #CSLₙ falls from the potential V_{CS12}′ to the potential V_{CS11}′. The operation at the time t₁₇′ and later is the same as the operation at the time t₁₁′ and later.

The above example of operation has described a case where the auxiliary capacitor signal #CSLₙ rises from the potential V_{CS11}′ to the potential V_{CS12}′ at the time t₁₂′ and the auxiliary capacitor signal #CSLₙ falls from the potential V_{CS12}′ to the potential V_{CS11}′ at the time t₁₅′. However, more generally, the auxiliary capacitor signal #CSLₙ rises from the potential V_{CS11}′ to the potential V_{CS12}′ before several horizontal periods (period multiple times as long as a horizontal period Th) have elapsed since the time t₁₂′ and the auxiliary capacitor signal #CSLₙ falls from the potential V_{CS12}′ to the potential V_{CS11}′ before several horizontal periods (period multiple times as long as a horizontal period Th) have elapsed since the time t₁₅′.

Further, the above example of operation has described a case where the auxiliary capacitor signal #CSLₙ rises from the potential V_{CS13}′ to the potential V_{CS12}′ at the time t₁₄′. However, more generally, the auxiliary capacitor signal #CSLₙ rises from the potential V_{CS13}′ to the potential V_{CS12}′ in a period from the time t₁₃′ to the time t₁₅′.

As in this example of operation, the display panel 1 according to the present invention can also cause a change in brightness of the pixel region P_{n,m} in a single vertical scanning period by supplying the auxiliary capacitor signal #CSLₙ in such a way that the brightness of the pixel region P_{n,m} in the second half of a single vertical scanning period is smaller than the brightness of the pixel region P_{n,m} in the first half of the single vertical scanning period.

Therefore, in this example of operation, too, the phenomenon of blurring of moving images can be suppressed. Further, in this example of operation, the auxiliary capacitor signal #CSLₙ takes on a three-valued voltage level. Therefore, as compared with the example 4 of operation described above, a display at a high brightness can be carried out while maintaining the effect of suppressing the phenomenon of blurring of moving images.

(Example 6 of Operation of the Display Panel 1)

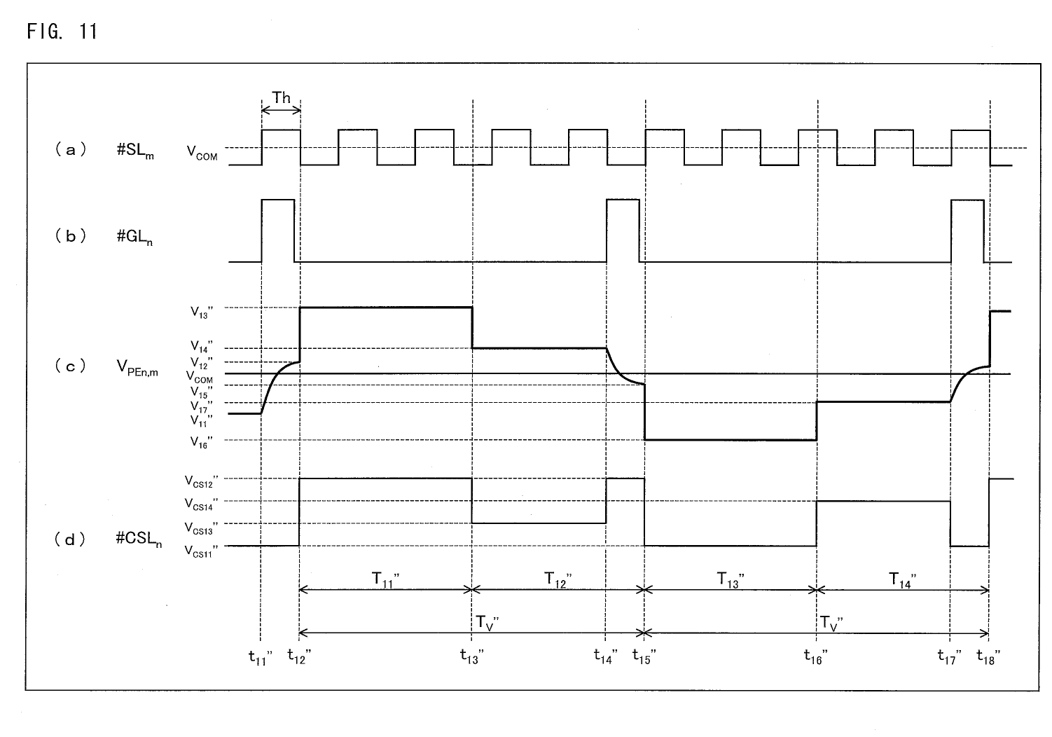

A sixth example of operation of the display panel 1 according to the present embodiment is described below with reference to (a) through (d) of FIG. 11.

(a) of FIG. 11 is a timing chart showing an example of a waveform of the source signal #SLₘ, which is supplied to the source bus line SLₘ. As shown in (a) of FIG. 11, the waveform of the source signal #SLₘ in this example of operation is described as being substantially the same as the waveform of the source signal #SLₘ shown in (a) of FIG. 3.

(b) of FIG. 11 is a timing chart showing a waveform of the gate signal #GLₙ, which is supplied to the gate bus line GLₙ. As shown in (b) of FIG. 11, the waveform of the gate signal #GLₙ in this example of operation is described as being substantially the same as the waveform of the gate signal #GLₙ shown in (b) of FIG. 3.

(c) of FIG. 11 is a timing chart showing the common potential V_{COM}, which is supplied to the counter electrode wire COML, and a potential V_{PEn,m} that is applied to the pixel electrode PE_{n,m}.

(d) of FIG. 11 is a timing chart showing a waveform of the auxiliary capacitor signal #CSLₙ, which is supplied to the auxiliary capacitor bus line CSLₙ. As shown in (d) of FIG. 11, the auxiliary capacitor signal #CSLₙ in this example of operation is a signal that takes on a potential V_{CS11}″, a potential V_{CS12}″, a potential V_{CS13}″, and a potential V_{CS14}″ in a single cycle composed of two consecutive vertical scanning periods T_{V}″. More specifically, as shown in (d) of FIG. 11, the auxiliary capacitor signal #CSLₙ takes on the potential V_{CS12}′ during a period T₁₁″ in a single vertical scanning period T_{V}″, takes on the potential V_{CS13}″ from a time t₁₃″ to a time t₁₄″ in a period T₁₂″, and takes on the potential V_{CS12}″ from the time t₁₄″ to a time t₁₅″ in the period T₁₂″. Further, the auxiliary capacitor signal #CSLₙ takes on the potential V_{CS11}″ during a period T₁₃″ in the ensuing vertical scanning period T_{V}″, takes on the potential V_{CS14}″ from a time t₁₆″ to a time t₁₇″ in a period T₁₄″, and takes on the potential V_{CS11}″ from the time t₁₇″ to a time t₁₈″ in the period T₁₄″. It is assumed that as shown in (d) of FIG. 11, specific values of the potentials V_{CS11}″, V_{CS12}″, V_{CS13}″, and V_{CS14}″ satisfy V_{CS11}″<V_{CS13}″<V_{CS14}″<V_{CS12}″.

The following describes the operation of each of the components in the pixel region P_{n,m} of the display panel 1 in this example of operation.

First, as shown in (b) of FIG. 11, the gate signal #GLₙ rises from a low level to a high level at the time t₁₁″ and, after a certain period of time has elapsed, falls to a low level. In a period of time during which the gate signal #GLₙ is at a high level, the transistor M_{n,m} is in a conducting state. When the transistor M_{n,m} is in a conducting state, the source signal #SLₘ is supplied to the pixel electrode PE_{n,m} and the first auxiliary capacitor electrode CE1_{n,m}. As shown in (c) of FIG. 11, in a period from the time t₁₁″ to the time t₁₂″, the potential V_{PEn,m}, which is applied to the pixel electrode PE_{n,m}, rises from a potential V₁₁″ to a potential V₁₂″ (which is positive).

Further, the auxiliary capacitor signal #CSLₙ rises from the potential V_{CS11}″ to the potential V_{CS12}″ at the time t₁₂″. Accordingly, the potential V_{PEn,m} of the pixel electrode PE_{n,m} changes from the potential V₁₂″ to a potential V₁₃″. It should be noted here that a specific value of the potential V₁₃″ is defined as:

V₁₃″=(V_{CS12}″−V_{CS11}″)×C_{CS}/Σ_{C}+V₁₂″.

Since V_{CS11}″<V_{CS12}″ as mentioned above, the potential V₁₃″ is greater than the potential V₁₂″.

Then, the auxiliary capacitor signal #CSLₙ falls from the potential V_{CS12}″ to the potential V_{CS13}″ at the time t₁₃″. Accordingly, the potential V_{PEn,m} of the pixel electrode PE_{n,m} changes from the potential V₁₃″ to a potential V₁₄″. It should be noted here that a specific value of the potential V₁₄″ is defined as:

V₁₄″=(V_{CS13}″−V_{CS12}″)×C_{CS}/Σ_{C}+V₁₃″.

Since V_{CS13}″<V_{CS12}″ as mentioned above, the potential V₁₄″ is smaller than the potential V₁₃″.

As shown in (c) of FIG. 11, the potential difference between the potential V₁₃″ and the common potential V_{COM} is greater than the potential difference between the potential V₁₄″ and the common potential V_{COM}. That is, the transmittance of the liquid crystal LC in a period from the time t₁₂″ to the time t₁₃″ is greater than the transmittance of the liquid crystal LC in a period from the time t₁₃″ to the time t₁₄″. That is, the brightness of the pixel region P_{n,m} in the period from the time t₁₂″ to the time t₁₃″ is greater than the brightness of the pixel region P_{n,m} in the period from the time t₁₃″ to the time t₁₄″.

Then, the gate signal #GLₙ rises from a low level to a high level at the time t₁₄″ and, after a certain period of time has elapsed, falls to a low level. In a period of time during which the gate signal #GLₙ is at a high level, the transistor M_{n,m} is in a conducting state, and the source signal #SLₘ is supplied to the pixel electrode PE_{n,m} and the first auxiliary capacitor electrode CE1_{n,m}. Further, the auxiliary capacitor signal #CSLₙ rises from the potential V_{CS13}″ to the potential V_{CS12}″ at the time t₁₄″.

As shown in (a) of FIG. 11, in the period from the time t₁₄″ to the time t₁₅″, the potential V_{PEn,m}, which is applied to the pixel electrode PE_{n,m}, falls from the potential V₁₄″ to a potential V₁₅″ (which is negative).

Further, the auxiliary capacitor signal #CSLₙ falls from the potential V_{CS12}″ to the potential V_{CS11}″ at the time t₁₅″. Accordingly, the potential V_{PEn,m} of the pixel electrode PE_{n,m} changes from the potential V₁₅″ to a potential V₁₆″. It should be noted here that a specific value of the potential V₁₆″ is defined as:

V₁₆″=(V_{CS11}″−V_{CS12}″)×C_{CS}/Σ_{C}+V₁₅″.

Since V_{CS11}″<V_{CS12}″ as mentioned above, the potential V₁₆″ is smaller than the potential V₁₅″.

Then, the auxiliary capacitor signal #CSLₙ rises from the potential V_{CS11}″ to the potential V_{CS14}″ at the time t₁₆″. Accordingly, the potential V_{PEn,m} of the pixel electrode PE_{n,m} changes from the potential V₁₆″ to a potential V₁₇″. It should be noted here that a specific value of the potential V₁₇″ is defined as:

V₁₇″=(V_{CS14}″−V_{CS11}″)×C_{CS}/Σ_{C}+V₁₆″.

Since V_{CS11}″<V_{CS14}″ as mentioned above, the potential V₁₇″ is greater than the potential V₁₆″.

As shown in (c) of FIG. 11, the potential difference between the potential V₁₆″ and the common potential V_{COM} is greater than the potential difference between the potential V₁₇″ and the common potential V_{COM}. That is, the transmittance of the liquid crystal LC in a period from the time t₁₅″ to the time t₁₆″ is greater than the transmittance of the liquid crystal LC in a period from the time t₁₆″ to the time t₁₇″. That is, the brightness of the pixel region P_{n,m} in the period from the time t₁₅″ to the time t₁₆″ is greater than the brightness of the pixel region P_{n,m} in the period from the time t₁₆″ to the time t₁₇″.

Then, the gate signal #GLₙ rises from a low level to a high level at the time t₁₇″ and, after a certain period of time has elapsed, falls to a low level. Further, the auxiliary capacitor signal #CSLₙ falls from the potential V_{CS14}″ to the potential V_{CS11}″. The operation at the time t₁₇″ and later is the same as the operation at the time t₁₁″ and later.

The above example of operation has described a case where the auxiliary capacitor signal #CSLₙ rises from the potential V_{CS11}″ to the potential V_{CS12}″ at the time t₁₂″ and the auxiliary capacitor signal #CSLₙ falls from the potential V_{CS12}″ to the potential V_{CS11}″ at the time t₁₅″. However, more generally, the auxiliary capacitor signal #CSLₙ rises from the potential V_{CS11}″ to the potential V_{CS12}″ before several horizontal periods (period multiple times as long as a horizontal period Th) have elapsed since the time t₁₂″ and the auxiliary capacitor signal #CSLₙ falls from the potential V_{CS12}″ to the potential V_{CS11}″ before several horizontal periods (period multiple times as long as a horizontal period Th) have elapsed since the time t₁₅″.

Further, the above example of operation has described a case where the auxiliary capacitor signal #CSLₙ rises from the potential V_{CS13}″ to the potential V_{CS12}″ at the time t₁₄″. However, more generally, the auxiliary capacitor signal #CSLₙ rises from the potential V_{CS13}″ to the potential V_{CS12}″ in a period from the time t₁₃″ to the time t₁₅″.

As in this example of operation, the display panel 1 according to the present invention can also cause a change in brightness of the pixel region P_{n,m} in a single vertical scanning period by supplying the auxiliary capacitor signal #CSLₙ in such a way that the brightness of the pixel region P_{n,m} in the second half of a single vertical scanning period is smaller than the brightness of the pixel region P_{n,m} in the first half of the single vertical scanning period.

Therefore, in this example of operation, too, the phenomenon of blurring of moving images can be suppressed. Further, in this example of operation, the auxiliary capacitor signal #CSLₙ takes on a four-valued voltage level. Therefore, as compared with the examples 4 and 5 of operation, a display at a higher brightness can be carried out, and the phenomenon of blurring of moving images can be more effectively suppressed.

The above examples 1 to 6 of operation have been described by taking, as an example, the gate signal #GLn that is supplied to the nth gate bus line GLₙ and the auxiliary capacitor signal #CSLₙ that is supplied to the nth auxiliary capacitor bus line CSLₙ. However, the same applies to a gate signal #GLₚ that is supplied to a gate bus line GLₚ (p≠n) other than the nth gate bus line and a auxiliary capacitor signal #CSLₚ that is supplied to an auxiliary capacitor bus line CSLₚ (p≠n) other than the nth auxiliary capacitor bus line.

Further, the auxiliary capacitor driver 14 in the display panel 1 according to the present invention supplies the nth auxiliary capacitor bus line CSLₙ with the auxiliary capacitor signal #CSLₙ in synchronization with the gate signal #GLₙ.

Furthermore, in a case where such a polarity reversal signal as that mentioned above is applied to the pixel electrode PE_{n,m}, i.e., in a case where the potential V_{PEn,m} of the pixel electrode PE_{n,m} reverses its polarity with respect to the voltage V_{COM} of the counter electrode every single horizontal scanning period, the auxiliary capacitor driver 14 supplies an auxiliary capacitor signal #CSLₙ₊₁ in such a way that the auxiliary capacitor signal #CSLₙ₊₁ has its polarity reversed with respect to the polarity of the auxiliary capacitor signal #CSLₙ.

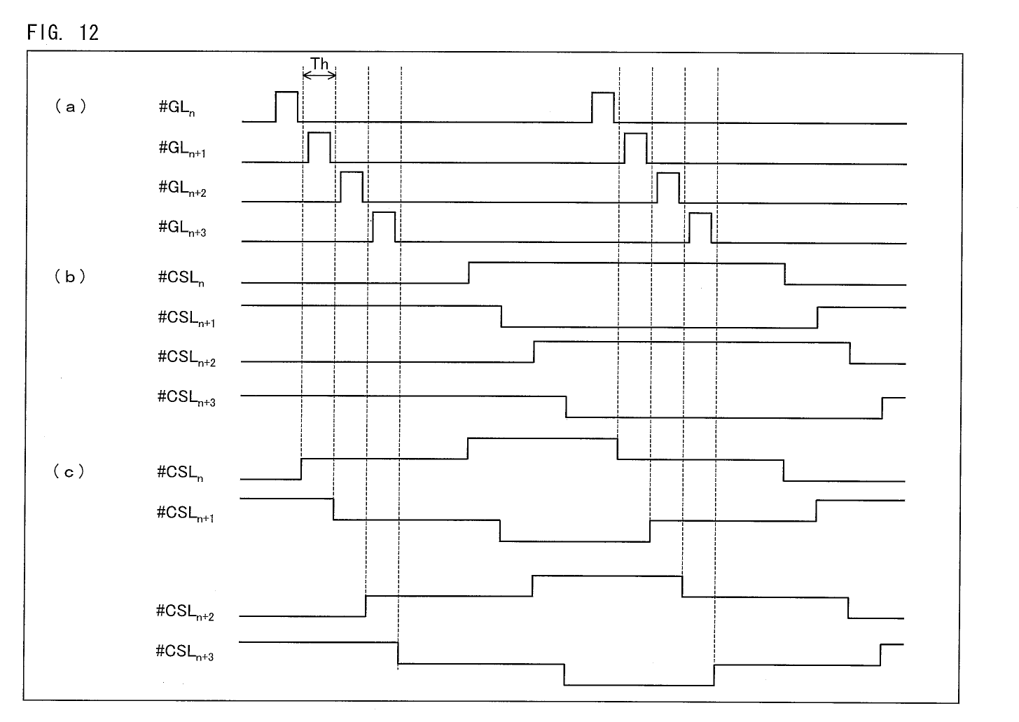

(a) of FIG. 12 is a timing chart showing examples of waveforms of gate signals #GLₙ to #GLₙ₊₃ that are supplied to the gate bus lines GLₙ to GLₙ₊₃, respectively. (b) of FIG. 12 is a timing chart showing examples of waveforms of auxiliary capacitor signals #CSLₙ to #CSLₙ₊₃ that are supplied to the auxiliary capacitor bus lines CSLₙ to CSLₙ₊₃, respectively, in the example 1 of operation described above. (c) of FIG. 12 is a timing chart showing examples of waveforms of auxiliary capacitor signals #CSLₙ to #CSLₙ₊₃ that are supplied to the auxiliary capacitor bus lines CSLₙ to CSLₙ₊₃, respectively, in the example 2 of operation described above.

In a case where as in the example 1 of operation, the potential level of an auxiliary capacitor signal during a selection period switches between the highest and lowest potential levels among a plurality of potential levels every single horizontal line period, i.e., in the case of line reversal driving, as shown in (b) and (c) of FIG. 12, the auxiliary capacitor driver 14 supplies the auxiliary capacitor signal #CSLₙ₊₁ in such a way that the auxiliary capacitor signal #CSLₙ₊₁ has its polarity reversed with respect to the polarity of the auxiliary capacitor signal #CSLₙ.

Further, as shown in (b) and (c) of FIG. 12, the auxiliary capacitor driver 14 supplies the auxiliary capacitor bus line CSLₙ with the auxiliary capacitor signals #CSLₙ to #CSLₙ₊₃ in synchronization with the gate signals #GLₙ to #GLₙ₊₃, respectively.

Further, the same applies to the other gate signal #GL_{q} (q≦n−1, q≦n+4) and the other auxiliary capacitor signal #CSL_{q} (q≦n−1, q≦n+4).

In a case where the potential level of an auxiliary capacitor signal during a selection period switches between the highest and lowest potential levels among a plurality of potential levels every plural horizontal line periods, it is preferable the auxiliary capacitor driver 14 be configured to supply an auxiliary capacitor signal having its polarity reversed every plural auxiliary capacitor bus lines.

(Example 7 of Operation of the Display Panel 1)

The examples 1 to 6 of operation described above have been described by taking, as an example, a case where the auxiliary capacitor driver 14 supplies the plurality of auxiliary capacitor bus line CSL₁ to CSL_{N} with the auxiliary capacitor signals #CSL₁ to #CSL_{N}, respectively, in sequence every horizontal scanning period Th, i.e., a case where there is a phase difference corresponding to the length of a horizontal scanning period Th between the auxiliary capacitor signal #CSLₙ and the auxiliary capacitor signal #CSLₙ₊₁. However, the present invention is not to be limited to such an example.

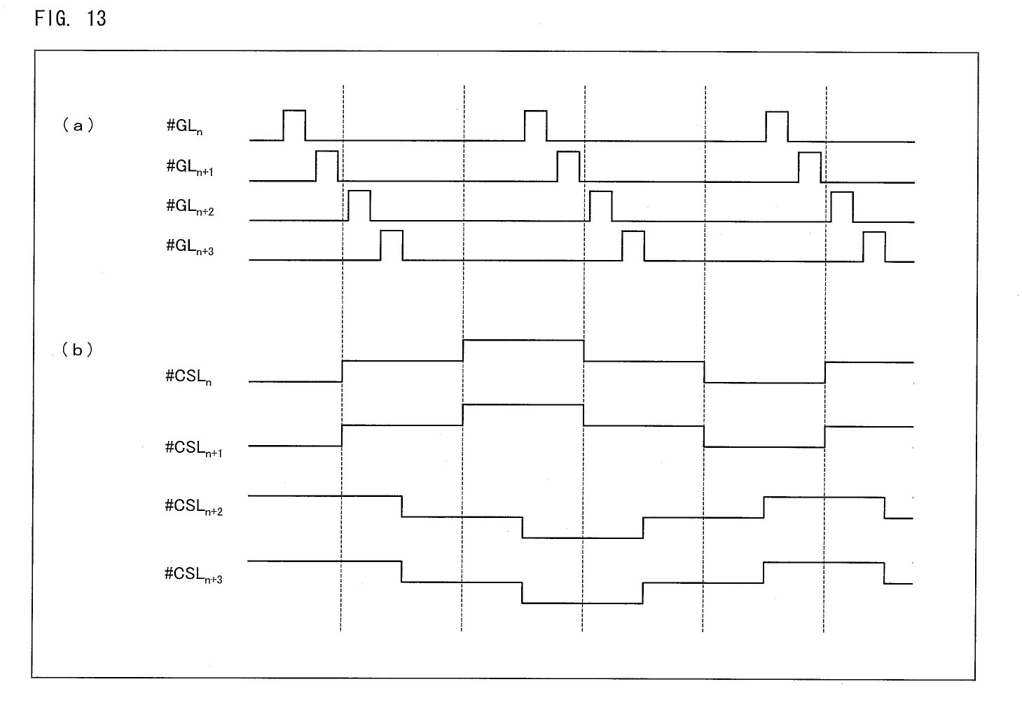

A seventh example of operation of the display panel 1 according to the present embodiment is described below with reference to (a) and (b) of FIG. 13. Further, this example of operation is described by taking, as an example, a case where the potential level of an auxiliary capacitor signal during a selection period switches between the highest and lowest potential levels among a plurality of potential levels every two horizontal line periods.

(a) of FIG. 13 is a timing chart showing examples of waveforms of gate signals #GLₙ to #GLₙ₊₃ that are supplied to the gate bus lines GLₙ to GLₙ₊₃, respectively. (b) of FIG. 13 is a timing chart showing examples of waveforms of auxiliary capacitor signals #CSLₙ to #CSLₙ₊₃ that are supplied to the auxiliary capacitor bus lines CSLₙ to CSLₙ₊₃, respectively, in this example of operation.

As shown in (b) FIG. 13, the auxiliary capacitor driver supplies the auxiliary capacitor bus lines CSLₙ and CSLₙ₊₁ with the auxiliary capacitor signals #CSLₙ and #CSLₙ₊₁, which are in phase with each other. In other words, the auxiliary capacitor driver 14 supplies a pair of two adjacent auxiliary capacitor bus lines with a common auxiliary capacitor signal.

Thus, in this example of operation, the auxiliary capacitor driver 14 synchronously supplies the rectangular voltage signal (auxiliary capacitor signals #CSLₙ and #CSLₙ₊₁) to the auxiliary capacitor bus line CSLₙ connected via the transistor M_{n,m} and the capacitor C_{n,m} to the nth gate bus line GLₙ of the plurality of gate bus lines GL₁ to GL_{N}, and to the auxiliary capacitor bus line CSLₙ₊₁ connected via the transistor M_{n+1,m} and the capacitor C_{n+1,m} to the (n+1)th gate bus line GLₙ₊₁ of the plurality of gate bus lines GL₁ to GL_{N}.

As a configuration to supply a pair of auxiliary capacitor bus lines with a common auxiliary capacitor signal, for example, it is only necessary to generate the auxiliary capacitor signals #CSLₙ and #CSLₙ₊₁ by using identical signal generating means in the auxiliary capacitor driver 14, and to supply the auxiliary capacitor signals #CSLₙ and #CSLₙ₊₁ to the auxiliary capacitor bus lines CSLₙ and CSLₙ₊₁, respectively.

Therefore, in this example of operation, the phenomenon of blurring of moving images can be suppressed by the auxiliary capacitor driver 14 of a simpler configuration.

Further, the display panel according to the present invention may be configured such that the auxiliary capacitor driver 14 synchronously supplies the rectangular voltage signal (auxiliary capacitor signals #CSLₙ and #CSLₙ₊₂) to the auxiliary capacitor bus line CSLₙ connected via the transistor M_{n,m} and the capacitor C_{n,m} to the nth gate bus line GLₙ of the plurality of gate bus lines GL₁ to GL_{N}, and to the auxiliary capacitor bus line CSLₙ₊₂ connected via the transistor M_{n+2,m} and the capacitor C_{n+2,m} to the (n+2)th gate bus line GLₙ₊₂ of the plurality of gate bus lines GL₁ to GL_{N}.

According to the foregoing configuration, the auxiliary capacitor driver 14 of a simpler configuration brings about a further effect of making it possible to suppress the phenomenon of blurring of moving images while suppressing the occurrence of flickers and streaks corresponding to polarity reversal.

Further, the auxiliary capacitor driver 14 may be configured to supply a set of three or more adjacent auxiliary capacitor bus lines with a common auxiliary capacitor signal.

As described above in the examples 1 to 7 of operation, in a single vertical scanning period, the display panel 1 according to the present invention supplies the auxiliary capacitor bus lines CSL₁ to CSL_{N} with the rectangular auxiliary capacitor signals #CSL₁ to #CSL_{N} each composed of a plurality of voltage levels, thereby making it possible to set up, in the single vertical scanning period, a period during which the brightness of the pixel region P_{n,m} is relatively high (such a period being hereinafter referred to as “bright period”) and a period during which the brightness of the pixel region P_{n,m} is relatively low (such a period being hereinafter referred to as “dark period”).

Further, the existence of such bright and dark periods in a single vertical scanning period can suppress blurring of images that are displayed on the display panel 1.

Further, the length of such a bright period and the length of such a dark period in a single vertical scanning period can be adjusted by changing the duty ratio of an auxiliary capacitor signal #CSLₙ that is supplied by the auxiliary capacitor driver 14.

It should be noted here that in a single vertical scanning period immediately after the potential level of an auxiliary capacitor signal #CSLₙ during a selection period takes on the lowest potential level among a plurality of potential levels, the duty ratio of the auxiliary capacitor signal #CSLₙ means the proportion of a period during which the voltage level of the auxiliary capacitor signal #CSLₙ takes on the highest voltage level among the plurality of voltage levels in the single vertical scanning period, and that in a single vertical scanning period immediately after the potential level of an auxiliary capacitor signal #CSLₙ during a selection period takes on the highest potential level among a plurality of potential levels, the duty ratio of the auxiliary capacitor signal #CSLₙ means the proportion of a period during which the voltage level of the auxiliary capacitor signal #CSLₙ takes on the lowest voltage level among the plurality of voltage levels in the single vertical scanning period.

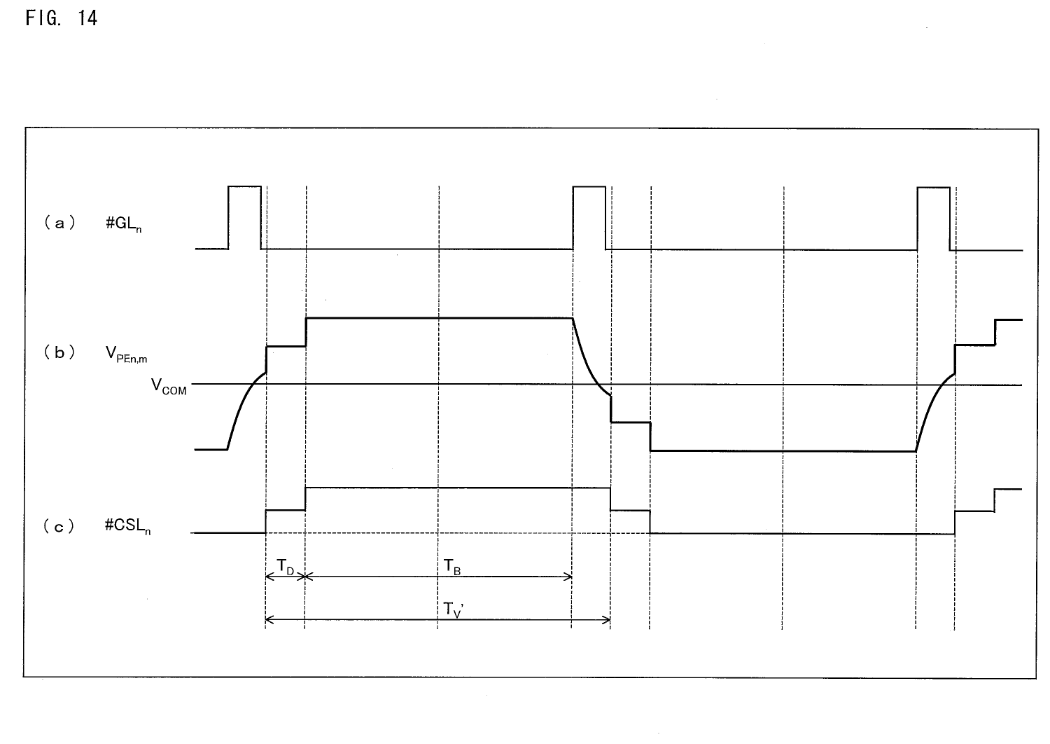

(c) of FIG. 14 shows a waveform of the auxiliary capacitor signal #CSLₙ shown in (d) of FIG. 5, the auxiliary capacitor signal #CSLₙ being set so that the duty ratio is approximately 90%.

As shown in (c) of FIG. 14, a period TD during which the voltage level of the auxiliary capacitor signal #CSLₙ is relatively low occupies approximately 10% of a single vertical scanning period T_{V}′, and a period T_{B} during which the voltage level of the auxiliary capacitor signal #CSLₙ is relatively high occupies approximately 90% of the single vertical scanning period T_{V}′. Further, the single vertical scanning period T_{V}′ shown in (c) of FIG. 14 is a vertical scanning period immediately after a potential of a positive polarity has been applied to the pixel electrode PE_{n,m}. Therefore, the duty ratio of the auxiliary capacitor signal #CSLₙ is approximately 90%.

As shown in (b) of FIG. 14, the potential difference between the potential V_{PEn,m} of the pixel electrode PE_{n,m} and the supply potential V_{COM} during the period TD is smaller than the potential difference between the potential V_{PEn,m} of the pixel electrode PE_{n,m} and the supply potential V_{COM} during the period T_{B}. Therefore, the period TD corresponds to a dark period, and the period T_{B} corresponds to a bright period. In other words, the supply of the auxiliary capacitor signal #CSLₙ set so that the duty ratio is approximately 90% causes approximately 90% of a single vertical scanning period to be a bright period and the rest 10% to be a dark period.

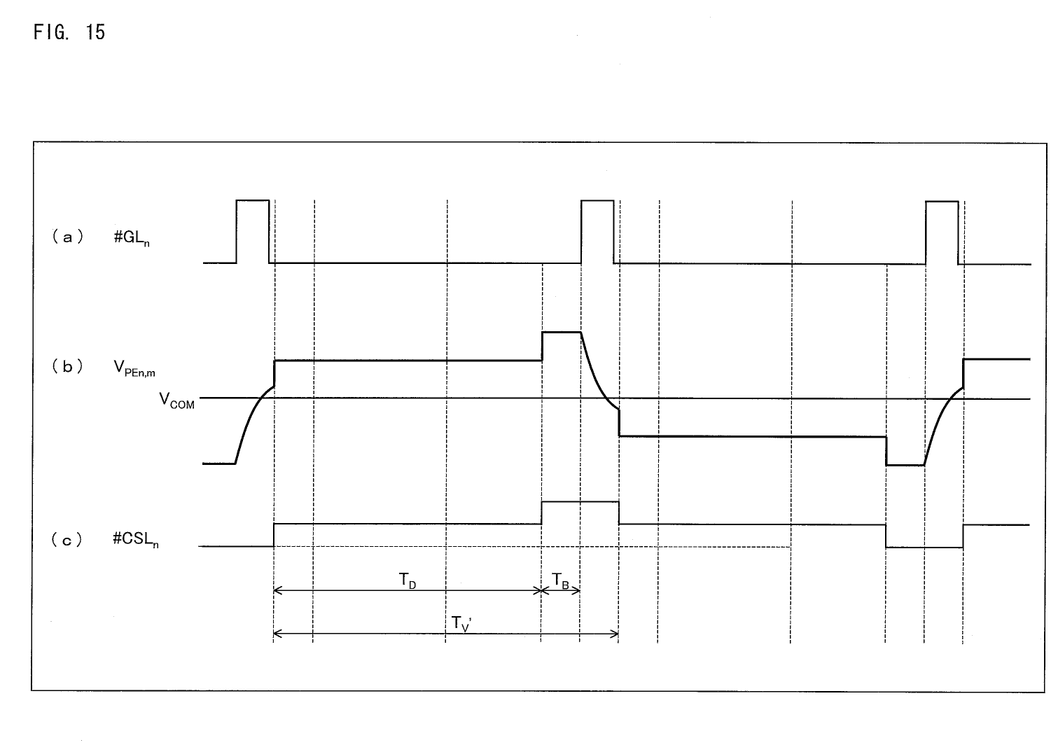

(c) of FIG. 15 shows a waveform of the auxiliary capacitor signal #CSLₙ shown in (d) of FIG. 5, the auxiliary capacitor signal #CSLₙ being set so that the duty ratio is approximately 10%.

As shown in (c) of FIG. 15, a period TD during which the voltage level of the auxiliary capacitor signal #CSLₙ is relatively low occupies approximately 90% of a single vertical scanning period T_{V}′, and a period T_{B} during which the voltage level of the auxiliary capacitor signal #CSLₙ is relatively high occupies approximately 10% of the single vertical scanning period T_{V}′. Further, the single vertical scanning period T_{V}′ shown in (c) of FIG. 15 is a vertical scanning period immediately after a potential of a positive polarity has been applied to the pixel electrode PE_{n,m}. Therefore, the duty ratio of the auxiliary capacitor signal #CSLₙ is approximately 10%.

As shown in (b) of FIG. 15, the potential difference between the potential V_{PEn,m} of the pixel electrode PE_{n,m} and the supply potential V_{COM} during the period TD is smaller than the potential difference between the potential V_{PEn,m} of the pixel electrode PE_{n,m} and the supply potential V_{COM} during the period T_{B}. Therefore, the period TD corresponds to a dark period, and the period T_{B} corresponds to a bright period. In other words, the supply of the auxiliary capacitor signal #CSLₙ set so that the duty ratio is approximately 10% causes approximately 10% of a single vertical scanning period to be a bright period and the rest 90% to be a dark period.

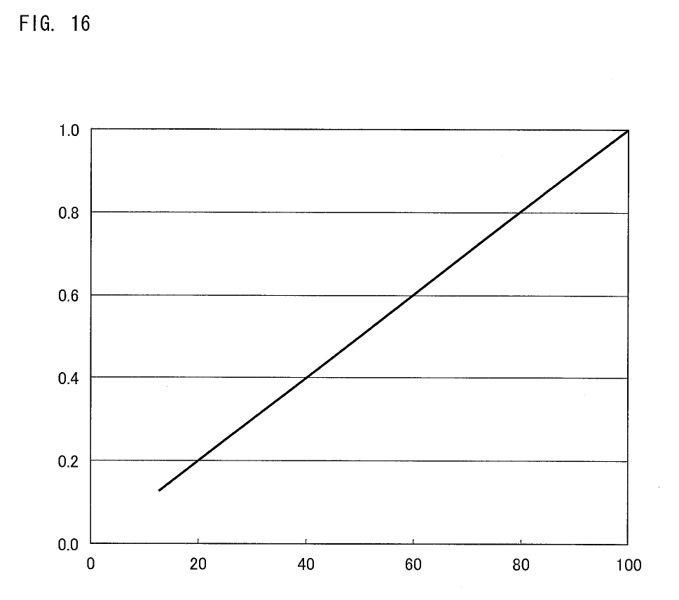

FIG. 16 is a graph showing a relationship between the duty ratio and brightness. In FIG. 16, the vertical axis represents the relative brightness with the lowest brightness at 0.0 and the highest brightness at 1.0, and the horizontal axis represents the duty ratio.

As shown in FIG. 16, the greater the duty ratio is, the higher the relative brightness is.

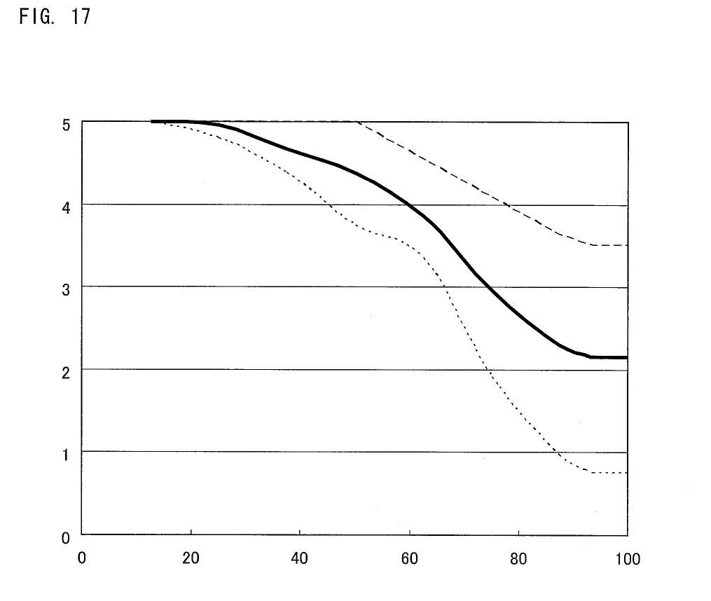

FIG. 17 is a graph of experimental data showing a relationship between the duty ratio and the visibility of moving images that are displayed on the display panel 1.

The vertical axis of FIG. 17 represents, on a scale of 1 to 5, the visibility felt by a viewer looking at a moving image being displayed on the display panel 1. The higher the visibility is, the more clearly the moving image looks to the viewer, i.e., the less blurred the moving image looks to the viewer. The horizontal axis of FIG. 17 represents the aforementioned duty ratio.

In FIG. 17, the dotted line represents the lowest evaluations among evaluations of visibility given by a plurality of viewers, respectively, the broken line representing the highest evaluations among the evaluations of visibility given by the plurality of viewers, respectively, the solid line representing the average of the evaluations of visibility given by the plurality of viewers, respectively.

As shown in FIG. 17, at a duty ratio of approximately 10% or less, all of the viewers gave the highest evaluation of visibility. Meanwhile, at a duty ratio of approximately 90% or greater, most of the viewers cannot sense a change in visibility.

The experimental data shown in FIG. 17 shows that it is preferable that the aforementioned duty ratio be set within a range of approximately 10% to approximately 90%.

Further, the display panel 1 according to the present embodiment is preferably configured such that the source driver 12 sets the size of amplitude of the source signals #SL₁ to #SL_{M} in accordance with the size of amplitude of the auxiliary capacitor signals #CSL₁ to #CSL_{N} that are supplied by the auxiliary capacitor driver 14.

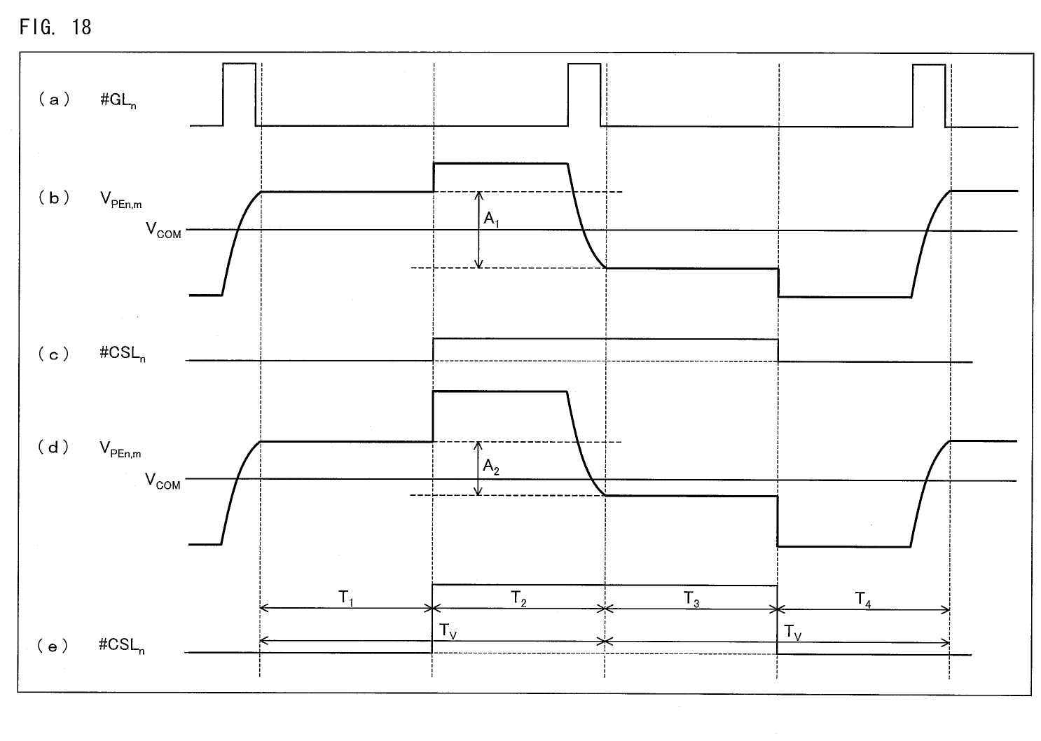

(a) of FIG. 18 is a timing chart showing a waveform of the gate signal #GLₙ. (b) of FIG. 18 is a timing chart showing the common potential V_{COM} and a waveform of the potential V_{PEn,m} as applied to the pixel electrode PE_{n,m} in a case where the amplitude of the source signal #SLₘ is larger, and (c) of FIG. 18 is a timing chart showing a waveform of the auxiliary capacitor signal #CSLₙ as supplied to the auxiliary capacitor bus line CSLₙ in a case where the amplitude of the source signal #SLₘ is larger.

Further, (d) of FIG. 18 is a timing chart showing the common potential V_{COM} and a waveform of the potential V_{PEn,m} as applied to the pixel electrode PE_{n,m} in a case where the amplitude of the source signal #SLₘ is smaller, and (e) of FIG. 18 is a timing chart showing a waveform of the auxiliary capacitor signal CSLₙ as supplied to the auxiliary capacitor bus line CSLₙ in a case where the amplitude of the source signal #SLₘ is smaller.

The amplitude A1 shown in (b) of FIG. 18 and the amplitude A2 shown in (d) of FIG. 18 represent the amplitude of the source signal #SLₘ.

As shown in (b) through (e) of FIG. 18, the auxiliary capacitor driver 14 supplies the auxiliary capacitor signal #CSLₙ of smaller amplitude in a case where the amplitude of the source signal #SLₘ is larger, and supplies the auxiliary capacitor signal #CSLₙ of larger amplitude in a case where the amplitude of the source signal #SLₘ is smaller. Thus, in a case where the auxiliary capacitor driver 14 supplies the auxiliary capacitor signal #CSLₙ of smaller amplitude, the source driver 12 supplies the source signal #SLₘ of larger amplitude, and in a case where the auxiliary capacitor driver 14 supplies the auxiliary capacitor signal #CSLₙ of larger amplitude, the source driver 12 supplies the source signal #SLₘ of smaller amplitude, whereby the average brightness of the pixel region P_{n,m} during a single vertical scanning period T_{V} can be held substantially constant regardless of whether the auxiliary capacitor signal #CSLₙ is of larger amplitude or smaller amplitude.

Further, a specific configuration, such as that described above, for supplying the auxiliary capacitor bus lines CSL₁ to CSL_{N} with the rectangular auxiliary capacitor signals #CSL₁ to #CSL_{N} each composed of a plurality of voltage levels can be realized, for example, by the auxiliary capacitor driver 14 including a plurality of power supplies for supplying the plurality of voltage levels and a selector for selecting any one of the voltage levels supplied from the plurality of power supplies.

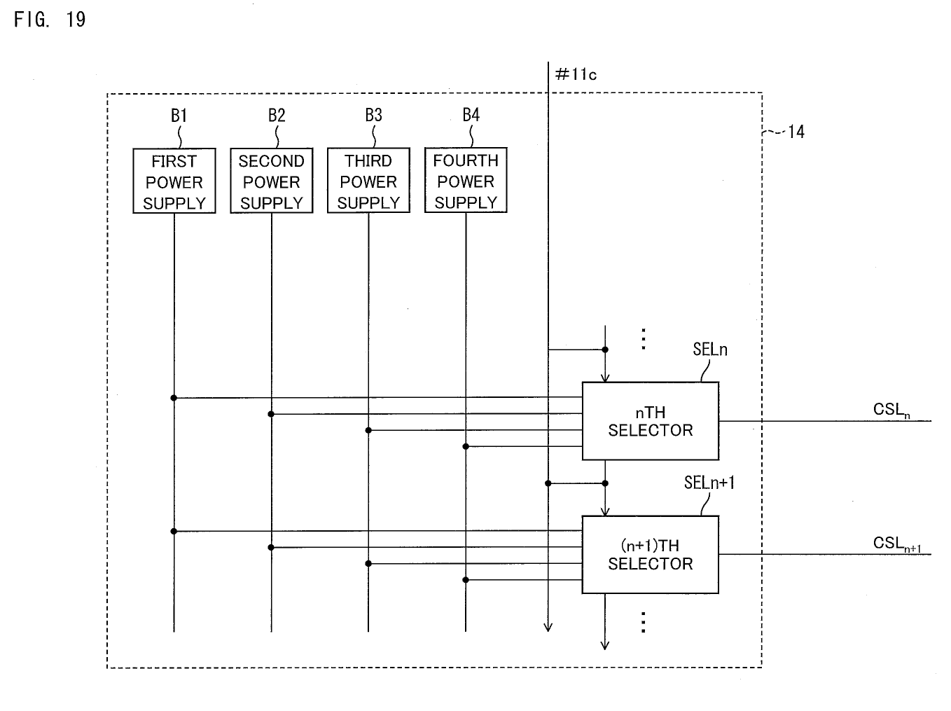

FIG. 19 is a block diagram showing a configuration of the auxiliary capacitor driver 14 for supplying the auxiliary capacitor signals #CSL₁ to #CSL_{N} each composed of a four-valued voltage level.

As shown in FIG. 19, the auxiliary capacitor driver 14 includes a first power supply B1, a second power supply B2. a third power supply B3, and a fourth power supply B4. Further, as shown in FIG. 19, the auxiliary capacitor driver 14 includes an nth selector SELₙ (1≦n≦N) connected to the auxiliary capacitor bus line CSLₙ (1≦n≦N).

Further, as shown in FIG. 19, the nth selector SELₙ is supplied with the control signal #11c that is outputted from the control section 11.

As shown in FIG. 19, a first potential that is outputted from the first power supply B1, a second potential that is outputted from the second power supply B2, a third potential that is outputted from the third power supply B3, and a fourth potential that is outputted from the fourth power supply B4 are supplied to the nth selector SELₙ (1≦n≦N). The nth selector SELₙ selects any one of the first to fourth potentials in accordance with the control signal #11c and supplies the selected potential to the auxiliary capacitor bus line CSLₙ.

Although the present invention is not to be limited by a specific configuration of the first to fourth power supplies, DACs (digital-analog converters) to which digital values respectively corresponding to the first to fourth potentials are inputted may be used, for example, or another configuration may be used.

As described above, the display panel 1 according to the present invention is preferably configured such that the auxiliary capacitor driver 14 includes amplitude changing means for changing size of amplitude of the rectangular voltage signal (auxiliary capacitor signal #CSLₙ).

By the auxiliary capacitor driver 14 thus including amplitude changing means for changing size of amplitude of the rectangular voltage signal, the phenomenon of blurring of moving images can be more effectively suppressed.

Further, the display panel 1 according to the present invention is configured such that the source driver 12 supplies the source signal #SLₘ of larger amplitude in a case where the amplitude of the rectangular voltage signal (auxiliary capacitor signal #CSLₙ) is smaller, and supplies the source signal #SLₘ of smaller amplitude in a case where the amplitude of the rectangular voltage signal (auxiliary capacitor signal #CSLₙ) is larger.

The foregoing configuration allows the source driver to supply the source signal of larger amplitude in a case where the amplitude of the rectangular voltage signal is smaller, and to supply the source signal of smaller amplitude in a case where the amplitude of the rectangular voltage signal is larger, thus bringing about a further effect of making it possible to effectively suppress the phenomenon of blurring of moving images, regardless of whether the rectangular voltage signal is of larger amplitude or smaller amplitude.

It should be noted the amplitude of the source signal is defined as being obtained by subtracting the potential of the source signal at the time of negative polarity writing from the potential of the source signal at the time of positive polarity writing (same applies below). Further, the time of positive polarity writing refers to the time of supply of the conducting signal during which the rectangular voltage signal is at the lowest voltage level, and the time of negative polarity writing refers to the time of supply of the conducting signal during which the rectangular voltage signal is at the highest voltage level (same applies below).

### Embodiment 2

In Embodiment 1, the display device 1 has been described as being configured to include N gate bus lines GL₁ to GL_{N} and N auxiliary capacitor bus lines CSL₁ to CSL_{N}. However, the present invention is not to be limited to this configuration.

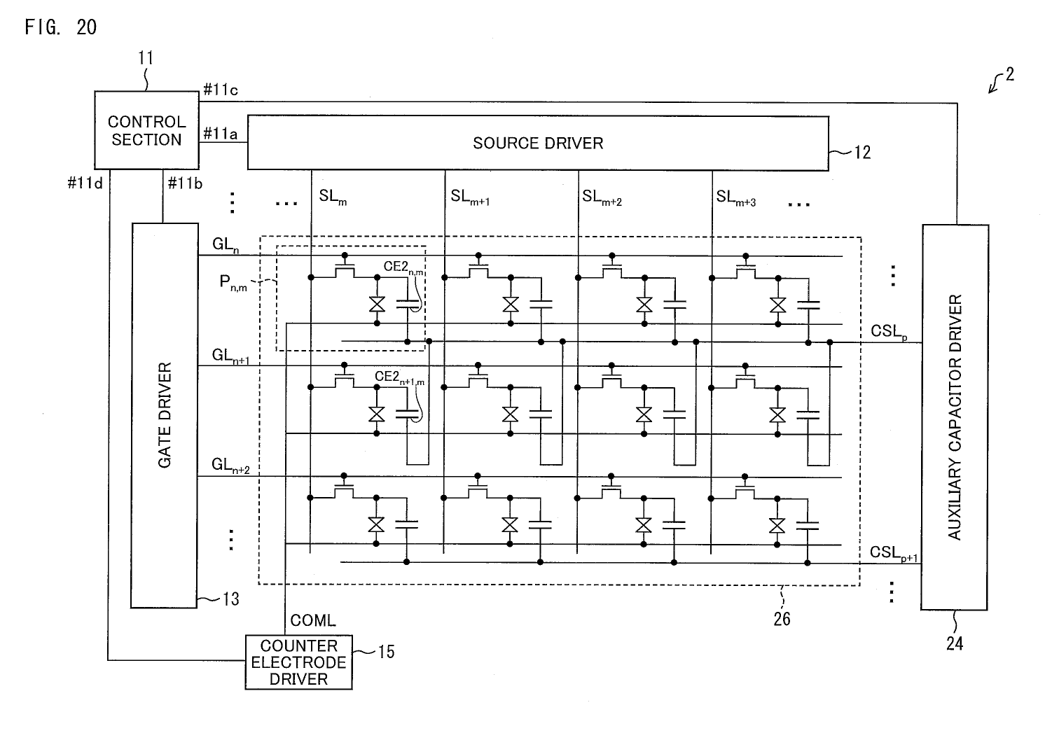

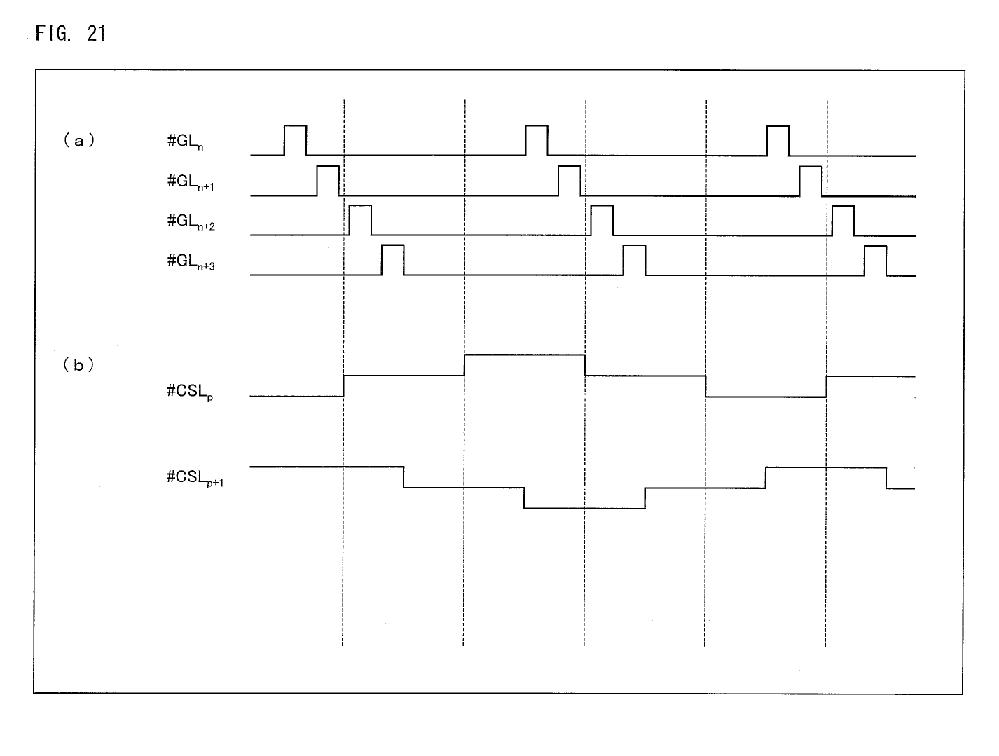

A display panel 2 according to a second embodiment of the present invention is described below with reference to FIGS. 20 and 21. It should be noted those parts which have already been described are given the same reference signs, and as such, will not be described below.

FIG. 20 is a block diagram showing a configuration of the display panel 2 according to the present embodiment. As shown in FIG. 20, the display panel 2 includes an auxiliary capacitor driver 24, instead of the auxiliary capacitor driver 14 in the display panel 1, and a display section 26, instead of the display section 16 in the display panel 1.

As shown in FIG. 20, in addition to the N gate bus lines GL₁ to GL_{N} (it is assumed in the present embodiment that N is an even number) and the M source bus lines SL₁ to SL_{M}, the display section 26 includes N/2 auxiliary capacitor bus lines CSL₁ to CSL_{N/2}.

Further, as shown in FIG. 20, a second auxiliary capacitor electrode CE2_{n,m} formed in the pixel region P_{n,m} defined by a gate bus line GLₙ (n is an odd number) and a second auxiliary capacitor electrode CE2_{n+1,m} formed in the pixel region P_{n+1,m} defined by a gate bus line GLₙ₊₁ are both connected to an auxiliary capacitor bus line CSLₚ (p=(n+1)/2).

The auxiliary capacitor driver 24 supplies the N/2 auxiliary capacitor bus lines CSL₁ to CSL_{N/2} with auxiliary capacitor signals #CSL₁ to #CSL_{N/2}, respectively.

Further, in the present embodiment, the source driver 12 is described as one which supplies the source bus line SLₘ with a source signal that reverses its polarity every two consecutive horizontal scanning periods.

The other components of the display panel 2 are the same as those of the display panel 1.

(a) of FIG. 21 is a timing chart showing examples of waveforms of gate signals #GLₙ to #GLₙ₊₃ that are supplied to the gate bus lines GLₙ to GLₙ₊₃, respectively, by the gate driver 13 in the display panel 2, and (b) of FIG. 21 is a timing chart showing examples of waveforms of auxiliary capacitor signals #CSLₚ (p=(n+1)/2) and #CSLₚ₊₁ that are supplied to the auxiliary capacitor bus lines CSLₚ and CSLₚ₊₁, respectively, by the auxiliary capacitor driver 24 in the display panel 2.

As shown in (a) and (b) of FIG. 21, the auxiliary capacitor driver 24 supplies the auxiliary capacitor bus line CSLₚ (p=(n+1)/2) with the auxiliary capacitor signal #CSLₚ (p=(n+1)/2) in synchronization with the gate signals #GLₙ and #GLₙ₊₁, and supplies the auxiliary capacitor bus line CSLₚ₊₁ (p=(n+1)/2) with the auxiliary capacitor signal #CSLₚ₊₁ (p=(n+1)/2) in synchronization with the gate signals #GLₙ₊₂ and #GLₙ₊₃.

Thus, the display panel 2 according to the present embodiment is configured such that: the number of the plurality of gate bus lines GL₁ to GL_{N} is an even number; the number of the plurality of auxiliary capacitor bus lines is a half (i.e., N/2) of the number of the plurality of gate bus lines; and the other end (second auxiliary capacitor electrode CE2_{2k-1,m}) of the capacitor C_{2k-1,m} connected via the transistor M_{2k-1,m} to the (2k−1)th (k is a natural number) gate bus line GL₂ₖ₋₁ of the plurality of gate bus lines and the other end (second auxiliary capacitor electrode CE2₂ₖ) of the capacitor C_{2k,m} connected via the transistor M_{2k,m} to the 2kth gate bus line GL_{2k,m} of the plurality of gate bus lines are connected to the kth auxiliary capacitor bus line CSLₖ of the plurality of auxiliary capacitor bus lines.

The display panel 2 according to the present embodiment can reduce the number of auxiliary capacitor bus lines to half as compared with the display panel 1 in Embodiment 1. Therefore, the configuration of the display section 26 in the display panel 2 can be made simpler than the configuration of the display section 16 in the display panel 1. Further, since the auxiliary capacitor driver 24 in the display panel 2 needs only supply the N/2 auxiliary capacitor bus lines CSL₁ to CSL_{N/2} with the auxiliary capacitor signals #CSL₁ to #CSL_{N/2}, respectively, the auxiliary capacitor driver 24 can be made simpler in configuration than the auxiliary capacitor driver 14, in the display panel 1, which supplies the N auxiliary capacitor bus lines CSL₁ to CSL_{N} with the auxiliary capacitor signals #CSL₁ to #CSL_{N}, respectively. That is, the display panel 2 according to the present embodiment can suppress the phenomenon of blurring of moving images with a simpler configuration than the display panel 1 in Embodiment 1.

### Embodiment 3

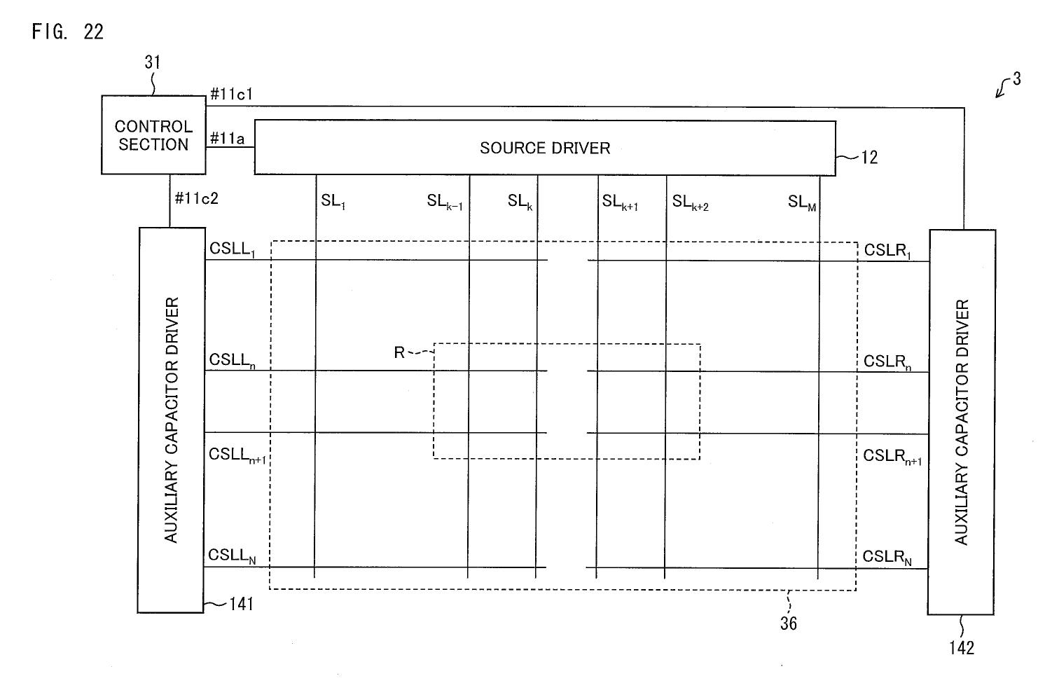

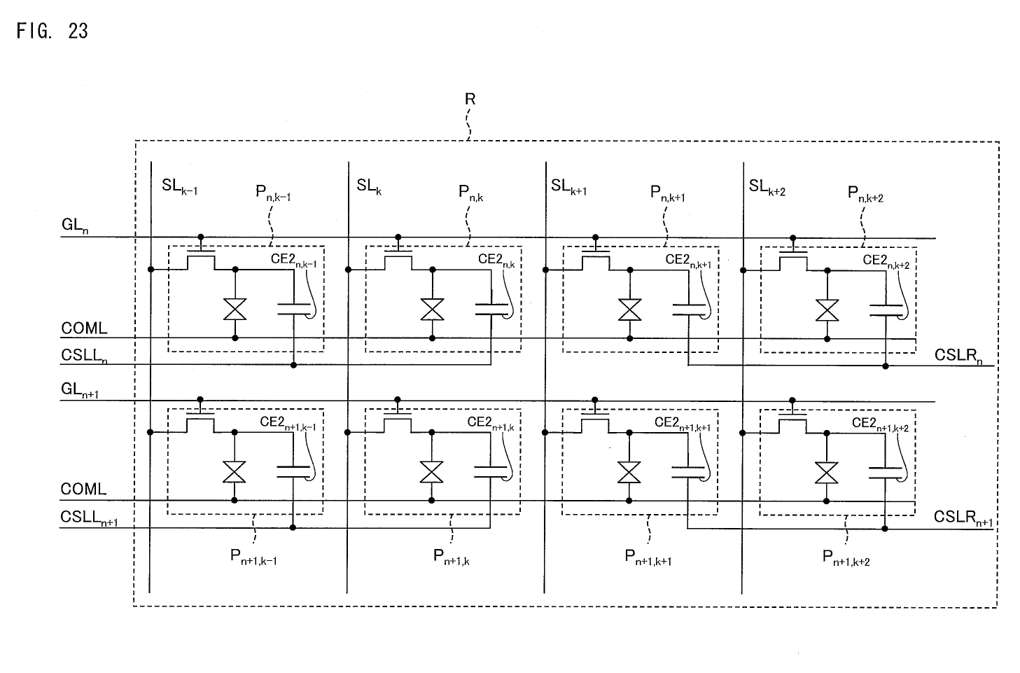

A display panel 3 according to a third embodiment of the present invention is described below with reference to FIGS. 22 and 23.

FIG. 22 is a block diagram showing a configuration of the display panel 3 according to the present embodiment. As shown in FIG. 22, the display panel 3 includes a control section 31, a source driver 12, an auxiliary capacitor driver 141, an auxiliary capacitor driver 142, and a display section 36. Further, the display panel 3 includes a gate driver (not illustrated) and a counter electrode driver (not illustrated). It should be noted here that the gate driver (not illustrated) and the counter electrode driver (not illustrated) are identical in configuration to the gate driver 13 and the counter electrode driver 15 in the display panel 1, respectively.

As shown in FIG. 22, the display section 36 has the auxiliary capacitor drivers 141 and 142 disposed on both sides thereof, respectively. Further, the auxiliary capacitor driver 141 is supplied with a control signal #11c2 from the control section 31, and the auxiliary capacitor driver 142 is supplied with a control signal #11c1 from the control section 31.

The display section 36 is provided with M source bus lines SL₁ to SL_{M} and N gate bus lines (not illustrated). It should be noted that the N gate bus lines (not illustrated) are identical in configuration to the N gate bus lines GL₁ to GL_{N} in the display pane 1. Further, the display section 36 is provided with a counter electrode wire (not illustrated) identical to the counter electrode wire COML in the display panel 1.

Further, as shown in FIG. 22, the display section 36 has N auxiliary capacitor bus lines CSLL₁ to CSLL_{N} formed on a left half surface thereof substantially perpendicularly to the source bus lines SL₁ to SL_{M}, and has N auxiliary capacitor bus lines CSLR₁ to CSLR_{N} formed on a right half surface thereof substantially perpendicularly to the source bus lines SL₁ to SL_{M}. Further, the N auxiliary capacitor bus lines CSLL₁ to CSLL_{N} and the N auxiliary capacitor bus lines CSLR₁ to CSLR_{N} are insulated from each other. Further, as shown in FIG. 22, the auxiliary capacitor bus line CSLLₙ and the auxiliary capacitor bus line CSLRₙ are disposed collinearly. Therefore, in other words, in the present embodiment, the auxiliary capacitor bus line CSLₙ in the display panel 1 is constituted by the two auxiliary capacitor bus lines CSLLₙ and CSLRₙ formed collinearly via an insulating section.

Further, each of the N auxiliary capacitor bus lines CSLL₁ to CSLL_{N} has an end connected to the auxiliary capacitor driver 141, and each of the N auxiliary capacitor bus lines CSLR₁ to CSLR_{N} has an end connected to the auxiliary capacitor driver 142.

It should be noted that the auxiliary capacitor bus lines CSLL₁ to CSLL_{N} and the auxiliary capacitor bus lines CSLR₁ to CSLR_{N} are insulated from each other.

The auxiliary capacitor driver 141 supplies the auxiliary capacitor bus lines CSLL₁ to CSLL_{N} with auxiliary capacitor signals #CSLL₁ to #CSLL_{N}, respectively, and the auxiliary capacitor driver 142 supplies the auxiliary capacitor bus lines CSLR₁ to CSLR_{N} with auxiliary capacitor signals #CSLR₁ to #CSLR_{N}, respectively.

FIG. 23 is a circuit diagram showing a configuration of the display section 36 in a region R shown in FIG. 22. As shown in FIG. 23, second auxiliary capacitor electrodes CE2_{n,1} to CE2_{n,k} formed in the pixel regions P_{n,1} to P_{n,k} defined by source bus lines SL₁ to SLₖ are connected to the auxiliary capacitor bus line CSLLₙ, and second auxiliary capacitor electrodes CE2_{n,k+1} to CE2_{n,M} formed in the pixel regions P_{n,k+1} to P_{n,M} defined by source bus lines SLₖ₊₁ to SL_{M} are connected to the auxiliary capacitor bus line CSLRₙ. The same applies to the pixel regions P_{s,1} to P_{s,k} (s≠n, 1≦s≦N) and the pixel regions P_{s,k+1} to P_{s,M} (s≠n, 1≦s≦N).

It should be noted here that it is preferable that the k take on a value of approximately M/2, where M is the number of source bus lines. Further, it is preferable that the value of k fall within a range of approximately 0.45×M to 0.55×M.

The auxiliary capacitor drivers 141 and 142 may be configured to carry out the same operation as the auxiliary capacitor driver 14 described in Embodiment 1, or may be configured to supply different auxiliary capacitor signals from each other. For example, the auxiliary capacitor driver 141 may supply auxiliary capacitor signals #CSLL₁ to #CSLL_{N} such as those of the example 2 of operation of Embodiment 1, and the auxiliary capacitor driver 142 may supply auxiliary capacitor signals CSLR₁ to #CSLR_{N} such as those of the example 5 of operation of Embodiment 1. Further, the auxiliary capacitor drivers 141 and 142 may be configured to output auxiliary capacitor signals #CSLL₁ to #CSLL_{N} and auxiliary capacitor signals #CSLR₁ to #CSLR_{N}, respectively, that are different in duty ratio from each other.

Further, it is preferable that in a case where the source driver 12 supplies the source bus lines SL₁ to SLₖ with source signals #SL₁ to #SLₖ of larger amplitude such as those shown in (b) of FIG. 18 and supplies the source bus lines SLₖ₊₁ to SL_{M} with source signals #SLₖ₊₁ to #SL_{M} of smaller amplitude such as those shown in (d) of FIG. 18, the auxiliary capacitor driver 141 supply the auxiliary capacitor bus lines CSLL₁ to CSLL_{N} with auxiliary capacitor signals #CSLL₁ to #CSLL_{N} of smaller amplitude such as those shown in (c) of FIG. 18 and the auxiliary capacitor driver 142 supply the auxiliary capacitor bus lines CSLR₁ to CSLR_{N} with auxiliary capacitor signals #CSLR₁ to #CSLR_{N} of larger amplitude such as those shown in (e) of FIG. 18.

Further, the display panel 3 according to the present embodiment is configured such that: the auxiliary capacitor driver comprises two auxiliary capacitor drivers (auxiliary capacitor drivers 141 and 142); the given auxiliary capacitor bus line (auxiliary capacitor bus line CSLₙ) is constituted by two auxiliary capacitor bus lines (auxiliary capacitor bus lines CSLLₙ and CSLRₙ) formed collinearly via an insulating section; in the single scanning period (single vertical scanning period), either one (auxiliary capacitor driver 141) of the two auxiliary capacitor drivers supplies either one (auxiliary capacitor bus line CSLLₙ) of the two auxiliary capacitor bus lines with the rectangular voltage signal (auxiliary capacitor signal #CSLLₙ) in synchronization with the conducting signal (high-level interval of the gate signal GLₙ), the rectangular voltage signal (auxiliary capacitor signal #CSLLₙ) being composed of the first voltage level and the second voltage level that is different from the first voltage level; and in the single scanning period, the other one (auxiliary capacitor driver 142) of the two auxiliary capacitor drivers supplies the other one (auxiliary capacitor bus line CSLRₙ) of the two auxiliary capacitor bus lines with the rectangular voltage signal (auxiliary capacitor signal #CSLRₙ) in synchronization with the conducting signal, the rectangular voltage signal (auxiliary capacitor signal #CSLRₙ) being composed of the first voltage level and the second voltage level that is different from the first voltage level.

The display panel 3 according to the present embodiment can supply a pixel electrode connected to the one auxiliary capacitor bus line (auxiliary capacitor bus line CSLLₙ) and a pixel electrode connected to the other auxiliary capacitor bus line (auxiliary capacitor bus line CSLRₙ) with the rectangular voltage signals (auxiliary capacitor signals #CSLLₙ and #CSLRₙ) independently from each other.

Therefore, the foregoing configuration allows a pixel region including the pixel electrode connected to the one auxiliary capacitor bus line and a pixel region including the pixel electrode connected to the other auxiliary capacitor bus line to display images that are different in improvement effect on the phenomenon of blurring of moving images. Therefore, the improvement effect of the present invention on the blurring of moving images can be made to more effectively claim users' attention. That is, the improvement effect of the present invention on the blurring of moving images can be made more effectively appealing to users.

Further, as mentioned above, the source driver 12 may supply source signals of different amplitudes to the source bus line SLₘ connected via the capacitor C_{n,m} (m≦k) and the transistor M_{n,m} to the one auxiliary capacitor bus line (auxiliary capacitor bus line CSLLₙ) and to the source bus line SLᵣ connected via the capacitor C_{n,r} (r≧k+1) and the transistor M_{n,r} to the other auxiliary capacitor bus line (auxiliary capacitor bus line CSLRₙ).

Therefore, in this example of operation, the pixel electrode PE_{n,m} (m≦k) connected to the one auxiliary capacitor bus line (auxiliary capacitor bus line CSLLₙ) and the pixel electrode PE_{n,m} (m k+1) connected to the other auxiliary capacitor bus line (auxiliary capacitor bus line CSLRₙ) are supplied with the rectangular voltage signals (auxiliary capacitor signals #CSLLₙ and #CSLRₙ) independently from each other, whereby while uniforming the visibility of images except for the phenomenon of blurring of moving images, the pixel region including the pixel electrode connected to the one auxiliary capacitor bus line and the pixel region including the pixel electrode connected to the other auxiliary capacitor bus line can display images that are different in improvement effect on the phenomenon of blurring of moving images. Therefore, the improvement effect of the present invention on the blurring of moving images can be made to more effectively claim users' attention. That is, the improvement effect of the present invention on the blurring of moving images can be made more effectively appealing to users.

Further, the one auxiliary capacitor bus line (auxiliary capacitor bus line CSLLₙ) has a length that is substantially 45% to substantially 55% of that of the given auxiliary capacitor bus line (auxiliary capacitor bus line CSLₙ in the display panel 1), and the other auxiliary capacitor bus line (auxiliary capacitor bus line CSLRₙ) has a length that is substantially equal to a length obtained by subtracting the length of the one auxiliary capacitor bus line (auxiliary capacitor bus line CSLLₙ) from the length of the given auxiliary capacitor bus line (auxiliary capacitor bus line CSLₙ in the display panel 1).

Therefore, according to the display panel 3 configured as described above, the brightness of the pixel region including the pixel electrode PE_{n,m} (n≦k) disposed on one half surface of the display section 36 and the brightness of the pixel region including the pixel electrode PE_{n,m} (n≧k+1) disposed on the other half surface can be each independently controlled in the single scanning period. Therefore, according to the foregoing configuration, the phenomenon of blurring of moving images can be more effectively suppressed.

Further, since the one auxiliary capacitor bus line and the other auxiliary capacitor bus line can be made substantially identical in load characteristic to each other, the auxiliary capacitor driver connected to the one auxiliary capacitor bus line and the auxiliary capacitor driver connected to the other auxiliary capacitor bus line can be made substantially identical in configuration to each other.

Therefore, according to the foregoing configuration, the improvement effect of the present invention on the blurring of moving images can be made effectively appealing to users by a configuration that is easy to design and fabricate.

Further, the display panel 3 according to the present embodiment is configured such that the one auxiliary capacitor driver (auxiliary capacitor driver 141) includes first amplitude changing means (configured in the same manner as that shown in FIG. 19) for changing size of amplitude of the rectangular voltage signal, and the other auxiliary capacitor driver (auxiliary capacitor driver 142) includes second amplitude changing means (configured in the same manner as that shown in FIG. 19) for changing size of amplitude of the rectangular voltage signal.

Therefore, according to the foregoing configuration, the one auxiliary capacitor driver and the other auxiliary capacitor driver supply the rectangular voltage signal of different amplitudes, whereby the pixel region including the pixel electrode connected to the one auxiliary capacitor bus line and the pixel region including the pixel electrode connected to the other auxiliary capacitor bus line can display images that are different in improvement effect on the phenomenon of blurring of moving images. Therefore, the improvement effect of the present invention on the blurring of moving images can be made to more effectively claim users' attention. That is, the improvement effect of the present invention on the blurring of moving images can be made more effectively appealing to users.

Further, it is preferable that in a case where the one auxiliary capacitor driver (auxiliary capacitor driver 141) supplies the one auxiliary capacitor bus line CSLLₙ with the rectangular voltage signal (auxiliary capacitor signal #CSLLₙ) of smaller amplitude, the source driver 12 supplies the source signal #SLₘ of larger amplitude to the source bus line SLₘ connected via the capacitor C_{n,m} (m≦k) and the transistor M_{n,m} to the one auxiliary capacitor bus line CSLLₙ, that in a case where the one auxiliary capacitor driver (auxiliary capacitor driver 141) supplies the one auxiliary capacitor bus line CSLLₙ with the rectangular voltage signal (auxiliary capacitor signal #CSLLₙ) of larger amplitude, the source driver 12 supplies the source signal #SLₘ of smaller amplitude to the source bus line SLₘ connected via the capacitor C_{n,m} and the transistor M_{n,m} to the one auxiliary capacitor bus line CSLLₙ, that in a case where the other auxiliary capacitor driver (auxiliary capacitor driver 142) supplies the other auxiliary capacitor bus line CSLRₙ with the rectangular voltage signal (auxiliary capacitor signal #CSLRₙ) of smaller amplitude, the source driver 12 supplies the source signal #SLₘ of larger amplitude to the source bus line SLₘ connected via the capacitor C_{n,m} and the transistor M_{n,m} to the other auxiliary capacitor bus line, and that in a case where the other auxiliary capacitor driver (auxiliary capacitor driver 142) supplies the other auxiliary capacitor bus line CSLRₙ with the rectangular voltage signal (auxiliary capacitor signal #CSLRₙ) of larger amplitude, the source driver 12 supplies the source signal #SLₘ of smaller amplitude to the source bus line SLₘ connected via the capacitor C_{n,m} and the transistor M_{n,m} to the other auxiliary capacitor bus line CSLRₙ.

According to the foregoing configuration, the amplitude of the source signal that the source driver supplies to the source bus line connected via the capacitor and the transistor to the one auxiliary capacitor bus line is controlled in accordance with the amplitude of the rectangular voltage signal that the one auxiliary capacitor driver supplies to the one auxiliary capacitor bus line, and the amplitude of the source signal that the source driver supplies to the source bus line connected via the capacitor and the transistor to the other auxiliary capacitor bus line is controlled in accordance with the amplitude of the rectangular voltage signal that the other auxiliary capacitor driver supplies to the other auxiliary capacitor bus line, whereby while uniforming the visibility of images except for the phenomenon of blurring of moving images, the pixel region including the pixel electrode connected to the one auxiliary capacitor bus line and the pixel region including the pixel electrode connected to the other auxiliary capacitor bus line can display images that are different in improvement effect on the phenomenon of blurring of moving images. Therefore, the improvement effect of the present invention on the blurring of moving images can be more effectively appealing to users.

### Embodiment 4

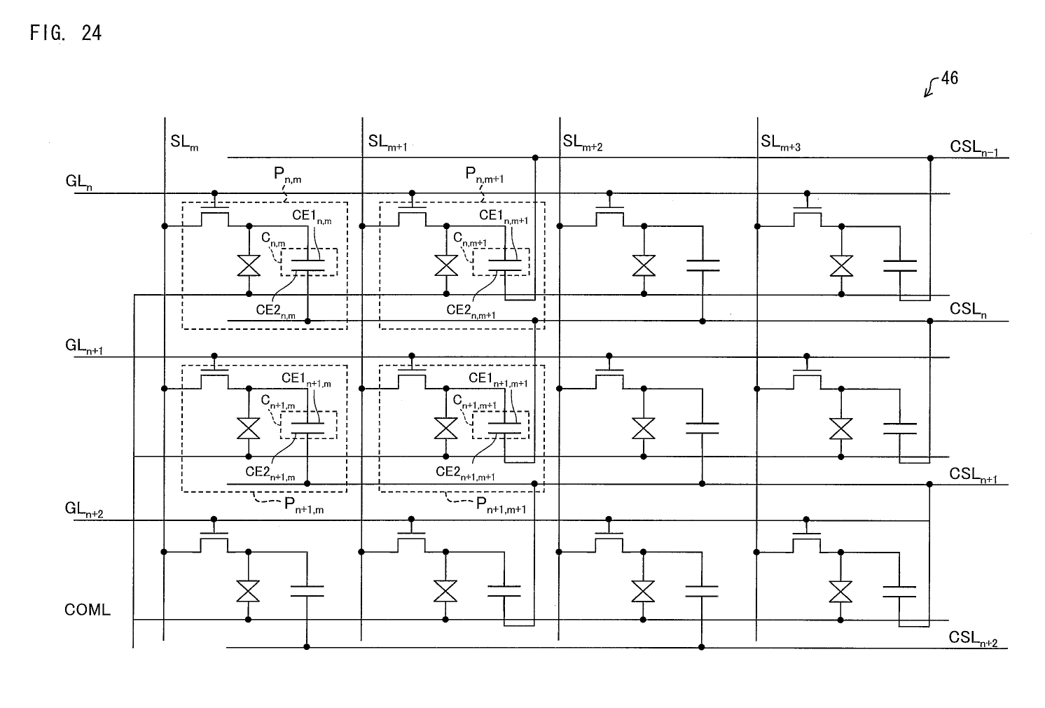

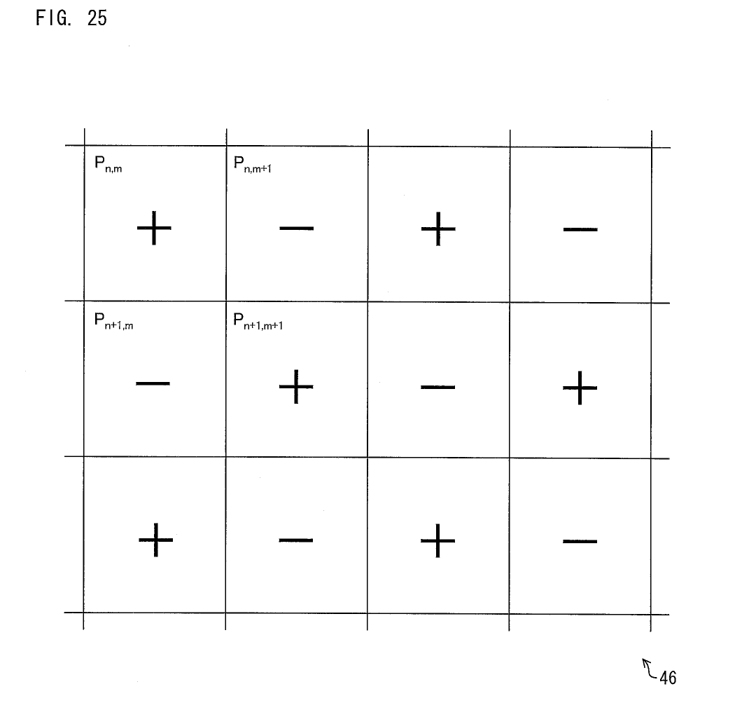

In Embodiments 1 to 3, the applications of the present invention to a line reversal driving system have mainly been described. However, the present invention is not to be limited to a line reversal driving system. In the following, the application of the present invention to a dot reversal driving system in which adjacent pixel electrodes are supplied with potentials that are opposite in polarity to each other is described with reference to FIGS. 24 and 25.

FIG. 24 is a circuit diagram showing a configuration of a display section 46 in a display panel according to the present embodiment. Another configuration of the display panel according to the present embodiment is identical to the configuration of the display panel 1 in Embodiment 1.

FIG. 25 is a diagram showing the polarities of potentials that are applied to the respective pixel electrodes of the display section 46. In the present embodiment, as shown in FIG. 25, pixel electrodes that are adjacent to each other are supplied with potentials of opposite polarities. For such dot reversal driving, the source driver in the present embodiment needs only be configured, for example, to supply, at a given timing, such source signals #SL₁ to #SL_{M} that the polarity of the source signal #SLₘ and the polarity of the source signal #SLₘ₊₁ are opposite polarities.

As shown in FIG. 24, in the display section 46, the second auxiliary capacitor electrode CE2_{n,m} formed in the pixel region P_{n,m} is connected to the auxiliary capacitor bus line CSLₙ, and the second auxiliary capacitor electrode CE2_{n,m+1} formed in the pixel region P_{n,m+1} is connected to the auxiliary capacitor bus line CSLₙ₋₁.

Further, the second auxiliary capacitor electrode CE2_{n+1,m} formed in the pixel region P_{n+1,m} is connected to the auxiliary capacitor bus line CSLₙ₊₁, and the second auxiliary capacitor electrode CE2_{n+1,m+1} formed in the pixel region P_{n+1,m+1} is connected to the auxiliary capacitor bus line CSLₙ.

Further, the auxiliary capacitor driver in the present embodiment supplies such auxiliary capacitor signals #CSL₁ to #CSL_{N} that the polarity of the auxiliary capacitor signal #CSLₙ and the polarity of the auxiliary capacitor signal #CSLₙ₊₁ are opposite polarities. This can be realized, for example, by configuring the auxiliary capacitor driver in the present embodiment in the same manner as the auxiliary capacitor driver 14 in Embodiment 1.

Thus, the display panel according to the present embodiment is configured such that: in a case where the one end (first auxiliary capacitor electrode CE1_{n,m}) of the capacitor C_{n,m} is connected to the transistor M_{n,m} connected to the nth gate bus line GLₙ of the plurality of gate bus lines and the mth source bus line SLₘ of the plurality of source bus lines, the other end (first auxiliary capacitor electrode CE2_{n,m}) of the capacitor C_{n,m} is connected to the nth auxiliary capacitor bus line CSLₙ of the plurality of auxiliary capacitor bus lines; and in a case where the one end (first auxiliary capacitor electrode CE1_{n,m+1}) of the capacitor C_{n,m+1} is connected to the transistor M_{n,m+1} connected to the nth gate bus line GLₙ of the plurality of gate bus lines and the (m+1)th source bus line SLₘ₊₁ of the plurality of source bus lines, the other end (second auxiliary capacitor electrode CE2_{n,m+1}) of the capacitor C_{n,m+1} is connected to the (n−1)th auxiliary capacitor bus line CSLₙ₋₁ of the plurality of auxiliary capacitor bus lines.

According to the display panel thus configured, by carrying out dot reversal driving in which potentials that are applied to pixel electrodes that are adjacent to each other are opposite in polarity to each other, the phenomenon of blurring of moving images can be suppressed while flickers, cross-talks, etc. are being suppressed.

(Summary)

As described above, a display panel according to the present invention is a display panel including: a plurality of gate bus lines; a plurality of source bus lines; a plurality of auxiliary capacitor bus lines; a transistor including a gate connected to a given gate bus line of the plurality of gate bus lines and a source connected to a given source bus line of the plurality of source bus lines; a pixel electrode connected to a drain of the transistor; a capacitor, one end of which is connected to the drain of the transistor in parallel with the pixel electrode, and the other end of which is connected to a given auxiliary capacitor bus line of the plurality of auxiliary capacitor bus lines; a source driver, connected to one end of each of the plurality of source bus lines, which supplies the given source bus line with a source signal; a gate driver, connected to one end of each of the plurality of gate bus lines, which sequentially supplies the given gate bus line with a conducting signal that renders the transistor conducting; a counter electrode opposed to the pixel electrode via a liquid crystal; a counter electrode wire connected to the counter electrode; and a counter electrode driver, which supplies the counter electrode wire with a common potential, the display panel including an auxiliary capacitor driver which, in a single scanning period from a point in time where the gate driver supplies the given gate bus line with the conducting signal to a point in time where the gate driver supplies the conducting signal next, supplies the given auxiliary capacitor bus line with a rectangular voltage signal in synchronization with the conducting signal, the rectangular voltage signal being composed of at least a first voltage level and a second voltage level that is different from the first voltage level, in the single scanning period, a period of time during which the rectangular voltage signal is at the first voltage level and a period of time during which the rectangular voltage signal is at the second voltage level being each longer than a response time of the liquid crystal.

Although, in changing from displaying one frame to displaying the next frame, a hold-type image display device such as a liquid crystal display device displays an moving object as if the moving object were staying in one position, the observer transfers his/her gaze on the screen in chase of the moving object even in a period of time during which the moving object is being displayed as if it were staying in one position; therefore, there occurs a phenomenon of blurring of moving images where the contours of the moving object appear to be blurred.

As described above, the display panel according to the present invention is a display panel including: a plurality of gate bus lines; a plurality of source bus lines; a plurality of auxiliary capacitor bus lines; a transistor including a gate connected to a given gate bus line of the plurality of gate bus lines and a source connected to a given source bus line of the plurality of source bus lines; a pixel electrode connected to a drain of the transistor; a capacitor, one end of which is connected to the drain of the transistor in parallel with the pixel electrode, and the other end of which is connected to a given auxiliary capacitor bus line of the plurality of auxiliary capacitor bus lines; a source driver, connected to one end of each of the plurality of source bus lines, which supplies the given source bus line with a source signal; a gate driver, connected to one end of each of the plurality of gate bus lines, which sequentially supplies the given gate bus line with a conducting signal that renders the transistor conducting; a counter electrode opposed to the pixel electrode via a liquid crystal layer; a counter electrode wire connected to the counter electrode; and a counter electrode driver, which supplies the counter electrode wire with a common potential, the display panel including an auxiliary capacitor driver which, in a single scanning period from a point in time where the gate driver supplies the given gate bus line with the conducting signal to a point in time where the gate driver supplies the conducting signal next, supplies the given auxiliary capacitor bus line with a rectangular voltage signal in synchronization with the conducting signal, the rectangular voltage signal being composed of at least a first voltage level and a second voltage level that is different from the first voltage level. Therefore, in a single scanning period from a point in time where the gate driver supplies the given gate bus line with the conducting signal to a point in time where the gate driver supplies the conducting signal next, a first voltage level and a second voltage level that is different from the first voltage level can be applied to the pixel electrode connected via the transistor to the given gate bus line.

Further, in the display panel according to the present invention, in the single scanning period, a period of time during which the rectangular voltage signal is at the first voltage level and a period of time during which the rectangular voltage signal is at the second voltage level are each longer than a response time of the liquid crystal. The response time of the liquid crystal here means the amount of time required for the orientation of the liquid crystal to start to change after application of an electric field to the liquid crystal. Generally, the amount of time required is 1 ms or more.

Therefore, the foregoing configuration can cause the brightness of an image in the pixel region in which the pixel electrode has been formed to switch between two values in the single scanning period.

This brings about an effect of making it possible to suppress the phenomenon of blurring of moving images.

Further, the auxiliary capacitor driver of the display panel according to the present invention can supply, in synchronization with the conducting signal, the rectangular voltage signal composed of the first voltage level and the second voltage level. Therefore, the voltage level of the rectangular voltage signal changes after a certain period of time has elapsed since the conducting signal was supplied.

Therefore, unlike in a case where a voltage signal is supplied out of synchronization with the conducting signal, the switching between bright and dark can be carried out in every pixel region on the screen after a certain period of time has elapsed since an update of image data.

Further, in the display panel according to the present invention, the blurring of moving images can be suppressed without using a frame memory in which to temporarily store image signals. Therefore, as compared with a conventional configuration that uses a frame memory in which to temporarily store image signals, the display panel according to the present invention brings about an effect of making it possible to reduce manufacturing cost. Further, as compared with a conventional configuration that uses a frame memory in which to temporarily store image signals, the display panel according to the present invention brings about an effect of making it possible to reduce power consumption.

Further, the display panel according to the present invention is preferably configured such that the rectangular voltage signal takes on either one of the first and second voltage levels in an at least 10% continuous period of time of the single scanning period.

According to the foregoing configuration, the rectangular voltage signal takes on either one of the first and second voltage levels in an at least 10% continuous period of time of the single scanning period. This brings about a further effect of making it possible to effectively suppress the phenomenon of blurring of moving images.

Further, the display panel according to the present invention is preferably configured such that the rectangular voltage signal takes on either one of the first and second voltage levels in a period of time from a point in time at which the single scanning period starts to a point in time where substantially 10% of the single scanning period elapses, and takes on the other one of the first and second voltage levels in a period of time from a point in time where substantially 90% of the single scanning period elapses to a point in time at which the single scanning period ends.

Generally, in the case of switching between a display at a high brightness and a display at a low brightness, the viewer feels no improvement in blurring of moving images when the percentage of the display at the high brightness is 90% or higher, feels more improvement in blurring of moving images at a lower percentage between 90% to 10%, and feels satisfactory improvement in blurring of moving images at a percentage of approximately 10%.

Therefore, the foregoing configuration brings about a further effect of making it possible to effectively suppress the phenomenon of blurring of moving images.

Further, the display panel according to the present invention is preferably configured such that in the single scanning period, a polarity of a voltage that is applied to the liquid crystal as represented by a difference between a potential of the pixel electrode and a potential of the counter electrode when the rectangular voltage signal is at the first voltage level and a polarity of a voltage that is applied to the liquid crystal as represented by a difference between a potential of the pixel electrode and the potential of the counter electrode when the rectangular voltage signal is at the second voltage level are polarities that are different from each other.

According to the foregoing configuration, regardless of whether the rectangular voltage signal is at the first or second voltage level, the absolute value of the voltage that is applied to the liquid crystal can be made sufficiently small.

Therefore, the foregoing configuration brings about a further effect of making it possible, in a normally black type in which the brightness is lower in a case where the absolute value of a voltage that is applied to the liquid crystal is smaller, to carry out a black display at a sufficiently low brightness, regardless of whether the rectangular voltage signal is at the first or second voltage level.

Further, the display panel according to the present invention is preferably configured such that an absolute value of a potential difference between the first voltage level and the second voltage level is twice or less as great as a threshold voltage of the liquid crystal.

Generally, the orientation of a liquid crystal is not affected even when a voltage that is lower than the threshold value is applied to the liquid crystal. In other words, the threshold voltage means a voltage at which the orientation of a liquid crystal starts to be affected (same applies below).

According to the foregoing configuration, the absolute value of the potential difference between the first voltage level and the second voltage level is twice or less as great as the threshold voltage of the liquid crystal. This makes it possible to prevent the orientation of the liquid crystal from being affected, regardless of whether the rectangular voltage signal is at the first or second voltage level.

Therefore, the foregoing configuration brings about a further effect of making it possible, in a normally black type in which the brightness is lower in a case where the absolute value of a voltage that is applied to the liquid crystal is smaller, to carry out a black display regardless of whether the rectangular voltage signal is at the first or second voltage level.

Further, the display panel according to the present invention is preferably configured such that in the single scanning period, the auxiliary capacitor driver supplies the given auxiliary capacitor bus line with a rectangular voltage signal in synchronization with the conducting signal, the rectangular voltage signal being composed of the first voltage level, the second voltage level, and a third voltage level that is different from the first and second voltage levels.

According to the foregoing configuration, in the single scanning period, the auxiliary capacitor driver can supply the given auxiliary capacitor bus line with a rectangular voltage signal in synchronization with the conducting signal, the rectangular voltage signal being composed of the first voltage level, the second voltage level, and a third voltage level that is different from the first and second voltage levels. Therefore, in the single scanning period, the level of voltage that is applied to the given auxiliary capacitor bus line switches among three values. In other words, in the single scanning period, the level of voltage that is applied to the auxiliary capacitor bus line makes two transitions. The first transition between the voltage levels in the single scanning period causes a voltage that is applied to the liquid crystal after the first transitions between the voltage levels to be suitable for a display after the first transition between the voltage levels, and the second transition between the voltage levels allows switching between a high brightness and a low brightness.

That is, the foregoing configuration brings about a further effect of making a display at a higher brightness possible while effectively suppressing the phenomenon of blurring of moving images.

Further, the display panel according to the present invention is preferably configured such that the rectangular voltage signal takes on any one of the first to third voltage levels in an at least 10% period of time of the single scanning period.

According to the foregoing configuration, the rectangular voltage signal takes on any one of the first to third voltage levels in an at least 10% period of time of the single scanning period. This brings about a further effect of making it possible to effectively suppress the phenomenon of blurring of moving images.

Further, the display panel according to the present invention is preferably configured such that the rectangular voltage signal takes on any one of the first to third voltage levels in a period of time from a point in time at which the single scanning period starts to a point in time where substantially 10% of the single scanning period elapses, and takes on another one of the first to third voltage levels in a period of time from a point in time where substantially 90% of the single scanning period elapses to a point in time at which the single scanning period ends.

Generally, in the case of switching between a display at a high brightness and a display at a low brightness, the viewer feels no improvement in blurring of moving images when the percentage of the display at the high brightness is 90% or higher, feels more improvement in blurring of moving images at a lower percentage between 90% to 10%, and feels satisfactory improvement in blurring of moving images at a percentage of approximately 10%.

Therefore, the foregoing configuration brings about a further effect of making it possible to effectively suppress the phenomenon of blurring of moving images.

Further, the display panel according to the present invention is preferably configured such that in the single scanning period, a polarity of a voltage that is applied to the liquid crystal as represented by a difference between a potential of the pixel electrode and a potential of the counter electrode after a first transition between the voltage levels and a polarity of a voltage that is applied to the liquid crystal as represented by a difference between a potential of the pixel electrode and the potential of the counter electrode after a next transition between the voltage levels are polarities that are different from each other.

According to the foregoing configuration, regardless of whether after the first transition between the voltage levels or after the next transition between the voltage levels in the single scanning period, the absolute value of the voltage that is applied to the liquid crystal can be made sufficiently small.

Therefore, the foregoing configuration brings about a further effect of making it possible, in a normally black type in which the brightness is lower in a case where the absolute value of a voltage that is applied to the liquid crystal is smaller, to carry out a black display at a sufficiently low brightness, regardless of whether after the first transition between the voltage levels or after the next transition between the voltage levels in the single scanning period.

Further, the display panel according to the present invention is preferably configured such that an absolute value of a potential difference between the highest voltage level among the first to third voltage levels and the middle voltage level among the first to third voltage levels is twice or less as great as a threshold voltage of the liquid crystal.

According to the foregoing configuration, the absolute value of the potential difference between the highest voltage level among the first to third voltage levels and the middle voltage level among the first to third voltage levels is twice or less as great as the threshold voltage of the liquid crystal. This makes it possible to prevent the orientation of the liquid crystal from being affected, regardless of which of the first to third voltage levels the rectangular voltage signal takes on.

Therefore, the foregoing configuration brings about a further effect of making it possible, in a normally black type in which the brightness is lower in a case where the absolute value of a voltage that is applied to the liquid crystal is smaller, to carry out a black display regardless of which of the first to third voltage levels the rectangular voltage signal takes on.

Further, the display panel according to the present invention is preferably configured such that in the single scanning period, the auxiliary capacitor driver supplies the given auxiliary capacitor bus line with a rectangular voltage signal in synchronization with the conducting signal, the rectangular voltage signal being composed of the first voltage level, the second voltage level, and a third voltage level that is different from the first and second voltage levels, and in a single scanning period subsequent to the single scanning period, the auxiliary capacitor driver supplies the given auxiliary capacitor bus line with a rectangular voltage signal in synchronization with the conducting signal, the rectangular voltage signal being composed of any two of the first to third voltage levels and a fourth voltage level that is different from the first to third voltage levels.

According to the foregoing configuration, in the single scanning period, the auxiliary capacitor driver can supply the given auxiliary capacitor bus line with a rectangular voltage signal in synchronization with the conducting signal, the rectangular voltage signal being composed of the first voltage level, the second voltage level, and a third voltage level that is different from the first and second voltage levels. Therefore, in the single scanning period, the level of voltage that is applied to the given auxiliary capacitor bus line switches among three values. In other words, in the single scanning period, the level of voltage that is applied to the auxiliary capacitor bus line makes two transitions. The first transition between the voltage levels in the single scanning period causes a voltage that is applied to the liquid crystal after the first transitions between the voltage levels to be suitable for a display after the first transition between the voltage levels, and the second transition between the voltage levels allows switching between a high brightness and a low brightness.

Therefore, the foregoing configuration brings about a further effect of making a display at a higher brightness possible while effectively suppressing the phenomenon of blurring of moving images.

Furthermore, the foregoing configuration makes it possible, in a single scanning period subsequent to the single scanning period, to supply a rectangular voltage signal composed of any two of the first to third voltage levels and a fourth voltage level that is different from the first to third voltage levels. Therefore, as compared with a case where a rectangular voltage signal composed of the first to third voltage levels is supplied in a single scanning period subsequent to the single scanning period, the adjustment of brightness levels between a high brightness and a low brightness can be more flexibly carried out.

Therefore, the foregoing configuration brings about a further effect of making a display at a high brightness possible while further effectively suppressing the phenomenon of blurring of moving images.

Further, the display panel according to the present invention is preferably configured such that an absolute value of a potential difference between the voltage level before a first transition between the voltage levels in the single scanning period and the voltage level after the first transition is smaller than an absolute value of a potential difference between the voltage level before a next transition between the voltage levels in the single scanning period and the voltage level after the next transition.

According to the foregoing configuration, the absolute value of the potential difference between the voltage level before the first transition between the voltage levels in the single scanning period and the voltage level after the first transition is smaller than the absolute value of the potential difference between the voltage level before the next transition between the voltage levels in the single scanning period and the voltage level after the next transition. Therefore, the difference between the brightness before the next transition and the brightness after the next transition can be made greater than the difference between the brightness before the first transition and the brightness after the first transition. Therefore, the foregoing configuration brings about a further effect of making it possible to more effectively suppress the phenomenon of blurring of moving images.

Further, the display panel according to the present invention is preferably configured such that the rectangular voltage signal takes on any one of the first to fourth voltage levels in an at least 10% period of time of the single scanning period.

According to the foregoing configuration, the rectangular voltage signal takes on any one of the first to fourth voltage levels in an at least 10% period of time of the single scanning period. This brings about a further effect of making it possible to effectively suppress the phenomenon of blurring of moving images.

Further, the display panel according to the present invention is preferably configured such that the rectangular voltage signal takes on any one of the first to fourth voltage levels in a period of time from a point in time at which the single scanning period starts to a point in time where substantially 10% of the single scanning period elapses, and takes on another one of the first to fourth voltage levels in a period of time from a point in time where substantially 90% of the single scanning period elapses to a point in time at which the single scanning period ends.

Generally, in the case of switching between a display at a high brightness and a display at a low brightness, the viewer feels no improvement in blurring of moving images when the percentage of the display at the high brightness is 90% or higher, feels more improvement in blurring of moving images at a lower percentage between 90% to 10%, and feels satisfactory improvement in blurring of moving images at a percentage of approximately 10%.

Therefore, the foregoing configuration brings about a further effect of making it possible to effectively suppress the phenomenon of blurring of moving images.

Further, the display panel according to the present invention is preferably configured such that in the single scanning period, a polarity of a voltage that is applied to the liquid crystal as represented by a difference between a potential of the pixel electrode and a potential of the counter electrode after a first transition between the voltage levels and a polarity of a voltage that is applied to the liquid crystal as represented by a difference between a potential of the pixel electrode and the potential of the counter electrode after a next transition between the voltage levels are polarities that are different from each other.

According to the foregoing configuration, regardless of whether after the first transition between the voltage levels or after the next transition between the voltage levels in the single scanning period, the absolute value of the voltage that is applied to the liquid crystal can be made sufficiently small.

Therefore, the foregoing configuration brings about a further effect of making it possible, in a normally black type in which the brightness is lower in a case where the absolute value of a voltage that is applied to the liquid crystal is smaller, to carry out a black display at a sufficiently low brightness, regardless of whether after the first transition between the voltage levels or after the next transition between the voltage levels in the single scanning period.

Further, the display panel according to the present invention is preferably configured such that an absolute value of a potential difference between the second lowest voltage level among the first to fourth voltage levels and the highest voltage level among the first to fourth voltage levels is twice or less as great as a threshold voltage of the liquid crystal.

According to the foregoing configuration, the absolute value of the potential difference between the second lowest voltage level among the first to fourth voltage levels and the highest voltage level among the first to fourth voltage levels is twice or less as great as the threshold voltage of the liquid crystal. This makes it possible to prevent the orientation of the liquid crystal from being affected, regardless of which of the first to fourth voltage levels the rectangular voltage signal takes on.

Therefore, the foregoing configuration brings about a further effect of making it possible, in a normally black type in which the brightness is lower in a case where the absolute value of a voltage that is applied to the liquid crystal is smaller, to carry out a black display regardless of which of the first to fourth voltage levels the rectangular voltage signal takes on.

Further, the display panel according to the present invention is preferably configured such that in a case where when the gate driver supplies the given gate bus line with the conducting signal, the given auxiliary capacitor bus line is supplied with the lowest voltage level among the voltage levels, the auxiliary capacitor driver supplies the given auxiliary capacitor bus line with the rectangular voltage signal in the single scanning period, the rectangular voltage signal having its voltage levels arranged in an ascending order.

Generally, in a normally black type in which a black display is carried out in a case where no voltage is applied to the pixel electrode, a phenomenon of insufficient rising from a low brightness to a high brightness occurs due to finite lengths of time of response of the liquid crystal. In other words, there is such a characteristic that the amount of time required to change from a low brightness to a high brightness is larger than the amount of time required to change from a high brightness to a low brightness. In a case where a signal that is applied to the pixel electrode has a positive polarity, such a phenomenon can occur at a timing when the potential of the pixel electrode changes to a high voltage.

According to the foregoing configuration, in a case where when the gate driver supplies the given gate bus line with the conducting signal, the given auxiliary capacitor bus line is supplied with the lowest voltage level among the voltage levels, the pixel electrode can be supplied with a voltage signal at a lower voltage level and then with a voltage signal at a higher voltage level in the single scanning period.

This allows the potential that is applied to the pixel electrode to gradually change to a high voltage. This brings about a further effect of making it possible to suppress the phenomenon of insufficient rising from a low brightness to a high brightness that can occur in a normally black type.

Further, the display panel according to the present invention is preferably configured such that in a case where when the gate driver supplies the given gate bus line with the conducting signal, the given auxiliary capacitor bus line is supplied with the highest voltage level among the voltage levels, the auxiliary capacitor driver supplies the given auxiliary capacitor bus line with the rectangular voltage signal in the single scanning period, the rectangular voltage signal having its voltage levels arranged in a descending order.

Generally, in a normally black type in which a black display is carried out in a case where no voltage is applied to the pixel electrode, a phenomenon of insufficient rising from a low brightness to a high brightness occurs due to finite lengths of time of response of the liquid crystal. In other words, there is such a characteristic that the amount of time required to change from a low brightness to a high brightness is larger than the amount of time required to change from a high brightness to a low brightness. In a case where a signal that is applied to the pixel electrode has a positive polarity, such a phenomenon can occur at a timing when the potential of the pixel electrode changes to a low voltage.

According to the foregoing configuration, in a case where when the gate driver supplies the given gate bus line with the conducting signal, the given auxiliary capacitor bus line is supplied with the highest voltage level among the voltage levels, the pixel electrode can be supplied with a voltage signal at a higher voltage and then with a voltage signal at a lower voltage level in the single scanning period.

This allows the potential that is applied to the pixel electrode to gradually change to a low voltage. This brings about a further effect of making it possible to suppress the phenomenon of insufficient rising from a low brightness to a high brightness that can occur in a normally black type.

Further, the display panel according to the present invention is preferably configured such that the auxiliary capacitor driver synchronously supplies the rectangular voltage signal to that one of the auxiliary capacitor bus lines which is connected via the transistor and the capacitor to the nth gate bus line of the plurality of gate bus lines and to that one of the auxiliary capacitor bus lines which is connected via the transistor and the capacitor to the (n+1)th gate bus line of the plurality of gate bus lines.

The foregoing configuration makes it possible to synchronously supply the rectangular voltage signal to that one of the auxiliary capacitor bus lines which is connected via the transistor and the capacitor to the nth gate bus line of the plurality of gate bus lines and to that one of the auxiliary capacitor bus lines which is connected via the transistor and the capacitor to the (n+1)th gate bus line of the plurality of gate bus lines. Therefore the auxiliary capacitor driver of a simpler configuration brings about a further effect of making it possible to suppress the phenomenon of blurring of moving images.

Further, the display panel according to the present invention is preferably configured such that the auxiliary capacitor driver synchronously supplies the rectangular voltage signal to that one of the auxiliary capacitor bus lines which is connected via the transistor and the capacitor to the nth gate bus line of the plurality of gate bus lines and to that one of the auxiliary capacitor bus lines which is connected via the transistor and the capacitor to the (n+2)th gate bus line of the plurality of gate bus lines.

The foregoing configuration allows the auxiliary capacitor driver to synchronously supply the rectangular voltage signal to that one of the auxiliary capacitor bus lines which is connected via the transistor and the capacitor to the nth gate bus line of the plurality of gate bus lines and to that one of the auxiliary capacitor bus lines which is connected via the transistor and the capacitor to the (n+2)th gate bus line of the plurality of gate bus lines. Therefore, the auxiliary capacitor driver of a simpler configuration brings about a further effect of making it possible to suppress the phenomenon of blurring of moving images while suppressing the occurrence of flickers and streaks corresponding to polarity reversal.

Further, the display panel according to the present invention is preferably configured such that: the number of the plurality of gate bus lines is an even number; the number of the plurality of auxiliary capacitor bus lines is a half of the number of the plurality of gate bus lines; and the other end of the capacitor connected via the transistor to the (2k−1)th (k is a natural number) gate bus line of the plurality of gate bus lines and the other end of the capacitor connected via the transistor to the 2 kth gate bus line of the plurality of gate bus lines are connected to the kth auxiliary capacitor bus line of the plurality of auxiliary capacitor bus lines.

According to the foregoing configuration, the number of auxiliary capacitor bus lines to be formed on the display panel can be reduced to half of the number of the plurality of gate bus lines. Therefore, the display panel of a simpler configuration brings about a further effect of making it possible to suppress the phenomenon of blurring of moving images.

Further, the display panel according to the present invention is preferably configured such that the auxiliary capacitor driver includes amplitude changing means for changing size of amplitude of the rectangular voltage signal.

According to the foregoing configuration, the auxiliary capacitor driver includes amplitude changing means for changing size of amplitude of the rectangular voltage signal. This brings about a further effect of making it possible to more effectively suppress the phenomenon of blurring of moving images.

Further, the display panel according to the present invention is preferably configured such that the source driver supplies the source signal of larger amplitude in a case where the amplitude of the rectangular voltage signal is smaller, and supplies the source signal of smaller amplitude in a case where the amplitude of the rectangular voltage signal is larger.

The foregoing configuration allows the source driver to supply the source signal of larger amplitude in a case where the amplitude of the rectangular voltage signal is smaller, and to supply the source signal of smaller amplitude in a case where the amplitude of the rectangular voltage signal is larger, thus bringing about a further effect of making it possible to effectively suppress the phenomenon of blurring of moving images, regardless of whether the rectangular voltage signal is of larger amplitude or smaller amplitude.

It should be noted the amplitude of the source signal is defined as being obtained by subtracting the voltage level of the source signal at the time of negative polarity writing from the voltage level of the source signal at the time of positive polarity writing (same applies below). Further, the time of positive polarity writing refers to the time of supply of the conducting signal during which the rectangular voltage signal is at the lowest voltage level, and the time of negative polarity writing refers to the time of supply of the conducting signal during which the rectangular voltage signal is at the highest voltage level (same applies below).

Further, the display panel according to the present invention may be configured such that: the auxiliary capacitor driver comprises two auxiliary capacitor drivers; the given auxiliary capacitor bus line is constituted by two auxiliary capacitor bus lines formed collinearly via an insulating section; in the single scanning period, either one of the two auxiliary capacitor drivers supplies either one of the two auxiliary capacitor bus lines with the rectangular voltage signal in synchronization with the conducting signal, the rectangular voltage signal being composed of the first voltage level and the second voltage level that is different from the first voltage level; and in the single scanning period, the other one of the two auxiliary capacitor drivers supplies the other one of the two auxiliary capacitor bus lines with the rectangular voltage signal in synchronization with the conducting signal, the rectangular voltage signal being composed of the first voltage level and the second voltage level that is different from the first voltage level.

According to the foregoing configuration, the one auxiliary capacitor driver supplies the rectangular voltage signal to either one of the two auxiliary capacitor bus lines formed collinearly via the insulating section, and the other auxiliary capacitor driver supplies the rectangular voltage signal to the other auxiliary capacitor bus line.

Therefore, according to the foregoing configuration, the pixel electrode connected to the one auxiliary capacitor bus line and the pixel electrode connected to the other auxiliary capacitor bus line can be supplied with the rectangular voltage signal independently from each other.

Therefore, the foregoing configuration allows a pixel region including the pixel electrode connected to the one auxiliary capacitor bus line and a pixel region including the pixel electrode connected to the other auxiliary capacitor bus line to display images that are different in improvement effect on the phenomenon of blurring of moving images. Therefore, the improvement effect of the present invention on the blurring of moving images can be made to more effectively claim users' attention. That is, such a further effect can be brought about that the improvement effect of the present invention on the blurring of moving images can be made more effectively appealing to users.

Further, the display panel according to the present invention is preferably configured such that the source driver supplies source signals of different amplitudes to that one of the source bus lines which is connected via the capacitor and the transistor to the one auxiliary capacitor bus line and to that one of the source bus lines which is connected via the capacitor and the transistor to the other auxiliary capacitor bus line.

According to the foregoing configuration, the source driver can supply source signals of different amplitudes to that one of the source bus lines which is connected via the capacitor and the transistor to the one auxiliary capacitor bus line and to that one of the source bus lines which is connected via the capacitor and the transistor to the other auxiliary capacitor bus line. Therefore, the pixel electrode connected to the one auxiliary capacitor bus line and the pixel electrode connected to the other auxiliary capacitor bus line can be supplied with the rectangular voltage signal independently from each other, whereby while uniforming the visibility of images except for the phenomenon of blurring of moving images, the pixel region including the pixel electrode connected to the one auxiliary capacitor bus line and the pixel region including the pixel electrode connected to the other auxiliary capacitor bus line can display images that are different in improvement effect on the phenomenon of blurring of moving images. Therefore, the improvement effect of the present invention on the blurring of moving images can be made to more effectively claim users' attention. That is, such a further effect can be brought about that the improvement effect of the present invention on the blurring of moving images can be made more effectively appealing to users.

Further, the display panel according to the present invention is preferably configured such that the one auxiliary capacitor bus line has a length that is substantially 45% to substantially 55% of that of the given auxiliary capacitor bus line, and the other auxiliary capacitor bus line has a length that is substantially equal to a length obtained by subtracting the length of the one auxiliary capacitor bus line from the length of the given auxiliary capacitor bus line.

According to the foregoing configuration, the given auxiliary capacitor bus line is electrically separated into the one auxiliary capacitor bus line and the other auxiliary capacitor bus line within a range of ±5% from the center line dividing the display section, which displays an image in the display panel, into two equal parts in parallel with the source bus lines.

Therefore, according to the foregoing configuration, the brightness of the pixel region including the pixel electrode disposed on one half surface of the display section and the brightness of the pixel region including the pixel electrode disposed on the other half surface can be each independently controlled in the single scanning period. Further, since the one auxiliary capacitor bus line and the other auxiliary capacitor bus line can be made substantially identical in load characteristic to each other, the auxiliary capacitor driver connected to the one auxiliary capacitor bus line and the auxiliary capacitor driver connected to the other auxiliary capacitor bus line can be made substantially identical in configuration to each other.

Therefore, the foregoing configuration brings about such a further effect that the improvement effect of the present invention on the blurring of moving images can be made effectively appealing to users by a configuration that is easy to design and fabricate.

Further, the display panel according to the present invention is preferably configured such that the one auxiliary capacitor driver includes first amplitude changing means for changing size of amplitude of the rectangular voltage signal, and the other auxiliary capacitor driver includes second amplitude changing means for changing size of amplitude of the rectangular voltage signal.

According to the foregoing configuration, the one auxiliary capacitor driver includes first amplitude changing means for changing size of amplitude of the rectangular voltage signal, and the other auxiliary capacitor driver includes second amplitude changing means for changing size of amplitude of the rectangular voltage signal. Therefore, the one auxiliary capacitor driver and the other auxiliary capacitor driver can supply the rectangular voltage signal of different amplitudes.

Therefore, according to the foregoing configuration, the one auxiliary capacitor driver and the other auxiliary capacitor driver supply the rectangular voltage signal of different amplitudes, whereby the pixel region including the pixel electrode connected to the one auxiliary capacitor bus line and the pixel region including the pixel electrode connected to the other auxiliary capacitor bus line can display images that are different in improvement effect on the phenomenon of blurring of moving images. Therefore, the improvement effect of the present invention on the blurring of moving images can be made to more effectively claim users' attention. That is, such a further effect can be brought about that the improvement effect of the present invention on the blurring of moving images can be made more effectively appealing to users.

Further, the display panel according to the present invention is preferably configured such that: in a case where the one auxiliary capacitor driver supplies the one auxiliary capacitor bus line with the rectangular voltage signal of smaller amplitude, the source driver supplies the source signal of larger amplitude to that one of the source bus lines which is connected via the capacitor and the transistor to the one auxiliary capacitor bus line; in a case where the one auxiliary capacitor driver supplies the one auxiliary capacitor bus line with the rectangular voltage signal of larger amplitude, the source driver supplies the source signal of smaller amplitude to that one of the source bus lines which is connected via the capacitor and the transistor to the one auxiliary capacitor bus line; in a case where the other auxiliary capacitor driver supplies the other auxiliary capacitor bus line with the rectangular voltage signal of smaller amplitude, the source driver supplies the source signal of larger amplitude to that one of the source bus lines which is connected via the capacitor and the transistor to the other auxiliary capacitor bus line; and in a case where the other auxiliary capacitor driver supplies the other auxiliary capacitor bus line with the rectangular voltage signal of larger amplitude, the source driver supplies the source signal of smaller amplitude to that one of the source bus lines which is connected via the capacitor and the transistor to the other auxiliary capacitor bus line.

According to the foregoing configuration, the amplitude of the source signal that the source driver supplies to the source bus line connected via the capacitor and the transistor to the one auxiliary capacitor bus line is controlled in accordance with the amplitude of the rectangular voltage signal that the one auxiliary capacitor driver supplies to the one auxiliary capacitor bus line, and the amplitude of the source signal that the source driver supplies to the source bus line connected via the capacitor and the transistor to the other auxiliary capacitor bus line is controlled in accordance with the amplitude of the rectangular voltage signal that the other auxiliary capacitor driver supplies to the other auxiliary capacitor bus line, whereby while uniforming the visibility of images except for the phenomenon of blurring of moving images, the pixel region including the pixel electrode connected to the one auxiliary capacitor bus line and the pixel region including the pixel electrode connected to the other auxiliary capacitor bus line can display images that are different in improvement effect on the phenomenon of blurring of moving images. Therefore, such a further effect can be brought about that the improvement effect of the present invention on the blurring of moving images can be more effectively appealing to users.

Further, the display panel according to the present invention is preferably configured such that: in a case where the one end of the capacitor is connected to the transistor connected to the nth gate bus line of the plurality of gate bus lines and the mth source bus line of the plurality of source bus lines, the other end of the capacitor is connected to the nth auxiliary capacitor bus line of the plurality of auxiliary capacitor bus lines; and in a case where the one end of the capacitor is connected to the transistor connected to the nth gate bus line of the plurality of gate bus lines and the (m+1)th source bus line of the plurality of source bus lines, the other end of the capacitor is connected to the (n−1)th auxiliary capacitor bus line of the plurality of auxiliary capacitor bus lines.

The display panel thus configured brings about such a further effect that by carrying out dot reversal driving in which source signals that are applied to pixel electrodes that are adjacent to each other are opposite in polarity to each other, the phenomenon of blurring of moving images can be suppressed while flickers, cross-talks, etc. are being suppressed.

Further, a liquid crystal display device including a display panel thus configured is also encompassed in the scope of the present invention.

Further, a driving method according to the present invention is a method for driving a display panel including: a plurality of gate bus lines; a plurality of source bus lines; a plurality of auxiliary capacitor bus lines; a transistor including a gate connected to a given gate bus line of the plurality of gate bus lines and a source connected to a given source bus line of the plurality of source bus lines; a pixel electrode connected to a drain of the transistor; a capacitor, one end of which is connected to the drain of the transistor in parallel with the pixel electrode, and the other end of which is connected to a given auxiliary capacitor bus line of the plurality of auxiliary capacitor bus lines; a source driver, connected to one end of each of the plurality of source bus lines, which supplies the given source bus line with a source signal; a gate driver, connected to one end of each of the plurality of gate bus lines, which sequentially supplies the given gate bus line with a conducting signal that renders the transistor conducting; a counter electrode opposed to the pixel electrode via a liquid crystal; a counter electrode wire connected to the counter electrode; and a counter electrode driver, which supplies the counter electrode wire with a common potential, the method including a voltage signal supplying step of, in a single scanning period from a point in time where the gate driver supplies the given gate bus line with the conducting signal to a point in time where the gate driver supplies the conducting signal next, supplying the given auxiliary capacitor bus line with a rectangular voltage signal in synchronization with the conducting signal, the rectangular voltage signal being composed of at least a first voltage level and a second voltage level that is different from the first voltage level, in the single scanning period, a period of time during which the rectangular voltage signal is at the first voltage level and a period of time during which the rectangular voltage signal is at the second voltage level being each longer than a response time of the liquid crystal.

The foregoing method brings about the same effects as the foregoing display panel according to the present invention.

The present invention is not limited to the description of the embodiments above, but may be altered by a skilled person within the scope of the claims. An embodiment based on a proper combination of technical means disclosed in different embodiments is encompassed in the technical scope of the present invention.

Further, a liquid crystal display device including a display panel described in any one of the embodiments is also encompassed in the present invention.

### INDUSTRIAL APPLICABILITY

The present invention can be suitably applied to a display panel that displays an image by using liquid crystals.

### REFERENCE SIGNS LIST

1 Display panel
11 Control section
12 Source driver
13 Gate driver
14 Auxiliary capacitor driver
15 Counter electrode driver
16 Display section
SLₘ Source bus line
GLₙ Gate bus line
CSLₙ Auxiliary capacitor bus line
COML Counter electrode wire
P_{n,m} Pixel region
PE_{n,m} Pixel electrode
M_{n,m} Transistor
E_{COM} Counter electrode
C_{n,m} Capacitor
CE1_{n,m} First auxiliary capacitor electrode
CE2_{n,m} Second auxiliary capacitor electrode

1. A display panel including:
a plurality of gate bus lines;
a plurality of source bus lines;
a plurality of auxiliary capacitor bus lines;
a transistor including a gate connected to a given gate bus line of the plurality of gate bus lines and a source connected to a given source bus line of the plurality of source bus lines;
a pixel electrode connected to a drain of the transistor;
a capacitor, one end of which is connected to the drain of the transistor in parallel with the pixel electrode, and the other end of which is connected to a given auxiliary capacitor bus line of the plurality of auxiliary capacitor bus lines;
a source driver, connected to one end of each of the plurality of source bus lines, which supplies the given source bus line with a source signal;
a gate driver, connected to one end of each of the plurality of gate bus lines, which sequentially supplies the given gate bus line with a conducting signal that renders the transistor conducting;
a counter electrode opposed to the pixel electrode via a liquid crystal;
a counter electrode wire connected to the counter electrode; and
a counter electrode driver, which supplies the counter electrode wire with a common potential,
the display panel comprising an auxiliary capacitor driver which, in a single scanning period from a point in time where the gate driver supplies the given gate bus line with the conducting signal to a point in time where the gate driver supplies the conducting signal next, supplies the given auxiliary capacitor bus line with a rectangular voltage signal in synchronization with the conducting signal, the rectangular voltage signal being composed of at least a first voltage level and a second voltage level that is different from the first voltage level,
in the single scanning period, a period of time during which the rectangular voltage signal is at the first voltage level and a period of time during which the rectangular voltage signal is at the second voltage level being each longer than a response time of the liquid crystal.

2. The display panel as set forth in claim 1, wherein the rectangular voltage signal takes on either one of the first and second voltage levels in an at least 10% continuous period of time of the single scanning period.

3. The display panel as set forth in claim 1, wherein the rectangular voltage signal takes on either one of the first and second voltage levels in a period of time from a point in time at which the single scanning period starts to a point in time where substantially 10% of the single scanning period elapses, and takes on the other one of the first and second voltage levels in a period of time from a point in time where substantially 90% of the single scanning period elapses to a point in time at which the single scanning period ends.

4. The display panel as set forth in claim 1, wherein in the single scanning period, a polarity of a voltage that is applied to the liquid crystal as represented by a difference between a potential of the pixel electrode and a potential of the counter electrode when the rectangular voltage signal is at the first voltage level and a polarity of a voltage that is applied to the liquid crystal as represented by a difference between a potential of the pixel electrode and the potential of the counter electrode when the rectangular voltage signal is at the second voltage level are polarities that are different from each other.

5. The display panel as set forth in claim 1, wherein an absolute value of a potential difference between the first voltage level and the second voltage level is twice or less as great as a threshold voltage of the liquid crystal.

6. The display panel as set forth in claim 1, wherein in the single scanning period, the auxiliary capacitor driver supplies the given auxiliary capacitor bus line with a rectangular voltage signal in synchronization with the conducting signal, the rectangular voltage signal being composed of the first voltage level, the second voltage level, and a third voltage level that is different from the first and second voltage levels.

7. The display panel as set forth in claim 6, wherein the rectangular voltage signal takes on any one of the first to third voltage levels in an at least 10% period of time of the single scanning period.

8. The display panel as set forth in claim 6, wherein the rectangular voltage signal takes on any one of the first to third voltage levels in a period of time from a point in time at which the single scanning period starts to a point in time where substantially 10% of the single scanning period elapses, and takes on another one of the first to third voltage levels in a period of time from a point in time where substantially 90% of the single scanning period elapses to a point in time at which the single scanning period ends.

9. The display panel as set forth in claim 6, wherein in the single scanning period, a polarity of a voltage that is applied to the liquid crystal as represented by a difference between a potential of the pixel electrode and a potential of the counter electrode after a first transition between the voltage levels and a polarity of a voltage that is applied to the liquid crystal as represented by a difference between a potential of the pixel electrode and the potential of the counter electrode after a next transition between the voltage levels are polarities that are different from each other.

10. The display panel as set forth in claim 6, wherein an absolute value of a potential difference between the highest voltage level among the first to third voltage levels and the middle voltage level among the first to third voltage levels is twice or less as great as a threshold voltage of the liquid crystal.

11. The display panel as set forth in claim 1, wherein in the single scanning period, the auxiliary capacitor driver supplies the given auxiliary capacitor bus line with a rectangular voltage signal in synchronization with the conducting signal, the rectangular voltage signal being composed of the first voltage level, the second voltage level, and a third voltage level that is different from the first and second voltage levels, and in a single scanning period subsequent to the single scanning period, the auxiliary capacitor driver supplies the given auxiliary capacitor bus line with a rectangular voltage signal in synchronization with the conducting signal, the rectangular voltage signal being composed of any two of the first to third voltage levels and a fourth voltage level that is different from the first to third voltage levels.

12. The display panel as set forth in claim 11, wherein an absolute value of a potential difference between the voltage level before a first transition between the voltage levels in the single scanning period and the voltage level after the first transition is smaller than an absolute value of a potential difference between the voltage level before a next transition between the voltage levels in the single scanning period and the voltage level after the next transition.

13. The display panel as set forth in claim 11, wherein the rectangular voltage signal takes on any one of the first to fourth voltage levels in an at least 10% period of time of the single scanning period.

14. The display panel as set forth in claim 11, wherein the rectangular voltage signal takes on any one of the first to fourth voltage levels in a period of time from a point in time at which the single scanning period starts to a point in time where substantially 10% of the single scanning period elapses, and takes on another one of the first to fourth voltage levels in a period of time from a point in time where substantially 90% of the single scanning period elapses to a point in time at which the single scanning period ends.

15. The display panel as set forth in claim 11, wherein in the single scanning period, a polarity of a voltage that is applied to the liquid crystal as represented by a difference between a potential of the pixel electrode and a potential of the counter electrode after a first transition between the voltage levels and a polarity of a voltage that is applied to the liquid crystal as represented by a difference between a potential of the pixel electrode and the potential of the counter electrode after a next transition between the voltage levels are polarities that are different from each other.

16. The display panel as set forth in claim 11, wherein an absolute value of a potential difference between the second lowest voltage level among the first to fourth voltage levels and the highest voltage level among the first to fourth voltage levels is twice or less as great as a threshold voltage of the liquid crystal.

17. The display panel as set forth in claim 1, wherein in a case where when the gate driver supplies the given gate bus line with the conducting signal, the given auxiliary capacitor bus line is supplied with the lowest voltage level among the voltage levels, the auxiliary capacitor driver supplies the given auxiliary capacitor bus line with the rectangular voltage signal in the single scanning period, the rectangular voltage signal having its voltage levels arranged in an ascending order.

18. The display panel as set forth in claim 1, wherein in a case where when the gate driver supplies the given gate bus line with the conducting signal, the given auxiliary capacitor bus line is supplied with the highest voltage level among the voltage levels, the auxiliary capacitor driver supplies the given auxiliary capacitor bus line with the rectangular voltage signal in the single scanning period, the rectangular voltage signal having its voltage levels arranged in a descending order.

19. The display panel as set forth in claim 1, wherein the auxiliary capacitor driver synchronously supplies the rectangular voltage signal to that one of the auxiliary capacitor bus lines which is connected via the transistor and the capacitor to the nth gate bus line of the plurality of gate bus lines and to that one of the auxiliary capacitor bus lines which is connected via the transistor and the capacitor to the (n+1)th gate bus line of the plurality of gate bus lines.

20. The display panel as set forth in claim 1, wherein the auxiliary capacitor driver synchronously supplies the rectangular voltage signal to that one of the auxiliary capacitor bus lines which is connected via the transistor and the capacitor to the nth gate bus line of the plurality of gate bus lines and to that one of the auxiliary capacitor bus lines which is connected via the transistor and the capacitor to the (n+2)th gate bus line of the plurality of gate bus lines.

21. The display panel as set forth in claim 1, wherein:
the number of the plurality of gate bus lines is an even number;
the number of the plurality of auxiliary capacitor bus lines is a half of the number of the plurality of gate bus lines; and
the other end of the capacitor connected via the transistor to the (2k−1)th (k is a natural number) gate bus line of the plurality of gate bus lines and the other end of the capacitor connected via the transistor to the 2kth gate bus line of the plurality of gate bus lines are connected to the kth auxiliary capacitor bus line of the plurality of auxiliary capacitor bus lines.

22. The display panel as set forth in claim 1, wherein the auxiliary capacitor driver includes amplitude changing means for changing size of amplitude of the rectangular voltage signal.

23. The display panel as set forth in claim 22, wherein the source driver supplies the source signal of larger amplitude in a case where the amplitude of the rectangular voltage signal is smaller, and supplies the source signal of smaller amplitude in a case where the amplitude of the rectangular voltage signal is larger.

24. The display panel as set forth in claim 1, wherein:
the auxiliary capacitor driver comprises two auxiliary capacitor drivers;
the given auxiliary capacitor bus line is constituted by two auxiliary capacitor bus lines formed collinearly via an insulating section;
in the single scanning period, either one of the two auxiliary capacitor drivers supplies either one of the two auxiliary capacitor bus lines with the rectangular voltage signal in synchronization with the conducting signal, the rectangular voltage signal being composed of the first voltage level and the second voltage level that is different from the first voltage level; and
in the single scanning period, the other one of the two auxiliary capacitor drivers supplies the other one of the two auxiliary capacitor bus lines with the rectangular voltage signal in synchronization with the conducting signal, the rectangular voltage signal being composed of the first voltage level and the second voltage level that is different from the first voltage level.

25. The display panel as set forth in claim 24, wherein the source driver supplies source signals of different amplitudes to that one of the source bus lines which is connected via the capacitor and the transistor to the one auxiliary capacitor bus line and to that one of the source bus lines which is connected via the capacitor and the transistor to the other auxiliary capacitor bus line.

26. The display panel as set forth in claim 24, wherein the one auxiliary capacitor bus line has a length that is substantially 45% to substantially 55% of that of the given auxiliary capacitor bus line, and the other auxiliary capacitor bus line has a length that is substantially equal to a length obtained by subtracting the length of the one auxiliary capacitor bus line from the length of the given auxiliary capacitor bus line.

27. The display panel as set forth in claim 24, wherein the one auxiliary capacitor driver includes first amplitude changing means for changing size of amplitude of the rectangular voltage signal, and the other auxiliary capacitor driver includes second amplitude changing means for changing size of amplitude of the rectangular voltage signal.

28. The display panel as set forth in claim 27, wherein:
in a case where the one auxiliary capacitor driver supplies the one auxiliary capacitor bus line with the rectangular voltage signal of smaller amplitude, the source driver supplies the source signal of larger amplitude to that one of the source bus lines which is connected via the capacitor and the transistor to the one auxiliary capacitor bus line;
in a case where the one auxiliary capacitor driver supplies the one auxiliary capacitor bus line with the rectangular voltage signal of larger amplitude, the source driver supplies the source signal of smaller amplitude to that one of the source bus lines which is connected via the capacitor and the transistor to the one auxiliary capacitor bus line,
in a case where the other auxiliary capacitor driver supplies the other auxiliary capacitor bus line with the rectangular voltage signal of smaller amplitude, the source driver supplies the source signal of larger amplitude to that one of the source bus lines which is connected via the capacitor and the transistor to the other auxiliary capacitor bus line; and
in a case where the other auxiliary capacitor driver supplies the other auxiliary capacitor bus line with the rectangular voltage signal of larger amplitude, the source driver supplies the source signal of smaller amplitude to that one of the source bus lines which is connected via the capacitor and the transistor to the other auxiliary capacitor bus line.

29. The display panel as set forth in claim 1, wherein:
in a case where the one end of the capacitor is connected to the transistor connected to the nth gate bus line of the plurality of gate bus lines and the mth source bus line of the plurality of source bus lines, the other end of the capacitor is connected to the nth auxiliary capacitor bus line of the plurality of auxiliary capacitor bus lines; and
in a case where the one end of the capacitor is connected to the transistor connected to the nth gate bus line of the plurality of gate bus lines and the (m+1)th source bus line of the plurality of source bus lines, the other end of the capacitor is connected to the (n−1)th auxiliary capacitor bus line of the plurality of auxiliary capacitor bus lines.

30. A liquid crystal display device comprising a display panel as set forth in claims 1.

31. A method for driving a display panel including:
a plurality of gate bus lines;
a plurality of source bus lines;
a plurality of auxiliary capacitor bus lines;
a transistor including a gate connected to a given gate bus line of the plurality of gate bus lines and a source connected to a given source bus line of the plurality of source bus lines;
a pixel electrode connected to a drain of the transistor;
a capacitor, one end of which is connected to the drain of the transistor in parallel with the pixel electrode, and the other end of which is connected to a given auxiliary capacitor bus line of the plurality of auxiliary capacitor bus lines;
a source driver, connected to one end of each of the plurality of source bus lines, which supplies the given source bus line with a source signal;
a gate driver, connected to one end of each of the plurality of gate bus lines, which sequentially supplies the given gate bus line with a conducting signal that renders the transistor conducting;
a counter electrode opposed to the pixel electrode via a liquid crystal;
a counter electrode wire connected to the counter electrode; and
a counter electrode driver, which supplies the counter electrode wire with a common potential,
the method comprising a voltage signal supplying step of, in a single scanning period from a point in time where the gate driver supplies the given gate bus line with the conducting signal to a point in time where the gate driver supplies the conducting signal next, supplying the given auxiliary capacitor bus line with a rectangular voltage signal in synchronization with the conducting signal, the rectangular voltage signal being composed of at least a first voltage level and a second voltage level that is different from the first voltage level,
in the single scanning period, a period of time during which the rectangular voltage signal is at the first voltage level and a period of time during which the rectangular voltage signal is at the second voltage level being each longer than a response time of the liquid crystal.
